(19) United States
(12) Patent Application Publication
(10) Pub. No.: US 2025/0296285 A1
(43) Pub. Date: Sep. 25, 2025

(54) THREE DIMENSIONAL PRINTING PROCESS FLOW MANAGEMENT AND SUPPORT SYSTEMS

(71) Applicant: Azul 3D, Inc., Skokie, IL (US)

(72) Inventors: Kanan Wanha, Skokie, IL (US); Juan Fernandez, Skokie, IL (US); Edward Cottiss, Skokie, IL (US); Katie Shi, Skokie, IL (US); David Lehman, Skokie, IL (US); Eric Potempa, Skokie, IL (US); Elvin Garayev, Skokie, IL (US); James Hedrick, Skokie, IL (US); Michael Flynn, Skokie, IL (US); Matthew Hildner, Skokie, IL (US); David Walker, Skokie, IL (US)

(21) Appl. No.: 18/849,107

(22) PCT Filed: Mar. 21, 2023
(86) PCT No.: PCT/US2023/015785

§ 371 Date: Sep. 20, 2024

Related U.S. Application Data
(60) Provisional application No. 63/321,998, filed on Mar. 21, 2022.
(60) Provisional application No. 63/322,015, filed on Mar. 21, 2022.
(60) Provisional application No. 63/322,025, filed on Mar. 21, 2022.
(60) Provisional application No. 63/322,036, filed on Mar. 21, 2022.

(51) Int. Cl. B29C 64/393; B29C 64/124; B29C 64/321; B33Y 10/00; B33Y 30/00; B33Y 40/10; B33Y 50/02

(52) U.S. Cl. CPC B29C 64/393; B29C 64/124; B29C 64/321; B33Y 10/00; B33Y 30/00; B33Y 40/10; B33Y 50/02

(57) ABSTRACT

The technology described herein provides methods and devices to manage process flows and support systems for 3D printing. The technology provides methods and devices for separating contaminants in 3D printing fluids. The technology provides methods and devices for aligning projectors with six degrees of freedom in 3D printers. The technology provides methods and devices to cause the flow of an immiscible liquid under an interface with liquid resin in a 3D printer liquid vat to be laminar, of proper height, and of appropriate flow rate to remove heat. The technology provides methods and devices to provide feedback loops for a three-dimensional printing process that uses a flow of oil under a liquid resin to control heat in the printing process.

### RELATED APPLICATIONS AND INCORPORATION BY REFERENCE

This application is a 35 U.S.C. § 371 national stage application of PCT Application No. PCT/US2023/015785, filed Mar. 21, 2023, which claims priority to U.S. provisional application No. 63/321,998, filed Mar. 21, 2022, U.S. provisional application No. 63/322,015, filed Mar. 21, 2022, U.S. provisional application No. 63/322,025, filed Mar. 21, 2022, and U.S. provisional application No. 63/322,036, filed Mar. 21, 2022. The entire contents of which are incorporated by reference in their entirety.

### TECHNICAL FIELD

The technology disclosed herein relates to three-dimensional (“3D”) printing, and more particularly to methods and devices for separating contaminants from 3D printing fluids, allowing for alignment of projectors with increased degrees of freedom, controlling flow and thermal interfaces, and providing feedback control loops.

### BACKGROUND

In conventional applications of photopolymerization-based 3D printing, a layer-by-layer process is utilized. In this process, a small layer of resin is cured and then moved away from a contact point to allow a subsequent layer of resin to cure. The layers may be added in either a top-down or bottom-up method. In the bottom-up method, a cured layer is created by shining polymerizing light through a window at the bottom of a pool of resin and lifting that layer up out of the liquid vat to expose uncured resin to the window and the light. The shape of the printed part is dictated by the area and shape of the energy exposure from the polymerizing light. The bottom-up method has several technical advantages over the top-down method, such as the ability to control resin layer thickness more precisely.

Bottom-up printing encounters many deficiencies and challenges that conventional systems have not been able to overcome. For example, contaminants are often dispersed in the resin. The contaminants can create obstructions in the tubing, valves, or other process equipment. The contaminants may also become entrained in the printed part, which creates errors, weak points, or blemishes.

When a layer of print material is formed, the cured resin will adhere to the build plate, previously cured layers, and the window at the bottom of the liquid vat. Adhering to the window creates a potential disadvantage by preventing the resin from being raised from the window, which prevents a new layer of uncured resin to be exposed to the polymerizing light. Further, conventional systems are unable to dissipate heat released by the photosensitive resin as part of the chemical process that changes the resin from a liquid to a solid.

A typical application for photopolymerization-based 3D printing uses a “light engine,” or projector, which is responsible for patterning light (i.e., energy) to drive the polymerization reactions of photo-sensitive liquid resins in the manufacturing process. Conventional approaches have included the use of multiple projectors to cover a larger area. The projection area of each independent projector can be aligned to generate a larger image. The challenges of aligning the projectors for high resolution 3D printing include scaling and precision in alignment. For example, in conventional manual alignment systems, adjusting a single projector alignment system within an array causes disruptions to the surrounding projector alignment systems.

Other challenges encountered by conventional systems is in maintaining the depth, flow conditions, temperatures, pressures, and interface levels of the fluids in the resin vat. Maintaining the levels and flow conditions within optimal specifications allows the printing to proceed faster and more efficiently with fewer printing errors.

### SUMMARY OF INVENTION

In one aspect, exampled embodiments described herein provide methods and devices for separating contaminants in 3D printing fluids without using a mechanical filter. The material separator technology is configured to remove air bubbles, cured photopolymerization resin, liquid resin, water, dust, and other buoyant contaminants from an interface material, such as an immiscible liquid, that flows beneath an interface between the interface material and the liquid resin without the use of mechanical or other particle filtering media. The material separator operates by using the natural buoyancy of contaminants, such as air bubbles and trapped photopolymerization resin, to remove the contaminants from the interface material. The buoyancy of the contaminants may be augmented by changes in flow direction that force the contaminants to float towards a collection region while the interface material flows a different direction. The material separator may have a relatively larger tube diameter compared to the tubing used in the plumbing system of the 3D printer. The larger tube diameter causes retention of a larger volume of fluids and reduces the flow velocity. The larger volume of fluids causes the fluids to linger near a collection region for a sufficient time to allow any containment to float out of the main fluid flow into the collection region. Once in the collection region, the containments are no longer at risk of flowing with the interface material to the filters or back to the 3D printer.

In certain examples, the interface material may be an aqueous liquid, an organic liquid, a silicone liquid, a hydrogel, and a fluoro liquid. For example, the interface material is a dense fluoro oil, such as Perfluoropolyether (“PFPE”) oil that has a density approximately twice the density of water. Other dense oils or densified liquids may be used to provide the interface material below the liquid resin in the liquid vat. The terms interface material, PFPE, PFPE oil, fluoro oil, or oil, may be used throughout the specification to represent any suitable interface material used in the liquid/liquid interface system.

In an example, the liquid resin used to form the 3D part has a density that is approximately equal to water. The terms photopolymerization resin or resin may be used throughout the specification to represent the liquid resin used to make a part or product. At certain times the resin may be liquid, may be a solid particle after polymerization, or in a gelatinous state after partial polymerization. The liquid form of the resin may be identified as simply liquid or liquid resin herein. Entrained air bubbles have a density that is approximately 1/1000th of the density of water. Other contaminants in the interface material may also float, such as dust, organic matter, fabrics, and dirt. These types of environmental contaminants typically have densities lower than twice the density of water and will typically float on the interface material. Therefore, both air, resin, and many other contaminants will float in the interface material if allowed to approach an equilibrium.

In an example, a material separator device may be configured that uses buoyancy, while another example material separator utilizes changes in flow direction to enhance the buoyancy of the contaminants. The material separator uses an inlet for the interface material flow, an outlet for the interface material flow, a collection region (or stagnation region) for resin, air, or other contaminants to collect, and a vent near the collection region. The material separator can be configured to perform these tasks while being small enough to include onboard a 3D printer device.

One version of the material separator utilizes a “reverse J bend.” The device is shaped like a question mark or an upside-down J, as illustrated herein. As interface material flows through this version, the flow is initially upwards (or horizontally) toward the vent and then changes direction downwards toward the outlet. Any trapped bubbles or resin will float into a collection zone near a vent at the topmost point of the flow tube. The separation of the contaminants from the interface material is aided by the initial upwards flow direction of the interface material. In alternate examples, more than one collection zone may be in the material separator. For example, the upper portion of the material separator may proceed upwards to a collection zone, proceed downwards as described, then proceed back upwards to a second collection zone before turning downwards towards the outlet. Any suitable shape or design that changes direction at a collection zone may be utilized. The advantages of the reverse J bend separator over a column separator are that the collection region is separate from the interface material flow and the reverse J bend separator is shorter than the column separator, which allows the reverse J bend separator to fit in a smaller housing.

An alternate version of the material separator is a column separator that primarily utilizes a vertical tube with caps for interface material inlet, interface material outlet, and a vent. The column separator is sufficiently tall such that any air or resin captured in the interface material will float to the top before the interface material reaches the outlet of the column separator.

The cooled, clean interface material after the cooling chamber and the material separator does not become cloudy from the buildup of contaminants and allows for more effective and precise 3D printing.

In another example, a material separator is configured to separate liquid resin from the interface material. In the example, the material separator receives a mixture of liquid resin and interface material and separates the resin and interface material. The separation is based on a buoyancy of liquid resin over the interface material. In the body of the material separator, the liquid resin floats or rises to the top of material separator, and the interface material sinks to the bottom of the material separator. The material separator may have an outlet at a top portion of the material separator through which the liquid resin is channeled back to a 3D printer or a storage container for liquid resin. The material separator may have an outlet at a bottom portion of the material separator through which the interface material is channeled back to a 3D printer or a storage container for interface material.

In another aspect, example embodiments described herein provide methods and devices for aligning projectors with six degrees of freedom in 3D printers. The projector alignment system is configured to align individual projectors in an array of projectors within a 3D printer with movement in X, Y, Z, roll, pitch, and yaw degrees of freedom while conforming to a footprint that is smaller than the desired projection area of each projector.

The projector alignment system uses a parallel manipulator to achieve movement with six degrees of freedom. The parallel manipulator is a robotic manipulator that uses parallel arms to precisely position the manipulator, or end effector. The parallel manipulator uses a substantially non-symmetrical configuration of six linkages to provide stability across the working range of the end-effector, which is the projector adjustment range. The substantially non-symmetrical configuration of the six linkages enables the parallel manipulator to fit within the projector area of each projector while maximizing the adjustment range of the projector.

The projector alignment system provides space for hardware needed to send patterning and projection data via a remote controller. The hardware includes custom printed circuit boards (“PCBs”), data connection, and power connection to allow for onboard processing of pattern images and motion control of the parallel manipulator. The hardware and the circuitry necessary to operate the parallel manipulator has been engineered to fit within the footprint of the projector alignment system. The projector alignment system includes independently addressable circuits for individual motor control for the parallel manipulator, and provides control of the image data delivery to the projector. Power distribution circuits deliver and generate correct voltage levels to the motor controller board, the projector, and the processor controlling the delivery of the image data to the projector. Digital communication is distributed within the same circuits between an image processing computer and the motor control circuit board. Each motor control board receives power and data from the distribution circuit boards to execute motor movement resulting in movement in one or more of X, Y, Z, roll, pitch, and yaw degrees of freedom. The image processing computer receives a hardwire data connection and power from the power and data distribution circuit boards and controls the motor movement circuit board and image display from the projector via the same power and data network.

The projector alignment system provides attachment points to secure each projector alignment system to a custom base plate that creates the array of projector alignment systems and provides power to each projector alignment system. The custom base plate provides grounding for data connection and power connection to each projector alignment system, as well as arranging each projector alignment system in an array as needed for the desired printing bed area. The base plate assists with heat management within the array. Each projector alignment system is in close proximity to the other projector alignment systems within the array. The close proximity of the projector alignment systems leaves little room for natural heat dissipation, which may cause the DLP chips and other sensitive electronic devices, such as microprocessors, on each projector alignment system to overheat and degrade life expectancy. The base plate includes fans to provide forced convection directly on the DLP chips on each projector, as well as around each projector alignment system, to keep the cavity housing of the entire array cool. A first set of fans, in an example half of the fans, include a shroud to direct air onto the DLP chips, while a second set of fans, in the example the other half of the fans, blow air upward throughout the cavity. Exhaust fans are mounted to side panels lining the cavity above the projector alignment systems to direct hot air out of the cavity.

In another aspect, example embodiments provide methods and devices for creating a liquid resin/immiscible liquid interface for a 3D printer liquid vat. The technology allows a 3D printer to 1) create and control a laminar flow of an immiscible liquid under a liquid resin in a liquid vat; 2) align the flowing liquid resin/immiscible liquid interface with the mechanical and optical elements of the 3D printer; and 3) manage the temperature and level of the liquid resin and immiscible liquid.

The interface material flow solutions described herein provides an advantage for a system with a flowing interface between an immiscible liquid that acts as an interface material below a liquid resin by actively cooling the interface material, thereby enabling larger and faster printing, unlike conventional technologies that can act as thermal insulators. The active cooling of the liquids in the liquid vat and the curing resin is achieved by creating a laminar flow underneath the liquid resin. The flowing interface material absorbs heat from the cured polymerizing resin and the surrounding liquid resin and removes the heat from the system. The interface material below the interface remains optically transparent and consistent such that light/radiation is able to pass through to the curing part. That is, the interface material below the interface does not create turbulent eddies or optical gradients through variation in flow velocities across the width of the build area. The interface between the interface material and the liquid resin is aligned with the build platform. The flowing interface material maintains a distinct layer separation between the liquid resin and the interface material to allow the liquid resin in the liquid vat to properly polymerize. Proper interface alignment is difficult to achieve through parameter adjustment. The technologies described herein can provide interface material at a consistent, repeatable height of the flow of interface material, which maintains the resin/interface material interface allowing control of the process.

The methods and devices described herein cause the flow of interface material under the interface to be laminar, of proper height, and of appropriate flow rate to remove the required heat. Flow manifolds distribute the flow of interface material evenly and create a laminar flow. Support structures keep build plates in proper alignment with the liquid vat and the interface. Level and temperature controls detect and control flow rates, build rates, and liquid vat levels.

In another aspect, example embodiments provides methods and devices for creating, controlling, and managing a liquid resin/interface material interface in a 3D printer liquid vat. The technology allows a 3D printer to provide feedback loops in 3D printing to control 1) the temperature of a 3D printed part and surrounding environment, 2) the forces applied to the 3D printed part, 3) the amount and rate of UV light that is applied to the 3D printed part, and 4) a supply of resin to the active print area.

Certain systems that utilize an interface between the liquid resin and an interface material, such as an interface material. In these systems, active cooling of the liquid resin and the cured resin is achieved by creating a laminar flow of the interface material beneath the liquid resin. The interface material flows under the resin in the liquid vat and forms an interface between the liquid resin and the interface material. This interface material flowing beneath the interface with the liquid resin absorbs heat from the polymerizing resin through the interface and removes the heat from the system.

The technology described herein provides an advantage of a system with a flowing interface between an interface material below a liquid resin by actively cooling the interface material thereby enabling larger and faster printing, unlike conventional technologies that can act as thermal insulators. The active cooling of the liquids in the liquid vat and the curing resin is achieved by creating a laminar flow underneath the liquid resin. The flowing interface material absorbs heat from the cured polymerizing resin and the surrounding liquid resin and removes the heat from the system. The interface material below the interface remains optically transparent and consistent such that light/radiation is able to pass through to the curing part. That is, the interface material below the interface does not create turbulent eddies or optical gradients through variation in flow velocities across the width of the build area. The interface between the interface material and the liquid resin is aligned with the build platform. The flowing interface material maintains a distinct layer of separation between the liquid resin and the interface material to allow the liquid resin in the liquid vat to properly polymerize. Proper interface alignment is difficult to achieve through conventional parameter adjustment. The technology described herein can provide interface material at a consistent, repeatable height of the flow of interface material, which maintains the resin/interface material interface allowing control of the process.

Many variable inputs may be controlled to manage the printing of a single part. Each printed part has a unique set of parameters that differentiates the printing process of the part from other parts made for different applications. Each part has inputs such as a geometry of the part, material and speed used to print the part, and the controls of input parameters to create the desired characteristics of the printed part. The input variables for the process of making the parts can be controlled, and the technology described herein provides a feedback loop that is constantly evolving to meet the optimal input levels for the part that is being printed.

The feedback loops may use inputs that are introduced by the active flow of interface material and resin, the curing of the photopolymerization resin, and other factors such as the humidity of the printer environment and the ambient temperature. During the operation of the 3D printer, a constant feedback loop aided by sensors fitted throughout the printer indicate different parameters encountered during the printing process.

The sensors may continuously communicatee with software on an interconnected computer network or device to report a status of a printing parameter. The computer network changes various printing parameters based on the sensor inputs. The parameters may include a temperature of the interface material and resin, flow rate of interface material, the humidity and temperature of the print environment, alignment parallelism, and liquid levels. The variety of sensors employed in the process to detect these parameters may include temperature probe thermistors, tilt sensors, pressure sensors, humidity sensors, fluid level detecting sensors, and other suitable sensors.

These and other aspects, objects, features, and advantages of the example embodiments will become apparent to those having ordinary skill in the art upon consideration of the following detailed description of illustrated example embodiments.

### BRIEF DESCRIPTION OF THE DRAWINGS

The drawings are appended hereto and form a portion of this disclosure.

FIG. 1 is a block flow diagram depicting a method to remove contaminants from a interface material liquid flow.

FIG. 2 is a side view of one embodiment of a reverse J material separator.

FIG. 3 is a side view of one embodiment of a vertical material separator.

FIG. 4 is a picture of a 3D printer with air bubbles entrained in the interface material.

FIG. 5 is a picture of a 3D printer with air bubbles removed from the interface material.

FIG. 6 is a picture of a working reverse J material separator.

FIG. 7 is a picture of a working column material separator.

FIG. 8 is a picture of a working column material separator installed in a housing connected to a 3D printer.

FIG. 9 is an illustration of alternate material separator designs.

FIG. 10 is an illustration depicting a material separator for liquid resin and interface material.

FIG. 11 is an illustration of a material separator 1000 depicting the baffles 1101 inside the body.

FIG. 12 is an illustration of a material separator depicting the baffles with perforations.

FIG. 13 is an illustration of an expanded view of a material separator with a middle inlet.

FIG. 14 is an illustration of a material separator with a middle inlet.

FIG. 15 is an illustration of a liquid vat of a 3D printer and a interface material flow path.

FIG. 16 is an illustration of a fluid handling and thermal management unit.

FIG. 17A-B—FIG. 17A is a perspective view of a projector alignment system. FIG. 17B is a picture of a projector alignment system depicting custom engineered circuit boards.

FIG. 18 is a perspective view of a linkage of a parallel manipulator.

FIG. 19A-B—FIG. 19A is a top view of the position of the linkages on a base platform of a parallel manipulator. FIG. 19B is a top view of the position of the linkages on a global platform of a parallel manipulator.

FIG. 20A-G—FIG. 20A is a top view of the position of the linkages on a base platform of a parallel manipulator. FIG. 20B is a top view of the position of the linkages on a global platform of a parallel manipulator. FIG. 20C is a top view of the position of the linkages on a base platform and the position of the linkages on a global platform of a parallel manipulator illustrating the single plane of symmetry of the parallel manipulator. FIG. 20D is a perspective view of a parallel manipulator illustrating the position of the linkages relative to a base platform and a global platform. FIG. 20E is a top view of the position of the linkages on a base platform and the position of the linkages on a global platform of a parallel manipulator illustrating the single plane of symmetry of the parallel manipulator without self-symmetry. FIG. 20F is a perspective view of a conventional Stewart platform illustrating three planes of symmetry on the top and bottom plate of the Stewart platform. FIG. 20G is a perspective view of a conventional Stewart platform illustrating the position of the linkages on the top and bottom plates and the three planes of symmetry with self-symmetry.

FIG. 21 is a perspective view of an array of projector alignment systems.

FIG. 22 is a top view of an array of projector alignment systems depicting the alignment of each of the projector alignment system projection areas.

FIG. 23 is a top view picture of the projector alignment systems' cooling fans.

FIG. 24 is a bottom side picture of the projector alignment systems' cooling fans.

FIG. 25 depicts calculations to determine performance of the cooling fans.

FIG. 26 is a front view illustration of a projector alignment system.

FIG. 27 is a picture of the hard wiring between the carrier board, the dart board, the power distribution board, and the motor control board.

FIG. 28A-C—FIGS. 28A, 28B, and 28C depict a schematic design of the custom printed circuit board for power and data transmission throughout the projector alignment system.

FIG. 29A-C—FIGS. 29A, 29B, and 29C depict a layout design of the custom printed circuit board for power and data transmission throughout the projector alignment system.

FIG. 30 is a top view illustration of the projector alignment systems projecting an alignment template.

FIG. 31 is a top view illustration of a subsection of the projector alignment systems projecting an alignment template.

FIG. 32 is a illustration of a visual alignment system.

FIG. 33 is picture depicting the visual alignment system attached to a 3D printer.

FIG. 34 is a top view picture depicting the visual alignment system supported by a post attached to the base plate.

FIG. 35 is a side view picture depicting the visual alignment system supported by a post.

FIG. 36 is an illustration depicting a portion of the projection area captured by the visual alignment system.

FIG. 37A-C—FIG. 37A is an illustration indicating the six degrees of freedom of the projector alignment systems. FIG. 37B is a top view illustration of an array of projector alignment systems. FIG. 37C is a perspective view and a front view of a projector alignment system.

FIG. 38 is a block flow diagram depicting a method to align projectors in an array of projector alignment systems in a 3D printer, in accordance with certain examples.

FIG. 39 is picture of a liquid vat of a 3D printer.

FIG. 40 is an illustration of the liquid vat of a 3D printer with flow manifolds denoted.

FIG. 41 is an illustration of an isobaric flow divider.

FIG. 42 is an illustration of the outlet of the flow divider.

FIG. 43 is an illustration of flow straighteners.

FIG. 44 is a picture of an example fluid handling and thermal management system.

FIG. 45 is an illustration of a fluid handling and thermal management system.

FIG. 46 is a picture of the fluid handling and thermal management system.

FIG. 47 is an illustration of a single rack of fluid handling and thermal management systems servicing two 3D printers.

FIG. 48 is an illustration of a 3D printer with a hard mounted Z-arm.

FIG. 49 is an illustration of the mounting bracket for the Z-arm.

FIG. 50 is an illustration of the mounting bracket for the Z-arm.

FIG. 51 is a picture of the Z-arm unassembled.

FIG. 52 is an illustration of the Z-arm being assembled.

FIG. 53 is a picture of the Z-arm being assembled.

FIG. 54 is an illustration of the Z-arm and liquid vat being assembled.

FIG. 55 is an illustration of temperature sensors arrayed on a liquid vat.

FIG. 56 is an illustration of sensors arrayed on an outlet manifold of a liquid vat.

FIG. 57 is an illustration of a liquid vat with an upper-level sensor and a lower-level sensor.

FIG. 58 is a schematic for a custom designed printed circuit board.

FIG. 59 and FIG. 60 are layouts for the custom designed PCB.

FIG. 61A is an illustration of a system with ultra-sonic sensors with a interface material channel.

FIG. 61B is a top view of the liquid vat and the channel.

FIG. 62 is an illustration of a submerged laser level with mirrors.

FIG. 63 an illustration of a submerged laser level signal generator with a separate detector.

FIG. 64 is an illustration of a build plate with perforations.

FIG. 65 is an illustration of fluid flow in a liquid vat using a build plate with perforations.

FIG. 66 is a is a picture of a build plate with perforations.

FIG. 67 is a picture depicting a custom build plate pattern.

FIG. 68 is an illustration of a build plate design and a picture of the build plate associated with the design.

FIG. 69 is an illustration of a build plate design and a picture of the build plate associated with the design.

FIG. 70 is a picture of a build plate with a varying thickness.

FIG. 71 is an illustration of a perspective view of a mounting system for a build plate.

FIG. 72 is an illustration of a front view of a mounting system for a build plate.

FIG. 73 is an illustration of a side view of a mounting system for a build plate.

FIG. 74A is an illustration of a kinematic coupling mechanism.

FIG. 74B is an illustration of a sphere and groove assembly of a kinematic coupling mechanism.

FIG. 75 is an illustration of a removable insert in a resin vat.

FIG. 76 is a block flow diagram illustrating a feedback loop for a 3D printer.

FIG. 77 is an illustration of fluid flow in a liquid vat using a build plate.

FIG. 78 is an illustration of fluid flow in a liquid vat with a resin void.

FIG. 79 is an illustration of fluid flow in a liquid vat with variable UV light intensity.

FIG. 80 is an illustration of multiple gelation height options.

FIG. 81 is an illustration of a printed part in which gelation height was not controlled.

FIG. 82 is an illustration of a printed part in which gelation height was appropriately controlled.

FIG. 83A is an illustration of a slice of a printed part with controlled gelation heights using a straight-line skeleton and graphic illumination algorithm.

FIG. 83B is an illustration of a slice of a printed part with controlled gelation heights using a polygon offset algorithm.

FIG. 84 is an illustration of a slice of a printed part with controlled gelation heights using a gradient polygon offset algorithm.

FIG. 85 is an image of a 3D printer comprising multiple sensors.

FIG. 86 is an illustration of strain gauges that are connected to fingers on a build plate.

FIG. 87 is an illustration of temperature sensors arrayed on a liquid vat.

FIG. 88 is an illustration of temperature sensors arrayed on an outlet manifold of a liquid vat.

FIG. 89 is a block flow diagram depicting a feedback loop to control interface material flow based on temperature and interface material flow rates.

FIG. 90 is a schematic for a custom designed printed circuit board.

FIG. 91 and FIG. 92 are layouts for the custom designed PCB.

FIG. 93 is a block flow diagram depicting a feedback loop to control cooling fans based on ambient temperature and ventilation fan speeds.

FIG. 94 is a block flow diagram depicting a feedback loop to control temperature based environmental humidity.

FIG. 95 is an illustration of tilt sensors on a light engine platform.

FIG. 96 is an illustration of tilt sensors on a liquid vat.

FIG. 97 is an illustration of a mounting location on a platform for a tilt sensor.

FIG. 98 is an illustration of a tilt sensor mounted on a mounting location on a platform.

FIG. 99 is an illustration of a mounting location on a liquid vat for a tilt sensor.

FIG. 100 is an illustration of a tilt sensor mounted on a mounting location on a liquid vat.

FIG. 101 is a block flow diagram depicting a feedback loop to control platforms based on tilt sensors.

FIG. 102 is an illustration of a liquid vat with an upper-level sensor and a lower-level sensor.

FIG. 103 is a block flow diagram depicting a feedback loop to control resin and interface material level based on fluid level sensors.

FIG. 104 is an image of a pressure transmitter in a glycol line.

FIG. 105 is an image of a pressure transmitter and a pressure sensor shut off in a glycol line.

FIG. 106 is an illustration of a system with ultra-sonic sensors with an interface material channel.

FIG. 107 is a top view of the liquid vat and the channel.

FIG. 108 is an illustration of a submerged laser level with mirrors.

FIG. 109 an illustration of a submerged laser level signal generator with a separate detector.

FIG. 110 is an illustration of a photodiode sensor to align a build plate.

FIG. 111 depicts a computing machine and a module.

### OVERVIEW

In one aspect, embodiments described herein provide material separator devices, and methods of using same, for separating contaminants in 3D printing fluids without the use of a mechanical filter. The material separator allows for removal of air bubbles, photopolymerization resin, and other buoyant contaminants from a liquid/hydrogel interface material without using filtering media. The material separator uses the natural buoyancy of contaminants, such as air bubbles and trapped photopolymerization resin, to remove the contaminants from the interface material that flows beneath an interface between interface material and the liquid resin in a 3D printer.

In another aspect, embodiments described herein provide a projector alignment device, and methods of using same, for aligning projectors with six degrees of freedom in 3D printers. The projector alignment system is configured to align individual projectors in an array of projectors within a 3D printer with movement in X, Y, Z, roll, pitch, and yaw degrees of freedom while conforming to a footprint that is smaller than the desired projection area of each projector.

In another aspect, embodiments describe herein provide fluid and cooling interface systems, and methods of use thereof, that allow, for example, a 3D printer to 1) create and control the laminar liquid resin/interface material interface; 2) align the flowing liquid resin/interface material interface with the mechanical and optical elements of the 3D printer; and 3) manage the temperature and level of the liquid resin and interface material.

In another aspect, embodiments provided herein provide sensor feedback systems, and methods of use of same, that may operate within a 3D printer environment to provide feedback loops in 3D printing to control 1) the temperature of a 3D printed part and surrounding environment, 2) the forces applied to the 3D printed part, 3) the amount and rate of UV light that is applied to the 3D printed part, 4) a supply of resin to the active print area, or a combination thereof.

In another aspect, embodiments described herein comprise 3D printing systems comprising one or more of the above referenced aspects. For example, a 3D printing device may comprise the materials separator, project alignments devices, fluid and temperature cooling interface systems, sensor feedback systems, or any combination thereof.

### Material Separator

The examples described herein provide methods and devices for separating contaminants in 3D printing fluids without the use of a mechanical filter. The process provides a technology to remove air bubbles, photopolymerization resin, and other buoyant contaminants from a liquid/hydrogel interface material without using filtering media. The material separator uses the natural buoyancy of contaminants, such as air bubbles and trapped photopolymerization resin, to remove the contaminants from the interface material that flows beneath an interface between interface material and the liquid resin in a 3D printer.

In certain systems that utilize an interface between the liquid resin and an interface material, such as an immiscible liquid, the active cooling of the liquid resin and the cured resin is achieved by creating a laminar flow of the interface material underneath the liquid resin. The interface material flows under the resin in the liquid vat and forms an interface between the liquid resin and the interface material. This flowing interface material flowing beneath the interface with the liquid resin will absorb heat from the polymerizing resin through the interface and remove the heat from the system. However, contaminants that become entrained in the liquid resin and in the interface material can interfere with the polymerizing light and introduce defects into a part being printed. The contaminants may include dirt, excess cured resin, or even air bubbles that are trapped in the liquid resin or the interface material. These foreign contaminates may interfere with the polymerizing light and cause defects in the printed parts. In liquid/liquid systems that use an active flow of interface material, small amounts of air and resin may become trapped in the flowing liquid via multiple causes, including accidental contamination by users, sedimentation of resin, localized turbulence, or capillary entrapment. Conventional systems have attempted to remove the contamination with particle filters, such as sintered metal, fiber, paper, micro-mesh, or combinations of these materials.

Mechanical particle filters are not an effective solution for all contaminants. For example, air bubbles can both clog and bypass traditional filtering media. When encountering a filter, the air bubbles may adhere to the small pores of the filter preventing the interface material from passing through the filter. When a sufficient number of air bubbles are adhered to the filter, the filter may become substantially clogged. Conversely, even if the filter is not clogged, air bubbles may also be shredded into micro bubbles by the filtering medium and the fluid pressure. The micro bubbles then have a size that is smaller than the filters effective filtration size and are released into the interface material medium, turning one bubble from one potential defect into hundreds or even thousands of potential defects.

Another contaminant that interferes with the interface between the interface material and the liquid resin is the photopolymerization liquid resin. Trace amounts of liquid resin may be entrained by the interface material when passing below the printed part. Filtration media may remove a portion of the liquid resin, however, because the entrained liquid, solid, or gelatinous resin particles are common in the 3D printing process and will constantly be introduced into the interface material, the filters are at risk for becoming clogged prematurely. Thus, conventional technologies are not configured to remove the liquid resin from the interface material before reaching the filters.

The interface material can comprise a flowing fluid. Examples of flowing fluids include an aqueous liquid, an organic liquid, a silicone liquid, and a fluoro liquid. The terms interface material, PFPE, PFPE oil, fluoro oil, or oil, may be used throughout the specification to represent any suitable interface material used in the liquid/liquid interface system.

Alternatively, aqueous liquids used as the interface material can include, but are not limited to, water, deuterium oxide, densified salt solutions, densified sugar solutions, and combinations thereof. Example salts and their solubility limit in water at approximately room temperature include NaCl 35.9 g/100 ml, NaBr 90.5 g/100 ml, KBr 67.8 g/100 ml, MgBr2 102 g/100 ml, MgCl2 54.3 g/100 ml, sodium acetate 46.4 g/100 ml, sodium nitrate 91.2 g/100 ml, CaBr2 143 g/100 ml, CaCl2 74.5 g/100 ml, Na2CO3 21.5 g/100 ml, NH4Br 78.3 g/100 ml, LiBr 166.7 g/100 ml, KI 34.0 g/100 ml, and NaOH 109 g/100 ml. Thus, for example, a 100 ml solution of 35.9 g NaCl has a density of 1204 kg/m3.

Example sugars used as the interface material and their solubility limit in water at approximately room temperature include sucrose 200 g/ml, maltose 108 g/100 ml, and glucose 90 g/100 ml. Thus, for example, a 60% sucrose water solution has a density of 1290 kg/m3 at room temperature. Silicone liquids can include, but are not limited to, silicone oils. Silicone oils are liquid polymerized siloxanes with organic side chains. Examples of silicone oil include polydimethylsiloxane (“PDMS”), simethicone, and cyclosiloxanes. Fluoro liquids can include, but are not limited to, fluorinated oils. Fluorinated oils generally include liquid perfluorinated organic compounds.

Examples of fluorinated oils used as the interface material include perfluoronalkanes, perfluoropolyethers, perfluoralkylethers, perfluorocarbons (“PFCs”), co-polymers of substantially fluorinated molecules, and combinations of the foregoing. Organic liquids can include, but are not limited to, organic oils, organic solvents, including but not limited to chlorinated solvents (such as dichloromethane, dichloroethane and chloroform), and organic liquids immiscible with aqueous systems. Organic oils include neutral, nonpolar organic compounds that are viscous liquids at ambient temperatures and are both hydrophobic and lipophilic. Examples of organic oils include, but are not limited to, higher density hydrocarbon liquids. In embodiments, the interface material comprises a silicone liquid, a fluoro liquid, or a combination thereof.

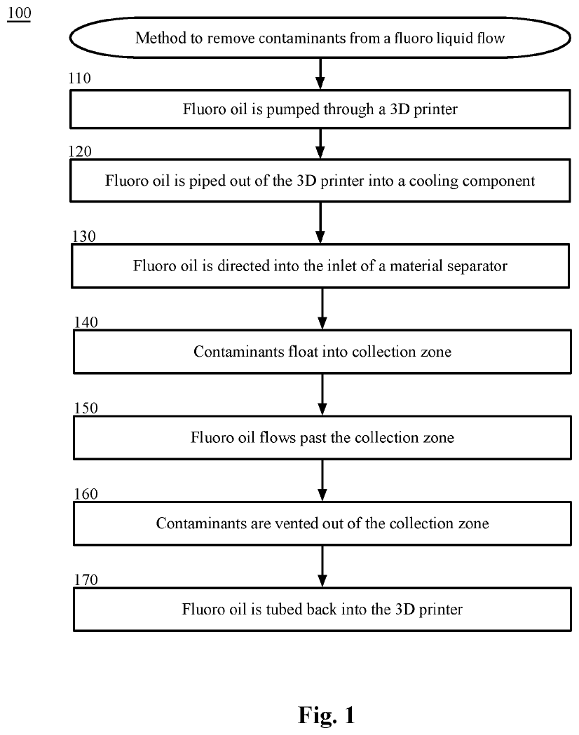

FIG. 1 is a block flow diagram depicting a method to remove contaminants from a interface material liquid flow.

In block 110, the interface material is pumped through a 3D printer. In certain 3D printers, when a layer of cured resin is formed at the bottom of the liquid vat on the surface of the window, the cured resin will adhere to the build plate, previously cured layers, and the window at the bottom of the liquid vat. The 3D printers may pump the interface material through the liquid vat to provide a continuous layer for dewetting the cured resin. The interface material is pumped through the liquid vat continuously or periodically to allow the interface material to be cooled and to have contaminants removed. The interface material forms a thin layer along the window at the bottom of the liquid vat. An interface caused by the different densities of the interface material and the resin is formed with the interface material on bottom and the liquid resin on top. The interface material flows slowly across the surface of the window. The interface material removes heat and contaminants from the liquid resin and the part. The interface material prevents the cured resin from adhering to the window.

In block 120, the interface material is piped out of the liquid vat of the 3D printer into a cooling component. The cooling component may be a heat exchanger or other type of cooling device to remove heat from the interface material. The interface material is forced through the tubing and the cooling component by pressure created by the pump or other device in the 3D printer. In certain examples, the cooling component is before the material separator and in certain examples, the cooling component is after the material separator.

The term “tube” is used herein to represent any tubing, piping, channel, or other plumbing elements through which the interface material or any other material may be pumped from one equipment location to another.

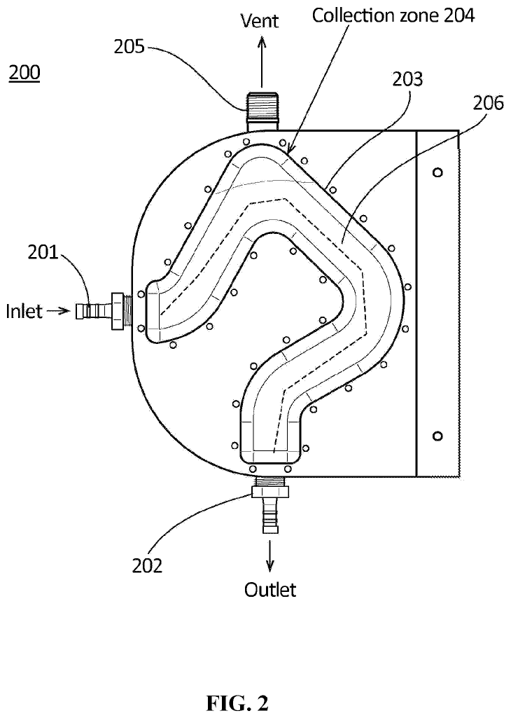

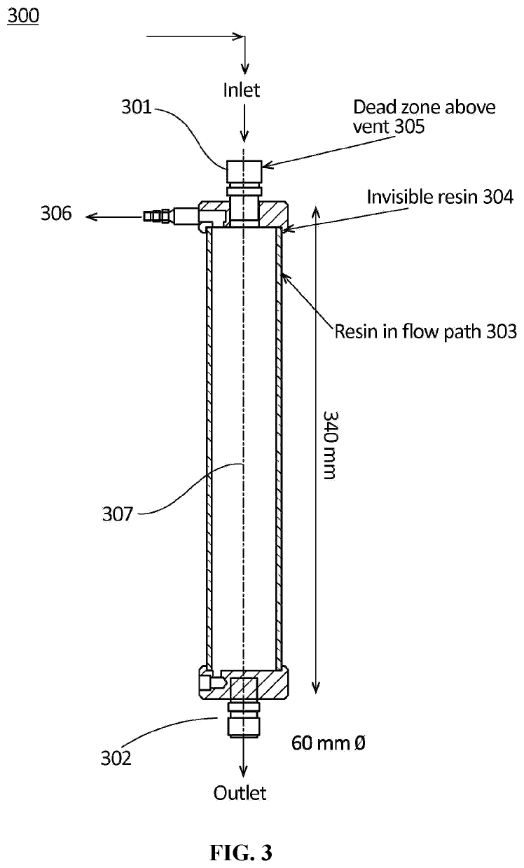

In block 130, the interface material is directed into the inlet of a material separator. FIG. 2 and FIG. 3 illustrate two versions of material separators for removing the buoyant contaminants. FIG. 2 is a side view of one embodiment of a reverse J material separator 200.

The material separator 200 is depicted with an inlet 201 and an outlet 202. The interface material that is pumped to the material separator 200 enters via the inlet 201 into the body of the material separator 200. As depicted, the tube 206 that channels the interface material inside the material separator 200 has a larger diameter than the inlet tube 201. The larger size tube 203 in the material separator 200 creates a slower interface material velocity than at the inlet 201. An example material separator 200 may have approximately 4.7 liters of volume inside the tubes, but other volumes of tubes, such as 1, 2, 5 or 10 liters may be used. Utilizing a volume that creates a slower velocity in the tubes allows the contaminants that are buoyant in the interface material more time to float to the top of the tube 203. In other examples, the internal tube 203 may be replaced or supplemented with a chamber or other compartment. For example, the tubing may lead to a compartment inside the material separator in which the flow is allowed to stagnate. The slowed flow allows the contaminants more time to float to the top.

The buoyancy separation is effective for any two fluids (or gases) that have a density difference of approximately 0.5 g/cm\hat{ }3 or 50%. In an example, a liquid resin may have a density of approximately 1.1 g/cm\hat{ }3, while the interface material has a density of approximately 1.9 g/cm\hat{ }3. These two densities provide a difference of 0.8 g/cm\hat{ }3 or approximately 70%. Under these conditions, buoyancy separation should be effective.

Slowing the velocity of the material being separated provides the contaminants time to float to the collection zone. However, the effectiveness of the material separator is determined by the amount of time required for the minimum contaminant size to “float” across the width of the pipe compared to the amount of time required to float along the length of the pipe. A “terminal velocity equation” provides a calculation of whether the material separator will be effective in example conditions. The actual flow velocity, the effect of orientation on flow direction/speed, fluid properties, and other factors contribute the determination of the capabilities of the material separator. However, the calculation allows a user to determine the minimum size of contaminant that will be able to float upwards into the collection area faster than the contaminant can float “across” the pipe.

A fundamental limit of the size of containment that a typical material separator used in 3D printing can accommodate is determined by the Bond Number (or Eotvos number). The Bond Number (“Bo”) is the ratio between gravitational forces (buoyancy) and surface tension forces. In the case of the material separator operated as described herein, the Bo for a 0.3 mm bubble is 1. The material separator will work for all bond numbers approximately 1 and greater. For bond numbers less than 1 surface tension may trap the contaminants in the fluid preventing the contaminants from floating upwards into the collection zone. The equation for Bo is as follows:

$$B o = \frac{( {ρ}_{1} - {ρ}_{2} ) g {r}^{2}}{σ}$$

where ρ₁ and ρ₂ are the densities of the interface material and the contaminant respectively, g is acceleration due to gravity, r is the radius of the contaminant and σ is the surface tension of the interface material. The flow of the interface material is depicted in FIG. 2 as flow 206. The flow 206 of the interface material is past the collection zone 204. The collection zone 204 is located at the highest point in the material separator 200 and collects the floating or buoyant contaminants as the interface material flows past. The shape of the tube 203 causes the buoyant contaminants to enter the collection zone and stagnate at that location. The shear forces of the interface material continuing in a downward motion along the flow 206 is insufficient to cause the buoyant contaminants to be pulled downwards. The contaminants remain in the collection zone. In an example calculation using a resin particle size that is smaller than typical, the buoyancy force requires approximately 55 mm to separate resin and interface material. Other buoyancy forces may be needed for different particle sizes or other contaminants, such as 1 mm, 10 mm, 100 mm, or more.

The material separator 200 has a vent 205 for retrieving the contaminants from the collection zone. Any air particles or less dense fluids or solids would escape through the vent 205 when forced by pressure in the flow 206. The vent 205 may be operated in any sufficient manner to allow the contaminants to escape. For example, the vent 205 may be opened periodically, either manually or automatically, with a ball valve or other valve. In an example, sensors could be used to determine a level of contaminants in the collection zone. When the sensors indicate a greater level of contaminants in the collection zone, a computer controller may direct an automatic valve on the vent to open. For example, the vent may be opened based on a signal from a pressure sensor that senses a buildup of pressure from the contaminants. In another example, an optical sensor may detect the contaminants in the collection zone and provide a signal to open the vent. The vent 205 may be tubed to a collection basin or back to a recycling process.

The interface material exits the material separator 200 through the outlet 202 and is tubed back to the 3D printer, a storage vessel, or any suitable location.

The material separator 200 does not significantly increase the pump head required for the system. In certain examples, a material separator only increases the pump potential in a typical 3D printing system by as low as 3%. This low percentage of the pump potential in a typical system precludes the necessity for installing a larger pump to overcome pressure increases with other filter systems. A typical material separator 200 filtering interface material only requires approximately 1 kPa to 4 kPa of head to overcome. The pressure required to pump the interface material through a physical or mechanical particle filtration system is typically much higher than the pressure required to pump interface material through the material separator. In example systems, some mechanical filters may require 25 psi, 50 psi, or more from the pump to pass the interface material through the filtering media. An example material separator as described herein may use as low as 0.2 psi to 0.5 psi. Without a need to pump the interface material through a physical media, the material separator provides a minimal amount of back pressure or drag on the system. For example, a material separator may use larger tube sizes, which create less flow pressure. Further, the material separator may be constructed without any flow impediments. That is, the fluid flow enters the material separator, flows through the material separator, and leaves the material separator without encountering any equipment, filters, check valves, or other flow impediments. With the lower pressure requirements, a system with a material separator may be designed with smaller filters, smaller pumps, and smaller pluming pipes. The lower pressure allows the pumps to last longer and the filters to last longer with fewer replacements.

The material separator 200 is maintainable with bolted connections instead of using an epoxy to affix the material separator 200 to a housing. In examples, the material separator 200 uses an o-ring and bolt seals. Alternate versions of the material separator 200 may use RTV gaskets, epoxy, or any other suitable sealing method.

The material separator 200 may include an even distribution of bolt patterns around the tube 203 to keep the material separator 200 stable and secure. The material separator 200 may be purged by closing the inlet 201, opening the vent 205, and forcing pressure upwards through the outlet 202. The material separator 200 may be filled with interface material pumping the interface material into the vent 205, opening the inlet 201, and venting air downward out of the outlet 202.

FIG. 3 is a side view of one embodiment of a vertical material separator 300. The vertical material separator 300 operates similarly to the reverse J material separator 200 except that the flow of the tubes does not provide a collection zone, such as collection zone 204. In the vertical material separator 300, the flow of the interface material enters at the inlet 301. The interface material flows downward towards the outlet 302. The contaminants float upwards or stay at the top of the vertical material separator 300 because the buoyant forces are greater than the drag forces from the downward flowing interface material.

The vertical material separator 300 is illustrated with the interface material flowing in the flow path 307 downward towards the outlet 302. The resin 303 is floating at the top of the flow path 307 and an invisible resin layer 304 is floating above the resin 303. The contaminants are vented out of the vent 306 in a similar manner as described in FIG. 2.

Table 2 below illustrates calculations used to estimate the drag force and buoyancy force of air bubbles to analyze the effectiveness of a material separator. The calculations provide a method of determining the maximum flow speed, the effects of changing tube diameters, the effects of different densities and viscosities of the interface material, and other changes to the process.

Table 3 below illustrates further analysis of the materials separator design calculating the maximum speed at which a bubble of a certain size can float inside the interface material. The maximum speed calculation is used because the terminal velocity of a bubble needs to be greater than the flow speed of the oil for the bubble to “float” out of the oil. As the bubble gets smaller in diameter the terminal velocity gets smaller, so the calculation determines the smallest size bubble on which a specific material separator is effective.

Table 4 illustrates an example calculation of a numerical analysis on the reverse J material separator 300 calculating the smallest bubble that the material separator 300 could capture. In the calculation, 0.3 mm diameter bubbles were capturable; however, with some design changes, 0.1 mm bubbles could be captured as well.

Returning to FIG. 1, in block 140, the contaminants float into the collection zone. As described with respect to FIG. 2, the contaminants float upward into the collection zone and are not dragged by the flowing interface material to the outlet.

In block 150, the interface material flows past the collection zone. The interface material follows the tubing of the material separator to the outlet leaving behind some or all of the contaminants in the collection zone.

In block 160, the contaminants are vented out of the collection zone. The material separator has a vent for retrieving the contaminants from the collection zone. Any air particles or less dense fluids or solids would escape through the vent when forced by pressure in the flow. The vent may be operated in any sufficient manner to allow the contaminants to escape. For example, the vent may be opened periodically, either manually or automatically, with a ball valve or other valve. The vent may be tubed to a collection basin or back to a recycling process. Air bubbles may be released to the environment or collecting in filter or air collection device.

In block 170, the interface material is tubed back into the 3D printer. The interface material may be forced out of the material separator by the pressure provided by the pump in the 3D printer, by any additional pumps, or by gravity. The interface material follows the tube either to a collection reservoir or directly to the liquid vat. In certain examples, a mechanical filter may be utilized in conjunction with the material separator. For example, a mesh filter or a cartridge filter may filter the interface material after the material separator has initially removed all or a portion of the contaminants. In the example, a mechanical filter may not experience clogging issues because the material separator has removed most of the contaminants, and only a portion are remaining to be filtered.

The interface material that is reintroduced to the liquid vat is substantially free of contaminants and is cooled. The interface material may have new contaminants introduced in the liquid vat of the 3D printer as parts are printed. The interface material is continuously pumped through the liquid vat and back to the cooling chamber and material separator. The cooled, clean interface material does not become cloudy from the buildup of contaminants and allows for more effective and precise 3D printing.

In alternate examples, the material separator may be utilized on resins from other systems in addition to 3D printers. For example, resins used in coatings or chemical processing may use the material separator to remove contaminants.

In alternate examples, the system pumps the interface material into an open container (similar to the liquid vat 107 but without liquid resin on top of the interface material). The open top of the container is exposed to air. The open container serves as the collection zone, and the air bubbles vent to atmosphere. Further, other floating contaminants may be skimmed or removed from the surface.

In alternate examples, the material separator has multiple collection zones. For example, the material separator may flow upwards (or horizontally) to a collection zone and then flow downward. Some or all of the contaminants may be retained in the collection zone as described herein. In the example, after proceeding downward, the material separator internal tubing turns the flow back horizontally or upwards creating a second local maximum for the flow. A second collection zone may be created when the flow turns back downward after the second local maximum section. Any number of subsequent local maximums may be used in a material separator. Each collection zone may have a vent to remove the contaminants.

In alternate examples, the material separator does not have a vent to remove contaminants from the collection zone. In the example, the material separator may be removed and cleaned or replaced periodically or when the collection zone is full of contaminants.

In alternate examples, the material separator is a horizontal tube. In the horizontal tube, the contaminants collect at the top wall of the tube. The outlet of the horizontal tube is located on a bottom portion of the horizontal tube. The floating contaminants are buoyant to a degree that the contaminants will not be pulled down to the outlet by the flowing interface material.

In alternate examples, the material separator does not direct the flow upwards before the collection zone. For example, the flow of the interface material is horizontal for a section of the material separator. The horizontal flow is long enough to allow the contaminants to flow to the top of the horizontal section. The flow then turns downward away from the collection zone in the top of the horizontal section. The contaminants are buoyant enough that the contaminants are not dragged downward with the flowing interface material.

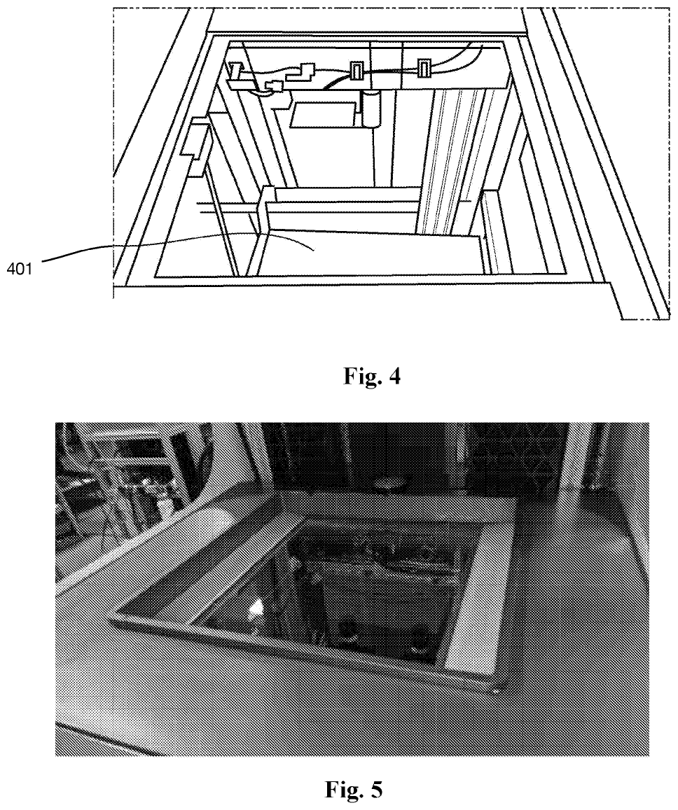

FIG. 4 is a picture of a 3D printer with air bubbles entrained in the interface material. The air bubbles, such as air bubble 401, interfere with the effective printing of the 3D printer because the air bubbles prevent the light from accurately and precisely reaching the resin.

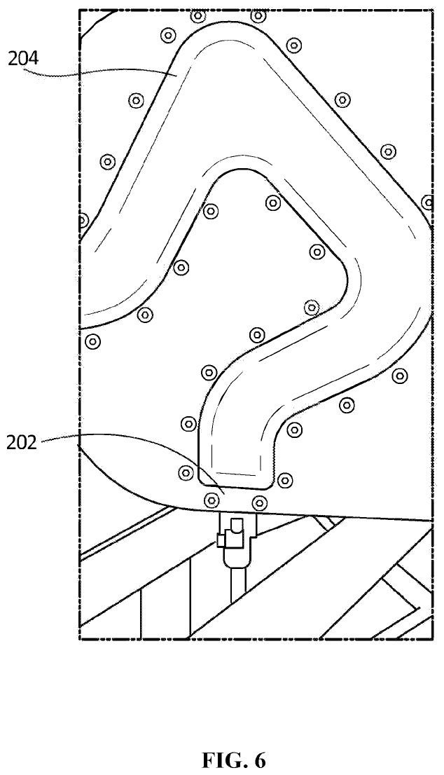

FIG. 5 is a picture of a 3D printer with air bubbles removed from the interface material. For example, if the interface material has been pumped through the liquid vat and through the material separator, the air bubbles will have been removed from the interface material. The interface material without air bubbles is recycled to the liquid vat. The interface material without the air bubbles would not create defects in the 3D printing process.

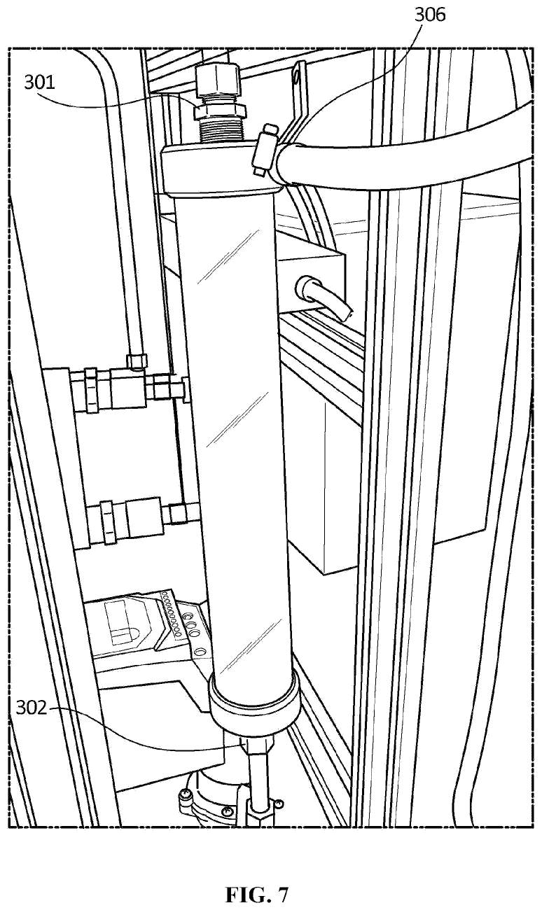

FIG. 6 is a picture of a working reverse J material separator. The material separator has air collecting in the collection zone 204. The air may be vented out of the collection zone 204 by a valve or other tubing or duct configuration out of the top of the material separator. The interface material is shown flowing beneath the collection zone 204 and out of the outlet 202.

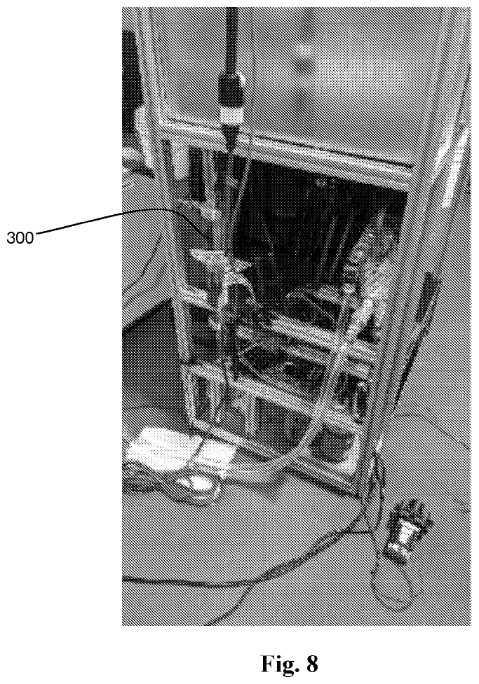

FIG. 7 is a picture of a working column material separator. The material separator has air collecting in the top of the material separator. The air may be vented out of the material separator by a vent 306 or other tubing or duct configuration out of the top of the material separator. The interface material is shown flowing into the material separator at the inlet 301 out of the material separator at the outlet 302.

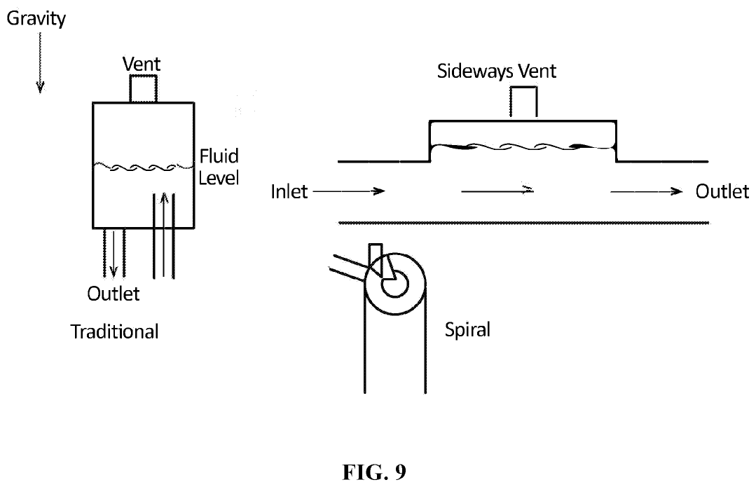

FIG. 8 is a picture of a working column material separator 300 installed in a housing connected to a 3D printer. The housing may be a compartment housing the material separator 300, a chiller component, and any other suitable components for cleaning, cooling, and returning the interface material to the 3D printer. The housing may be connected to, separate from, or integral with the 3D printer.

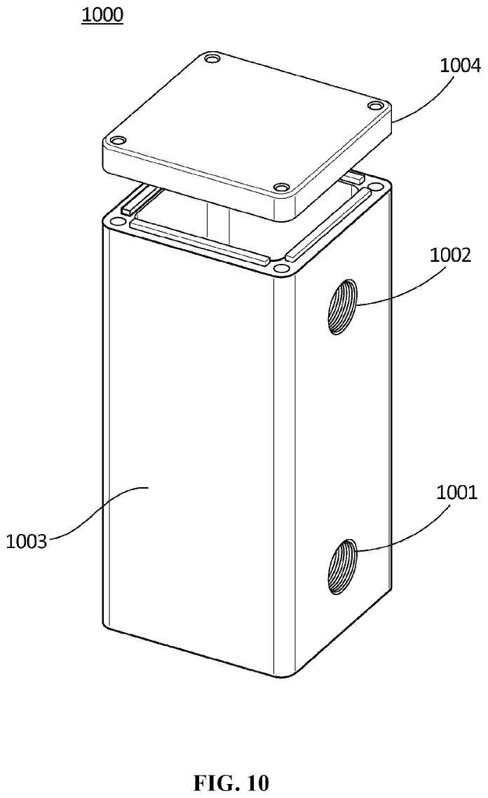

FIG. 9 is an illustration of alternate material separator designs. The alternates would utilize different geometries that help augment the buoyancy of the contaminants ability to separate the contaminants from the main flow of liquid/hydrogel interface material. The alternative designs would have an inlet and outlet for the main fluid flow along with a vent for the separated material to be removed. Certain alternative designs rely on changes in the flow direction (upwards to downwards flow and a spiral shape to the flow) to induce the separation of the resin and air from the interface material flows.

An additional alternative design would incorporate a gas permeable membrane to the vent with a one-way check valve. This membrane would allow for air that builds up in the collection zone to escape while preventing any of the fluid from passing through. Another alternative design would include initiating a vacuum on the gas permeable membrane. This vacuum would serve to extract any dissolved gas in the oil/interface medium.

Another additional alternative design would incorporate an additional port to the material separator that connects to a reservoir of interface material that could be pumped in and out of the system. The additional port would make servicing the machine more efficient, allow for automated changes in oil level, and automatic filling of the print chamber. One alternative design would combine this fourth port with the vent port. Another alternative design would make use of a throttling valve with this fourth port in order to more effectively automate changes in oil level.

Another potential alternate design would be to incorporate a skimmer in the collection zone to remove liquid/solid resin or other containments. The skimmer may be a belt, such as a cloth belt, or disk that collects liquid/solid build up on top of liquid. The buildup sticks to the skimmer belt and is scooped off the surface into a different container.

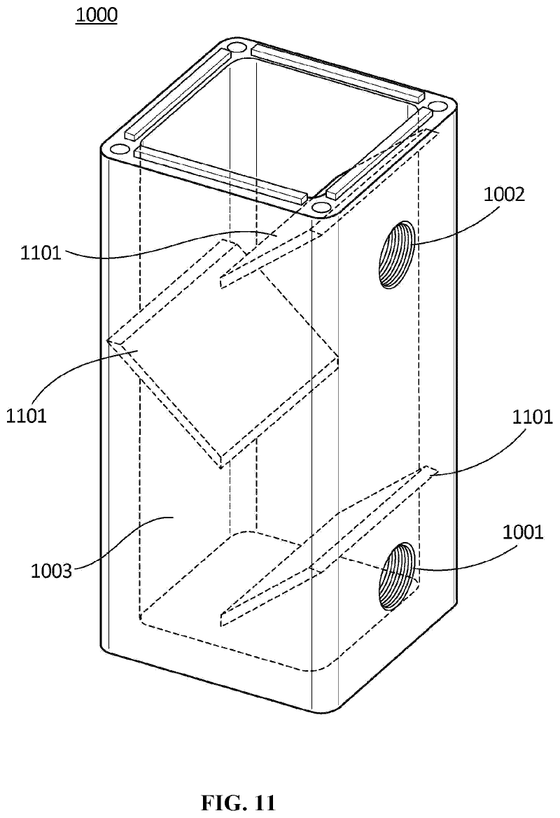

FIG. 10 is an illustration depicting a material separator 1000 for liquid resin and interface material.

The material separator 1000 is configured to separate liquid resin from interface material. In the example, the material separator 1000 receives a mixture of liquid resin and interface material and separates the resin and interface material. The separation is based on a buoyancy of liquid resin over the interface material. The liquid resin, after separation, may be returned to use in a 3D printer or in another suitable application. The interface material, after separation, may be returned to use in a 3D printer or in another suitable application.

The liquid resin, and any entrained interface material, enter the material separator 1000 at the bottom inlet 1001. The liquid resin and interface material may be pumped into the material separator 1000 from a liquid vat on a 3D printer, from a storage vessel, or from any suitable location. The material separator 1000 has baffles or other structures that cause the interface material to stagnate in the bottom of the material separator 1000. The liquid resin floats or rises to the top of material separator, and the interface material sinks to the bottom of the material separator 1000.

The material separator may have an outlet 1002 at a top portion of the material separator through which the liquid resin is channeled back to a 3D printer or a storage container for liquid resin. The material separator 1000 may have an outlet at a bottom portion of the material separator through which the interface material is channeled back to a 3D printer or a storage container for interface material. The material separator 1000 may have a removable top 1004 to allow cleaning or maintenance on the material separator 1000.

The volume of the material separator 1000 may be of a size to allow the liquid resin time to separate from the interface material before the liquid resin reaches the outlet 1002. That is, the fluids will separate, and the liquid resin will float above the interface material based on the difference in density of the two liquids. If the flow into the material separator 1000 is greater than a threshold, the interface material may be dragged by the upward flow faster than the interface material sinks below the liquid resin or the liquids may exit the material separator 1000 before the liquids have time to separate. The flow rate, the cross-sectional area of the material separator 1000, and the height between the inlet 1001 and the outlet 1002 are calculated to allow sufficient time for separation.

In an example, the material separator 1000 may have a drain on the lower portion opened or vented to remove the interface material that has sunk to the bottom of the material separator 1000. In another example, the drain is continuously open to allow the interface material to continuously drain out of the material separator 1000.

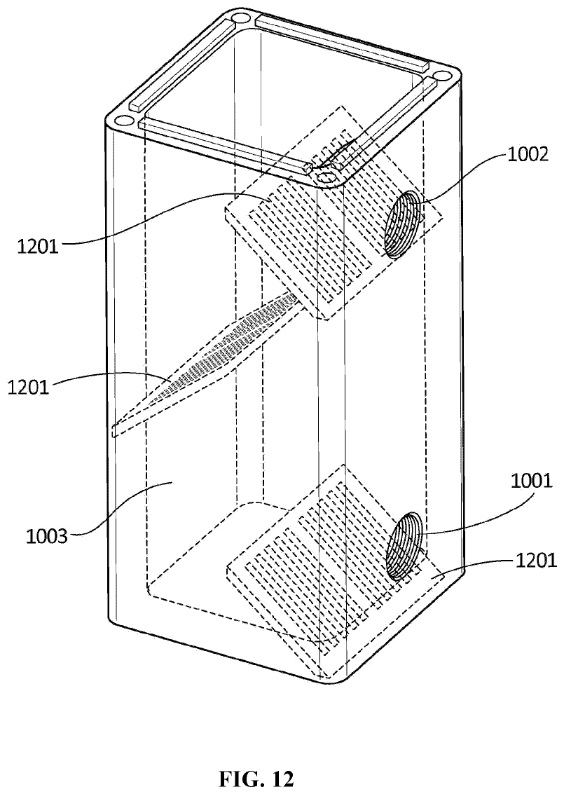

FIG. 11 is an illustration of a material separator 1000 depicting the baffles 1101 inside the body. The material separator 1000 has baffles that aid in the separation of the liquid resin from the interface material. The baffles create a calming effect to remove turbulence and eddies that may agitate and disturb flow. The entrained interface material suspended in the liquid resin will more easily separate if the flow is calmed and turbulence is dampened. Without the baffles, certain portions of the liquid resin flow with the entrained interface material may flow directly from the inlet 1001 to the outlet 1002 without a separating from the suspension. The turbulence in the liquids may keep the interface material in suspension with the liquid resin.

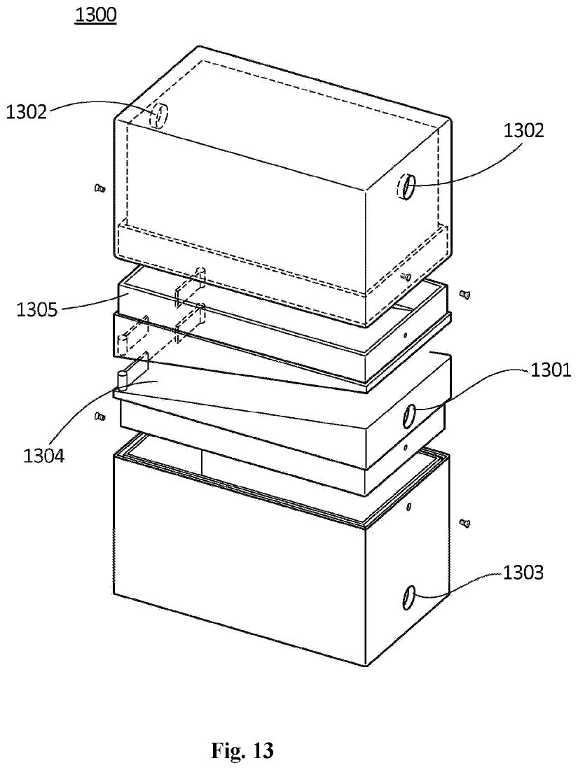

FIG. 12 is an illustration of a material separator 1000 depicting the baffles 1201 with perforations. The material separator 1000 has baffles 1201 that aid in the separation of the liquid resin from the interface material. The baffles 1201 are depicted with perforations. The perforations may further calm and distribute the flowing liquid resin to cause the interface material to drop out of suspension equally across a cross-sectional area of the flow path. The baffles with the perforations 1201 create a calming effect to remove turbulence and eddies and evenly distribute the flow. The entrained interface material suspended in the liquid resin will more easily separate if the flow is calmed and turbulence is dampened. Without the baffles, certain portions of the liquid resin flow with the entrained interface material may flow directly from the inlet 1001 to the outlet 1002 without a separating from the suspension.

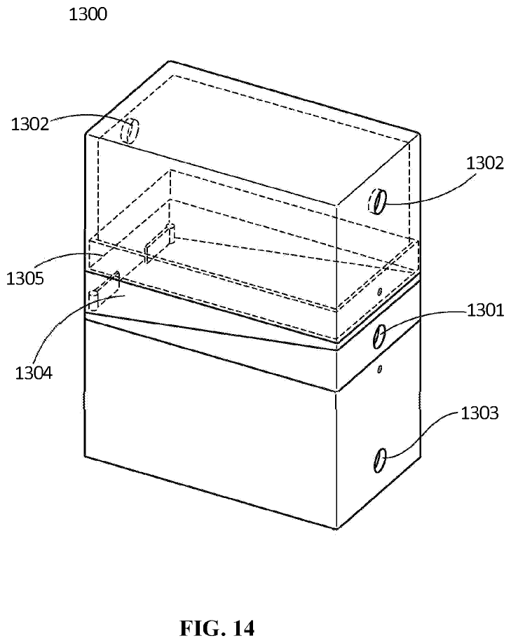

FIG. 13 is an illustration of an expanded view of a material separator 1300 with a middle inlet 1301. In the example, the material separator 1300 receives a mixture of liquid resin and interface material in the inlet 1301 located in the central portion vertically of the material separator 1300. The material separator 1300 separates the resin from the interface material based on the difference in densities. The interface material sinks down through the zones, such as zones 1304. The liquid resin floats upwards through the zones, such as zone 1305. The path through the zones provides an opportunity for the liquid resin to slow the flow velocity, and for the interface material to fall out of suspension. The interface material, after separation, flows downwards and exits the material separator 1300 at the outlet 1303. The liquid resin, after separation, flows upwards and exits the material separator 1300 at outlet 1302.

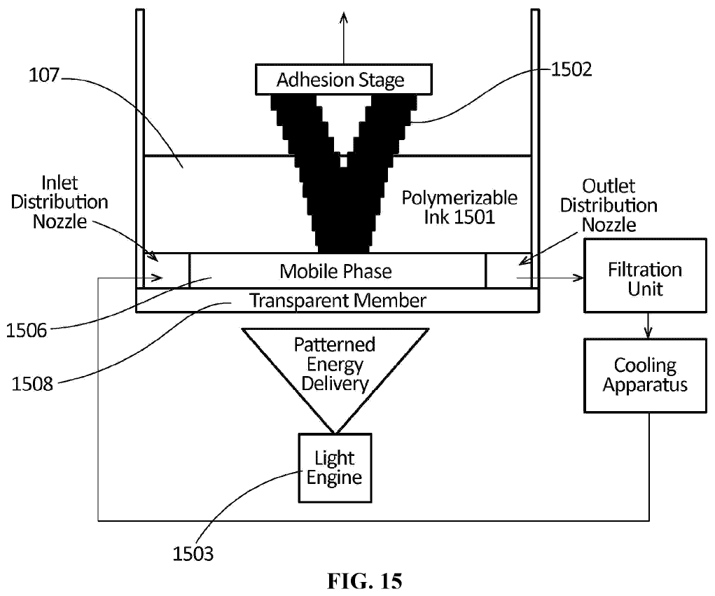

FIG. 14 is an illustration of a material separator 1300 with a middle inlet 1301. As described in FIG. 13, the material separator 1300 receives a mixture of liquid resin and interface material in the inlet 1301 located in the central portion vertically of the material separator 1300. The interface material, after separation, flows downwards and exits the material separator 1300 at the outlet 1303. The liquid resin, after separation, flows upwards and exits the material separator 1300 at outlet 1302.

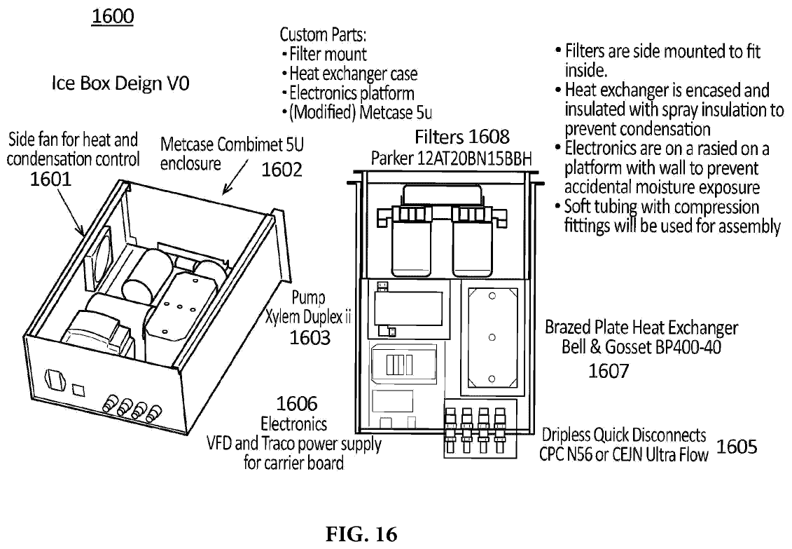

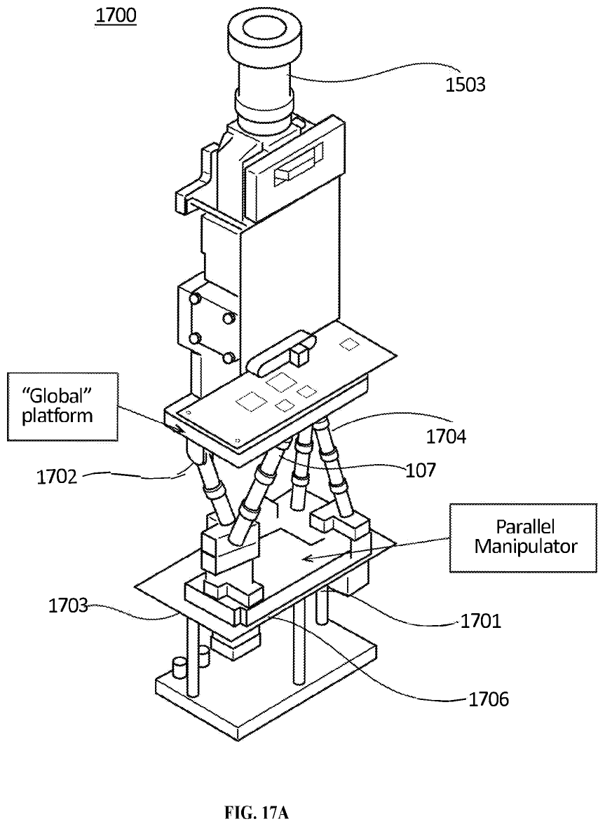

In certain examples, the material separators described herein are used in a 3D printing process. The material separator may be a component of a 3D printer, a fluid handling and thermal management that supplies cleaned, cooled interface material to the 3D printer, or any combination thereof. For example, the material separator may be mounted in a housing of the 3D printer, in the housing of a fluid handling system, or mounted independently. The material separator may be in line between the 3D printer and the fluid handling and thermal management. The 3D printing process and the fluid handling system are described in FIG. 15 and FIG. 16, respectively.

FIG. 15 is an illustration of a liquid vat 107 of a 3D printer 100 and the interface material flow path. The liquid vat stores a vat 107 of polymerizable ink 1501. The resin 1501 cures into a solid part 1502 upon exposure to the light from the light engine 1503. In the illustrated system, the active cooling of the liquid resin and the cured resin part is achieved by creating a laminar flow of interface material in a mobile phase 1506 beneath and interface with the liquid resin 1501. The interface material is pumped through the liquid vat 107 in the 3D printer. In certain conventional 3D printers, when a layer of cured resin 1502 is formed at the bottom of the liquid vat 1507 on the surface of the window, the cured resin 1502 will adhere to the build plate, previously cured layers, and the window 1508 at the bottom of the liquid vat 107. The 3D printers may pump the interface material through the bottom of the liquid vat 107 under an interface with the liquid resin 1501. The thin layer of interface material under an interface with the resin provides a continuous layer 1506 for dewetting the cured resin 1502. The interface material in the mobile phase 1506 is pumped through the liquid vat 107 continuously or periodically to allow the part to be raised without adhering to the window, to allow the interface material and the liquid resin to be cooled, and to have contaminants removed. The interface material may have contaminants removed in a material separator as described herein.

FIG. 16 is an illustration of a fluid handling and thermal management 1600. An example fluid handling and thermal management 1600 includes a volumetric pump 1603, filters 1608, a heat exchanger 1607, a fan 1601, an enclosure case 1602, quick disconnects 1605, electronics 1606, and various control sensors (including a computer, pressure, and temperature sensors). The heat exchanger 1607, or chiller, is represented as a rackmount plate heat exchanger unit. The fluid handling and thermal management 1600 may be integral to the 3D printer, affixed to the 3D printer, or located separately from the 3D printer. The fluid handling and thermal management 1600 may be a part of the 3D printer without being located on the same rack with the 3D printer. The fluid handling and thermal management 1600 may be scaled to service more than one 3D printer as described herein. The material separator as described may be housed in the fluid handling and thermal management 1600 before or after any of the described components such as the pump 1603 or the heat exchanger 1607. The material separator may be located in the flow of interface material before the interface material is provided to the fluid handling and thermal management 1600 or after the interface material leaves the fluid handling and thermal management 1600, or at any point in the flow of oil that leaves the liquid vat and returns to the liquid vat.

The operations of the 3D printer and the fluid handling and thermal management are described in greater detail in the Appendix A to this specification.

In examples of the technology herein, a material separator apparatus is described to remove contaminants from interface material from a 3D printing process. The apparatus comprises an inlet through which interface material flows into the material separator apparatus, an outlet through which the interface material flows from the material separator apparatus, and internal tubing connecting the inlet to the outlet and comprising a collection zone located before a downwardly declined portion of the internal tubing. A location of the collection zone allows contaminants in the interface material to collect in the collection zone.

The material separator apparatus may further comprise an upwardly inclined portion of the internal tubing before the collection zone. The material separator apparatus may further comprise a horizontal portion of the internal tubing before the collection zone. The material separator apparatus may further comprise a vent coupled to the collection zone of the internal tubing, wherein opening the vent allows the contaminants in the collection zone to be removed from the apparatus.

The material separator apparatus may include a tube to direct interface material from a 3D printer reservoir to an inlet of a material separator and tubing to return the separated oil to the 3D printer reservoir. The material separator apparatus may be a reverse J material separator comprising the collection zone before the downwardly declined portion of the internal tubing, the location of the collection zone allowing contaminants in the interface material to collect in the collection zone.

The material separator apparatus may be a column material separator comprising a vertical tube through which the interface material flows downward and a vent at an upper portion of the vertical tube through which the contaminants are vented out of the vertical tube. The material separator apparatus may be a column material separator comprising a horizontal tube through which the oil flows horizontally and exits from an outlet in a lower portion of the horizontal tube and a vent at an upper portion of the horizontal tube through which the contaminants are vented out of the horizontal tube. The material separator apparatus may include a plurality of collection zones, each collection zone being located before a separate downwardly declined portion of the internal tubing.

The interface material in the material separator apparatus may be an immiscible liquid. The contaminants in the material separator apparatus may comprise air bubbles. The contaminants in the material separator apparatus may comprise one or more of liquid or cured 3D printing resin, water, or dust. The internal tubing in the material separator apparatus may have a greater diameter than the section of tubing leading to the material separator apparatus collection zone. The material separator apparatus may include a heat exchanger that cools the interface material before the oil is returned to the 3D printer reservoir.

The technology may include a method to remove contaminants from interface material that includes opening a valve to allow interface material to flow into an inlet of the material separator apparatus; opening a vent to allow the contaminants to vent out of the material separator; and opening an outlet valve to allow interface material to flow through an outlet of the material separator apparatus, wherein the material separator apparatus comprises internal tubing connecting the inlet to the outlet and comprising a collection zone located before a downwardly declined portion of the internal tubing, the location of the collection zone allowing contaminants in the interface material to collect in the collection zone.

In other examples of the technology, the material separator apparatus to remove interface material from liquid resin includes an inlet through which liquid resin with entrained interface material flows into the material separator apparatus; an outlet at the top portion of the material separator through which the liquid resin flows from the material separator apparatus after the liquid resin is separated from the interface material; an outlet at the bottom portion of the material separator through which the interface material flows from the material separator apparatus after the liquid resin is separated from the interface material; and one or more baffles in the body of the material separator to distribute and smooth the flow of liquid resin and interface material.

### Projector Alignment Device

In another aspect, embodiments described herein provide methods and devices for aligning projectors with six degrees of freedom in 3D printers. The projector alignment system is configured to align individual projectors in an array of projectors within a 3D printer with movement in X, Y, Z, roll, pitch, and yaw degrees of freedom while conforming to a footprint that is smaller than the desired projection area of each projector.

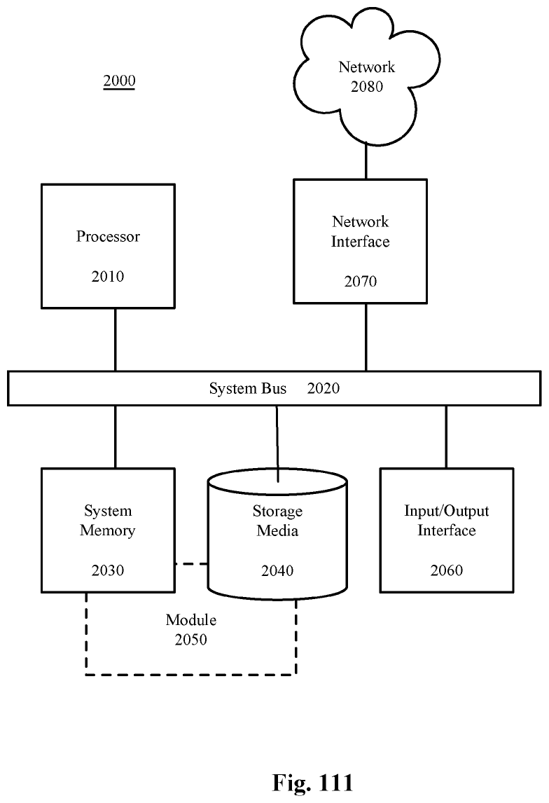

The network computing devices and any other computing machines associated with the technology presented herein may be any type of computing machine, such as, but not limited to, those discussed in more detail with respect to FIG. 111. For example, each device can include a server, a desktop computer, a laptop computer, a tablet computer, a television with one or more processors embedded therein and/or coupled thereto, a smart phone, a handheld computer, a PDA, a router, a switch, a hub, a gateway, a modem, an access point, a bridge, or any other wired or wireless processor-driven device. The computing machines discussed herein may communicate with one another, as well as with other computing machines or communication systems over one or more networks. Each network may include various types of data or communications networks, including any of the network technology discussed with respect to FIG. 111.

Furthermore, any functions, applications, or components associated with any of these computing machines, such as those described herein or any others (for example, scripts, web content, software, firmware, hardware, or modules) associated with the technology presented herein may by any of the components discussed in more detail with respect to FIG. 111.

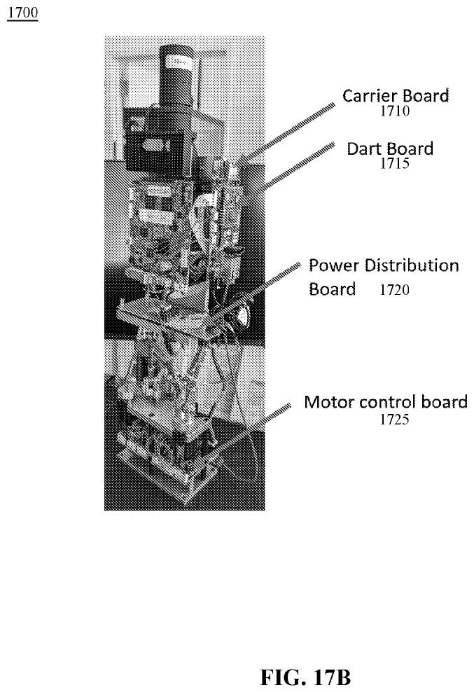

FIG. 17A is a perspective view of a projector alignment system 1700. Projector alignment system 1700 is depicted with a parallel manipulator 1701. A parallel manipulator 1701 is a mechanical system used to adjust a position of a platform, or end-effector, in one or more degrees of freedom. In an example, the platform, or end-effector, is global platform 1702. In an example, the parallel manipulator may be referred to as parallel robots or a generalized Stewart platform. The parallel manipulator 1701 utilizes six or more linkages 1704 connected between two platforms, global platform 1702 and base platform 1706, to provide six degrees of freedom in motion at the global platform 1702. In an example, global platform 1702 and base platform 1706 are essentially the same size in at least two dimensions. Global platform 1702 and base platform 1706 may be exactly the same size in the at least two dimensions or may be within a specified scale in the at least two dimensions. For example, global platform 1702 may be designed such that global platform 1702 dimensions of length and width are within 90%, 95%, 98%, or any other suitable scale of the respective dimensions of base platform 1706. Alternately, base platform 1706 may be designed such that base platform 1706 dimensions of length and width are within 90%, 95%, 98%, or any other suitable scale of the respective dimensions of global platform 1702.

In an example, the linkages 1704 may be referred to as arms. In an example, each of the six linkages 1704 are of the same length. In an example, six linkages 1704 are connected between the global platform 1702 and base platform 1706. In this example, the parallel manipulator 1701 has six linkages 1704, each linkage 1704 comprising two joints 107 to connect each linkage 1704 to global platform 1702 and base platform 1706. Each linkage 1704 is connected independently to global platform 1702 and base platform 1706, as opposed to being connected to another linkage 1704.

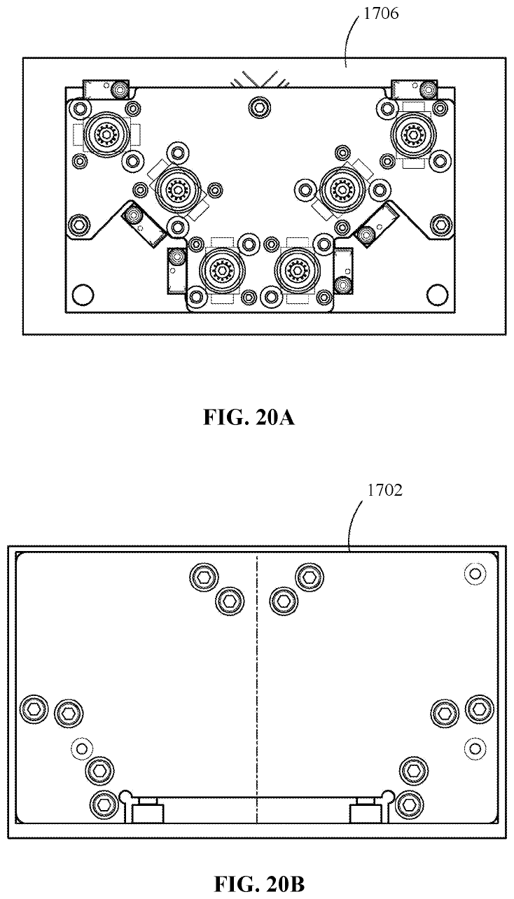

The configuration of the six linkages 1704 is calculated such that architectural singularities do not occur within the limits of the working envelope of the global platform 1702, which may also be referred to as the end-effector. An architectural singularity is an alignment of the motors and arms that creates a region of loose movement that is unpredictable and not related to the robustness of the mechanical design of the platform. In an example, the six linkages 1704 are configured in a pattern with a single plane of symmetry. In the example depicted in FIG. 20B, the six linkages 1704 are configured with a plane of symmetry parallel to the Y-Z axis and without self-symmetry. In an alternate example, the six linkages 1704 may be configured without a common plane of symmetry or with two planes of symmetry. The single plane of symmetry pattern or substantially non-symmetrical pattern of the linkages 1704 of the parallel manipulator 1701 allows the parallel manipulator 1701 to fit within a footprint smaller than the desired projection area. Conventional Stewart platform designs have three or more planes of symmetry and self-symmetry between the positions of the linkages of the Stewart platform. Using a substantially non-symmetrical configuration of the six linkages 1704, the parallel manipulator 1701 is able to provide stability across the entire working envelope of the global platform 1702. The substantially non-symmetrical configuration in the six linkages 1704 maximizes the working envelope of the end-effector. In addition, the calculated configuration of the six linkages 1704 prohibits the linkages 1704 from colliding with one another when the linkages 1704 are of a same length and in movement across the working envelope.

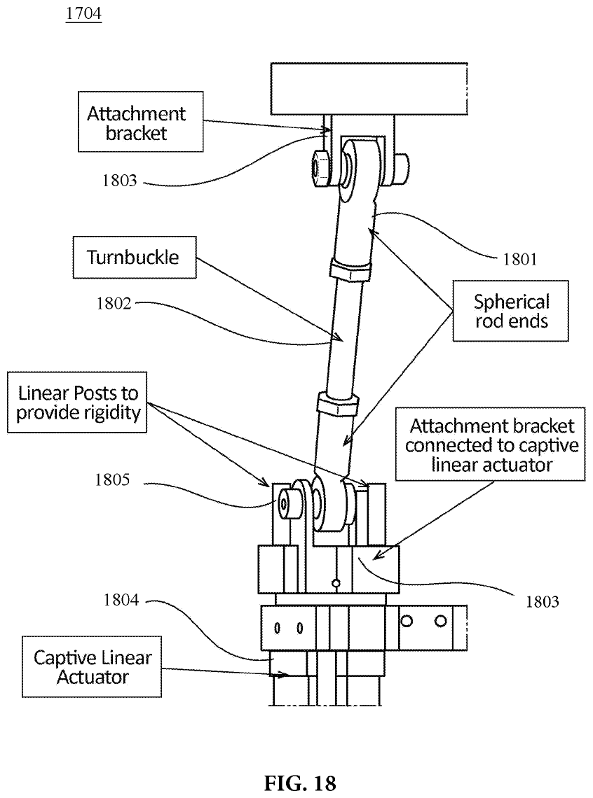

The parallel manipulator 1701 has a footprint smaller than the desired projection area of a projector 1503. In an example, the smaller footprint is achieved using a design wherein global platform 1702 and base platform 1706 are essentially the same size and the six linkages 1704 are arranged in a substantially non-symmetrical pattern. The configuration of the parallel manipulator 1701 provides stability, thereby preventing architectural singularity. The configuration of the six linkages 1704 of the parallel manipulator 1701 differs from conventional Stewart platforms in that the six linkages 1704 are arranged in a substantially non-symmetrical pattern that conforms to a rectangular bounding box in the projection area limits of each projector 1503, as opposed to a symmetrical quasi-triangular formation or a circular formation that is typically found on conventional Stewart platforms. In a conventional Stewart platform configuration, the top platform is approximately ⅔ the size of the bottom platform, as opposed to the platforms 1702 and 1706 of parallel manipulator 1701 that are essentially the same size. The global platform 1702, or top platform, of the parallel manipulator 1701 serves as the end-effector and is where the projector 1503 attaches for each individual projector alignment system 1700. The global platform 1702 serves as the global reference frame for the projector alignment system 1700. The global platform 1702 is the location where the linkages 1704 are first connected. Linkages 1704 are described in greater detail herein with reference to FIG. 18.

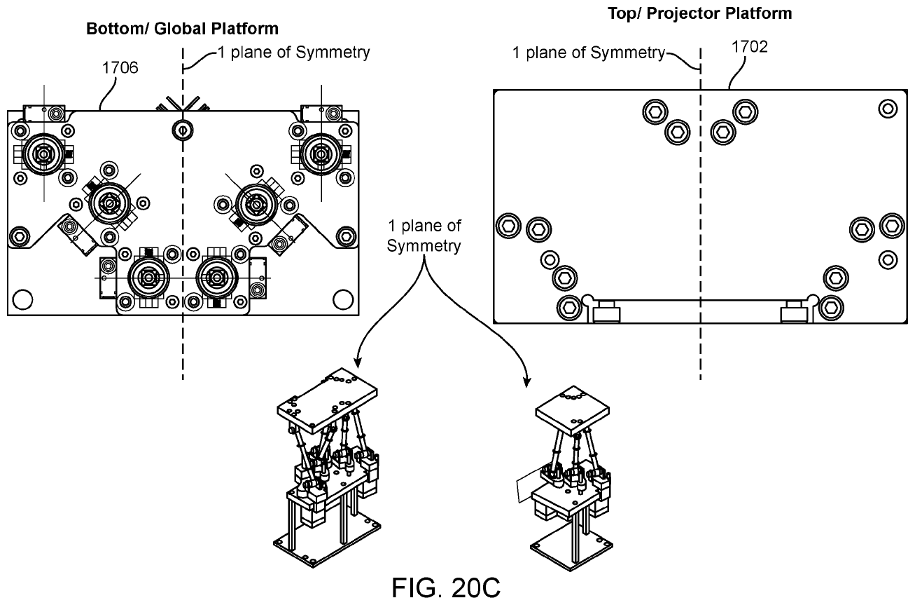

Control over six degrees of freedom provides dynamic adjustment of the projector 1503 in the projector alignment system 1700 to adapt to variables that may impact the height of the polymerization interface. The parallel manipulator 1701 includes a base platform 1706 for attaching the projector alignment system 1700 to a larger base plate 2101, discussed herein with reference to FIG. 21.

Projector alignment system 1700 depicts a projection area zone 1703 sketched around projector alignment system 1700 to illustrate that the footprint of the projector alignment system 1700 is smaller than the boundary of the projection area zone 1703.

Projector alignment system 1700 depicts a projector 1503. The projector 1503, which may also be referred to as a light-engine, is responsible for patterning light (i.e., energy) to drive the polymerization reactions of photo-sensitive liquid resins in the manufacturing process. In an example, the projector 1503 has a projection area of 136 mm by 76 mm.

In an example, projector alignment system 1700 may further comprise a rotational element or component to rotate projector 1503 during a printing process. The rotational element may be a rotational actuator. The rotational element may be affixed to base plate 1706 and connected to global platform 1702 by a rotational linkage. Rotational motion of projector 105 via rotation of global platform 102 may occur independently from or simultaneously with motion effectuated by parallel manipulator 1701. For example, rotation may occur in any plane to which global platform 1702 is positioned in by parallel manipulator 1701.

In an example, rotational linkage may be comprised of two spherical rod ends connected by a turnbuckle piece. The turnbuckle piece connects to attachment brackets to fasten the turnbuckle piece to global platform 1702 and base platform 1706. The attachment brackets provide space for the spherical rod ends to rotate in any plane to which global platform 1702 is positioned. The rotational linkage is actuated with a rotational actuator that provides rotational movement through the attachment bracket. Any suitable rotational linkage may be used. A current limitation of DLP projectors used in 3D printing are the spaces between the Digital Micromirror Devices (DMD) within the individual semiconductor chip of the projector. In an example DLP projector, these spaces are approximately 3 μm in length. As the energy from the semiconductor chip passes through the lens of the DLP projector and expands outward, these microscopic spaces can lead to inconsistent degrees of solidification of the polymerizable resin and can result in vertical “seam lines” on the surface of the additively manufactured article. Rotating the light projector throughout the printing process can more evenly distribute the energy from a given projector throughout the projection area of the projector, mitigating the effect of the gaps between the DMD's.”

The rotational linkage is configured to align with the calculated configuration of the six linkages 1704, previously described herein, such that the rotational linkage does not collide with the six linkages 1704 when in movement across the working envelope. Rotating projector 1705 throughout a printing process generates a more even energy distribution throughout the projection area of the projector 1503, mitigating the effect of gaps between DMDs. FIG. 17B is a picture of a projector alignment system 1700 depicting custom engineered circuit boards. Projector alignment system 1700 comprises a carrier board 1710, a dart board 1715, a power distribution board 1720, and a motor control board 1725.

Carrier board 1710 processes communications between the various subsystems of the parallel manipulator 1701. Carrier board 1710 receives signals, such as digital ethernet signals, from a printer controller (not depicted) for the dart board 1715. In response, carrier board 1710 transmits communication as requested by dart board 1715. In an example, the communications are high-definition multimedia interface (“HDMI”), universal asynchronous receiver/transmitter (“UART”), or inter-integrated circuit (“I2C”) communications. Carrier board 1710 is configured with a size such that the carrier board 1710 may be mounted on the parallel manipulator 1701 and paired with a projector 1503. In an example, unused circuits and integrated circuits are removed from carrier board 1710 to reduce the size of carrier board 1710. Carrier board 1710 is designed to interface with the dart board 1715. In an example, carrier board 1710 communicates with the various subsystems of the parallel manipulator 1701 via an ethernet cable connected to base plate 2101, described in greater detail herein with reference to FIG. 21. As the ethernet cable provides the only connection between base plate 2101 and carrier board 1710, the parallel manipulator 1701 has the capability for movement without the potential for damaging other communication cabling.

Dart board 1715 is an onboard microcontroller/central processing unit (“CPU”) for the parallel manipulator 1701 and the projector 1503. In an example, dart board 1715 is a DART-MX8M-MINI System on Module (“SOM”). In an example, dart board 1715 may be referred to as an image processing computer. Dart board 1715 functions to perform calculations for image generation for the projector 1503, control projector 1503, control parallel manipulator 1701, and collect data from sensors associated with the parallel manipulator 1701. In an example, the sensors are one or more of temperature sensors, UV light intensity sensors, and global platform 1702 position feedback sensors. Dart board 1715 allows for the independent operation of each projector alignment system 1700. Dart board 1715 is designed to include the above-described functions with a physical size to fit within the envelope of the parallel manipulator 1701.

Power distribution board 1720 receives power from base plate 2101 and transmits power to the various subsystems of parallel manipulator 1701. In an example, power distribution board 1720 receives power from base plate 2101 via a single power cable. In this example, the use of a single power cable into power distribution board 1720 enables the parallel manipulator 1701 to move without potentially damaging other power cables. In an example, power distribution board 1720 serves as a 24-volt power supply for carrier board 1710 and dart board 1715, a 12-volt 60 watt (or higher) power supply to projector 1503, and a 24-volt 20 watt power supply to motor control board 1725. Power distribution board 1720 transmits a communication signal from carrier board 1710 to motor control board 1725 via a communication cable. Power distribution board 1720 is designed to fit within the region underneath projector 1503 and on top of global platform 1702. Power distribution board 1720 comprises temperature probes and inputs for additional sensors that can be processed by dart board 1715 using the same communication cable as used to transmit communication signals to motor control board 1725.

Motor control board 1725 controls the motion of the motors that move the linkages 1704 of the parallel manipulator 1701. The motor control board 1725 receives communications from dart board 1715 comprising the direction and length each motor needs to move and transmits signals to the motors to execute the movement. In an example, the received communications are I2C communications. Each motor connected to each linkage 1704 of the parallel manipulator 1701 can be controlled and/or addressed independently from the other motors of the parallel manipulator 1701. Motor control board 1725 is designed to fit in the footprint of the parallel manipulator 1701.

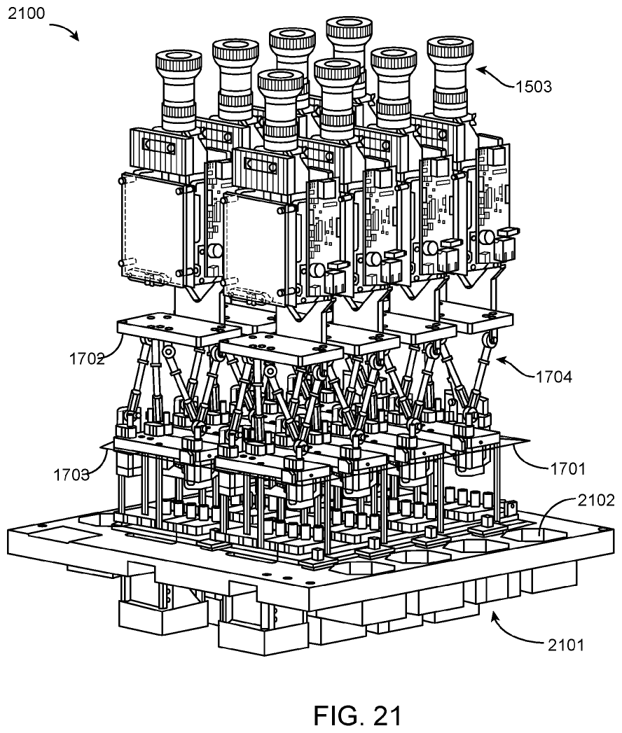

FIG. 18 is a perspective view of a linkage 1704 of a parallel manipulator 1701. Linkages 1704 are comprised of two spherical rod ends 1801 connected by a custom turnbuckle piece 1802. Turnbuckle piece 1802 connects to attachment brackets 1803 to fasten turnbuckle piece 1802 to global platform 1702 and base platform 1706. The attachment brackets 1803 provide space for the spherical rod ends 1801 to move in the intended three axes of rotation while also keeping spherical rod ends 1801 fixed in orientation. Linkages 1704 are actuated with a captive linear actuator 1804 that provides vertical movement through the attachment bracket 1803 closest to the global platform 1702. Linear posts 1805 provide rigidity to the projector alignment system 1700. A linear actuation motor 2601, described herein with reference to FIG. 26, is moved away from linkages 1704 in the present design to allow for a linear actuation motor 2601 that is of appropriate size to fit within the projection area zone 1703. The quantity of linear actuation motors 2601 corresponds to the quantity of linkages 1704, which in the present example is six. The vertical movement across all six linkages 1704 is translated to movement at the global platform 1702 in one or more of the six degrees of freedom by dart board 1715, also referred to as an image processing computer, that computes mathematical calculations to determine the linear actuator motor 2601 and associate linkage 1704 positions necessary to achieve the desired location at the global platform 1702 for each projector alignment system 1700. Plunger style limit switches (not depicted) are connected to the parallel manipulator 1701 for each of the six linkages 1704 to provide the location of the lower limit of the captive linear actuator 1804 and to assist with homing operations of the six linkages 1704. The attachment bracket 1803 that attaches to the linear actuator 1804 is designed with a form factor to interface with the limit switch. The height at which the limit switches are installed are calculated such that the total travel position of a plunger (not depicted and when fully depressed initiates a signal) aligns with the bottom of each linear actuator 1804.

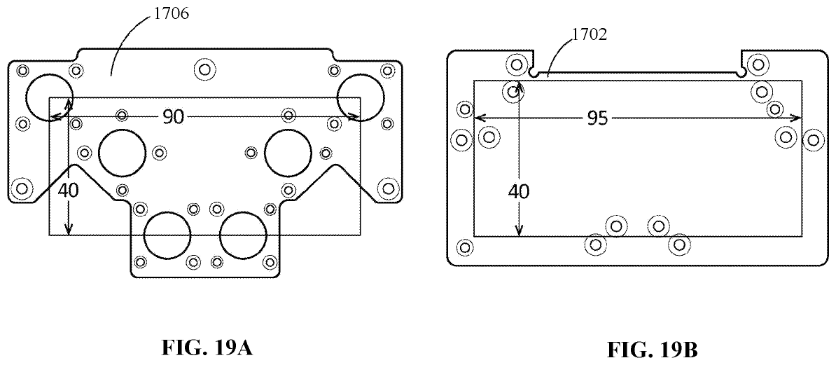

FIG. 19A is a top view of the position of the linkages 1704 on a base platform 1706 of a parallel manipulator 1701. FIG. 19A depicts an example envelope for base platform 1706. In an example, the envelope is the profile created by locations for manipulators 1701 to connect linkages 1704 to base platform 1706. In the example, the envelope is 90 mm×40 mm.

FIG. 19B is a top view of the position of the linkages 1704 on a global platform 1702 of a parallel manipulator 1701. FIG. 19B depicts an example envelope for global platform 1702. In the example, the envelope is 95 mm×45 mm.

The substantially non-symmetrical pattern of the linkages 1704 depicted in FIGS. 19A and 19B of the parallel manipulator 1701 provides an envelope for the base platform 1706 that is approximately the same size as the envelope for the global platform 1702. The linkages 1704 are able to extend and reach the global platform 1702 outside of the envelope depicted in FIG. 19A for the base platform 1706, providing a maximum adjustability for the size of the envelope. The substantially non-symmetrical pattern of the linkages 1704 enables the parallel manipulator 1701 to perform large scale macro adjustments of the projection image and the array 2100, discussed in greater detail herein with reference to FIG. 21. The array 2100 can be aligned through the use of the parallel manipulator 1701 and, in addition, can be shifted in one or more degrees of freedom while staying aligned to adjust for varying conditions, such as shifting oil levels or changing parameter inputs.

The substantially non-symmetrical pattern of the linkages 1704 depicted in FIGS. 19A and 19B provides increased stability as compared to the stability of conventional Stewart platforms with symmetrical quasi-triangular formation or circular formation of linkages. In conventional Stewart platform configurations, if the base platform and the manipulator platform are approximately the same size, the Stewart platform may have singularities, which limit the ability to move in the X and Y directions. In conventional Stewart platform configurations with base and manipulator platforms of approximately equal sizes, multiple linkages may become aligned in the same direction, or vector, and lose linear independence. The substantially non-symmetrical pattern of the linkages 1704 depicted in FIGS. 19A and 19B have linkages 1704 positioned such that the linkages 1704 will not become aligned and therefore will not create a singularity.

FIG. 20A is a top view of the position of the linkages 1704 on a base platform 1706 of a parallel manipulator 1701. As previously discussed herein, dart board 1715 computes mathematical calculations to determine the motor and arm positions necessary to achieve the desired location of the global platform 1702 for each projector alignment system 1700. The mathematical model used in the calculations uses the end positions of each linkage 1704 as if the end positions are projected onto the two platforms (base platform 1706 and global platform 1702). FIG. 20A illustrates the projections onto the base platform 1706 as the center of yellow circles.

FIG. 20B is a top view of the position of the linkages 1704 on a global platform 1702 of a parallel manipulator 1701. FIG. 20B illustrates the projections, previously discussed with reference to FIG. 20A, onto the global platform 1702 as the center of yellow crosses.

FIG. 20C is a top view of the position of the linkages 1704 on a base platform 1706 and the position of the linkages 1704 on a global platform 1702 of a parallel manipulator 1701 illustrating a single plane of symmetry of the parallel manipulator 1701.

FIG. 20D is a perspective view of a parallel manipulator 1701 illustrating the position of the linkages 1704 relative to a base platform 1706 and a global platform 1702.

FIG. 20E is a top view of the position of the linkages 1704 on a base platform 1706 and the position of the linkages 1704 on a global platform 1702 of a parallel manipulator 1701 illustrating a single plane of symmetry of the parallel manipulator 1701 without self-symmetry. The positions of the linkages 1704 (indicated as positions 1-6) as attached to the base platform 1706 are configured to be in a different shape (or pattern) as the positions of the linkages 1704 (indicated as positions 1-6) as attached to the global platform 1702. The single plane of symmetry without self-symmetry allows the parallel manipulator 1701 to fit within a footprint smaller than the desired projection area, provides stability across the entire working envelope of the global platform 1702, and maximizes the working envelope of the global platform 1702. The configuration of the linkages 1704 relative to the global platform 1702 and the base platform 1706 prohibits the linkages 1704 from colliding or interfering with one another when the linkages 1704 are of a same length and in movement across the working envelope.

FIG. 20F is a perspective view of a conventional Stewart platform illustrating three planes of symmetry on the top and bottom plate of the Stewart platform. In a conventional Stewart platform, there are three or more planes of symmetry in regard to the layout of the plates, linkages, and motors.

FIG. 20G is a perspective view of a conventional Stewart platform illustrating the position of the linkages on the top and bottom plates and the three planes of symmetry with self-symmetry of the conventional Stewart platform. In a conventional Stewart platform, the layout of the attachment points of the linkages/motors on each plate are self-similar (i.e., self-symmetry), which means that the shape of the layout on the top plate is the same as the shape of the layout on the bottom plate (may be a different size or orientation). The combination of the three planes of symmetry and self-symmetry reduces the probability of singularity during the operation of the conventional Stewart platform.

FIG. 21 is a perspective view of an array 2100 of projector alignment systems 2100. In an example, the array is a 2×4 array 2100 of projector alignment systems 2100. FIG. 21 depicts the 2×4 array 2100 of projector alignment systems 2100 connected to a base plate 2101. In an example, each projector alignment system 1700 is connected to the base plate 2101 using fasteners such as pins and quarter-turns. The base plate 2101 places power and data connection ports within the limits of the projection area zone 1703 in order to maintain an overall projector alignment system 1700, or module, footprint smaller than the projection area zone 1703. In an example, sixteen cooling fans 2102 are included in array 2100, with eight cooling fans 2102 having a shroud to direct air on the DLP chip on each projector 1503. The other eight cooling fans 2102 are located around the perimeter of the base plate 2101 to provide general air flow for the cavity of the array 2100. When projector alignment systems 2100 are packed tightly together using the parallel manipulator 1701, thermal management may become an issue. If the projectors 1503 become overheated, important components may begin to fail. The cooling fans 2102 and shrouds are paired with each individual parallel manipulator 1701. The shrouds direct air up the small gap between the grouped parallel manipulator 1701, thereby removing heat from the system. The packing of the cooling fans 2102 within the parallel manipulator 1701 allows the cooling of the parallel manipulator 1701 to scale as more projector alignment systems 2100 are added to an array 2100.

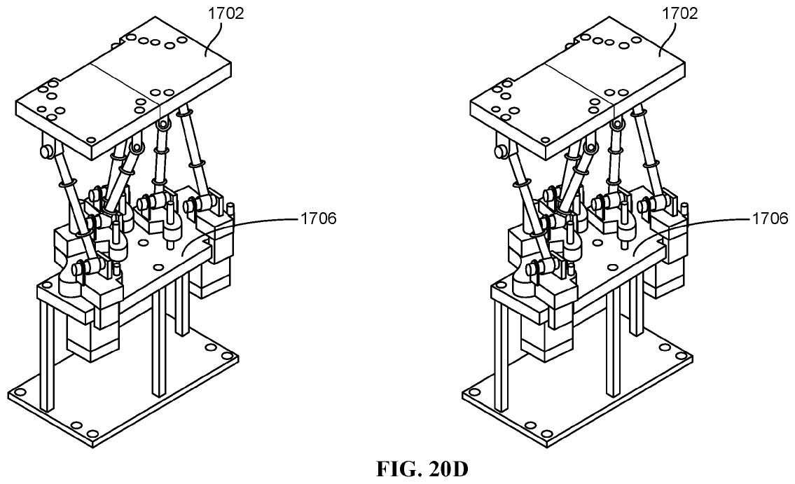

FIG. 22 is a top view of an array 2100 of projector alignment systems 2100 depicting the alignment of each of the projector alignment system 1700 projection area zones 1703.

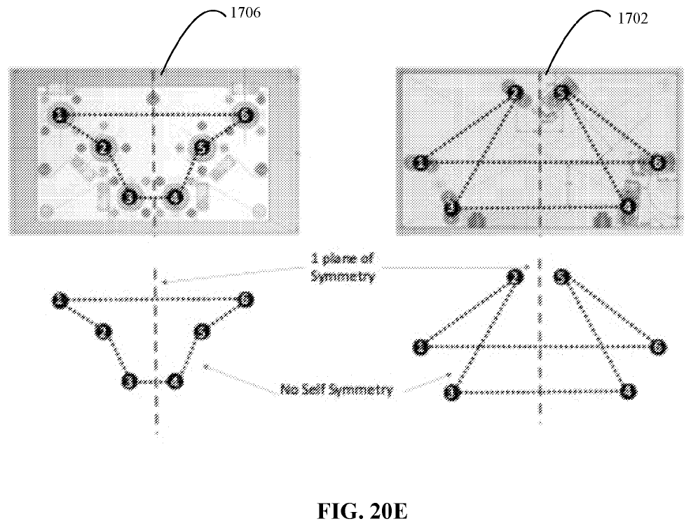

FIG. 23 is a top view illustration of the projector alignment systems' 1700 cooling fans 2102.

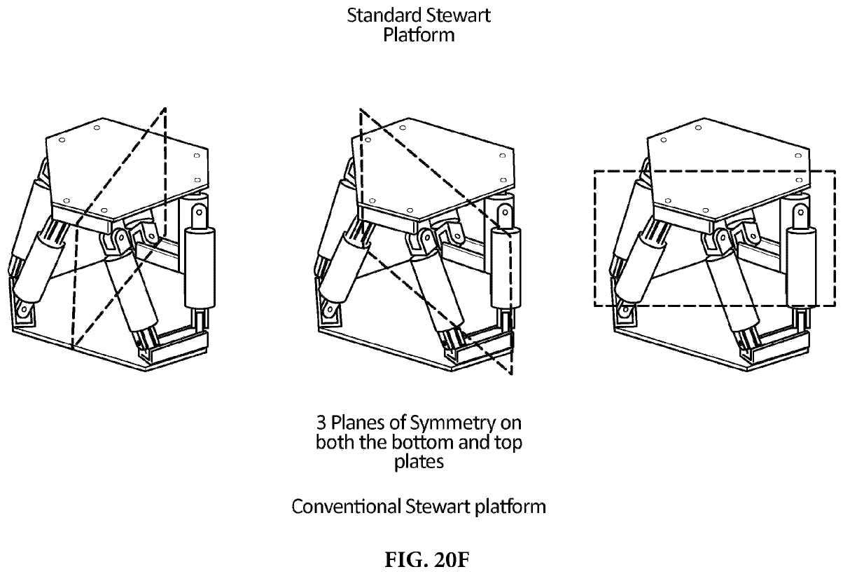

FIG. 24 is a bottom side picture of the projector alignment systems' 1700 cooling fans 2102.

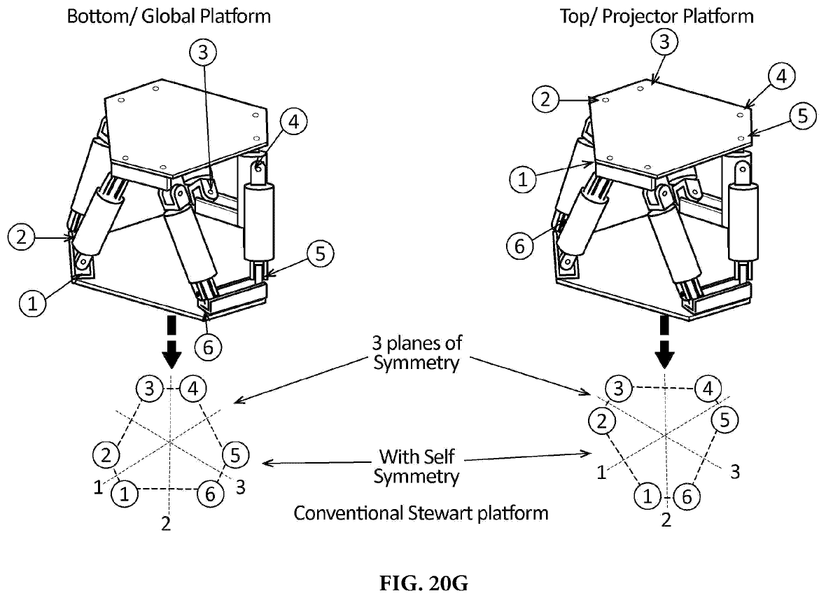

FIG. 25 depicts calculations made to determine performance of the cooling fans 2102. FIG. 25 depicts power estimations, air flow and temperature assumptions, duct and fan estimations, air properties, aluminum properties, and fin properties used in the calculations to determine cooling fans 2102 performance. Calculations include forced convection, heatsink (forced), block, pad, temperature (forced), natural convection, heatsink (natural), and temperature (natural).

FIG. 26 is a front view picture of a projector alignment system 1700. FIG. 26 depicts the parallel manipulator 1701 with global platform 1702, linkages 1704, projector 1503, motor control board 1725, and linear actuator motor 1001. Each linkage 1704 is connected to a linear actuator motor 2601. Each linear actuator motor 2601 receives communications from motor control board 1725 with a distance, or step count, to move to reposition the global platform 1702. The movement of each linkage 1704 by each linear actuator motor 2601 translates to movement of the global platform 1702 in one or more of the six degrees of freedom for alignment of the projector 1503 within each projector alignment system 1700 within the array 2100.

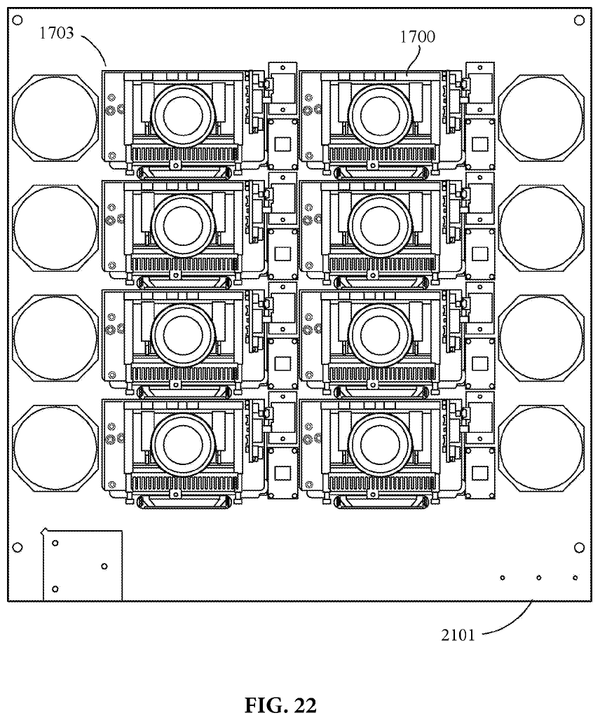

FIG. 27 is a picture of the hard wiring between the carrier board 1710, the dart board 1715, the power distribution board 1720, and the motor control board 1725.

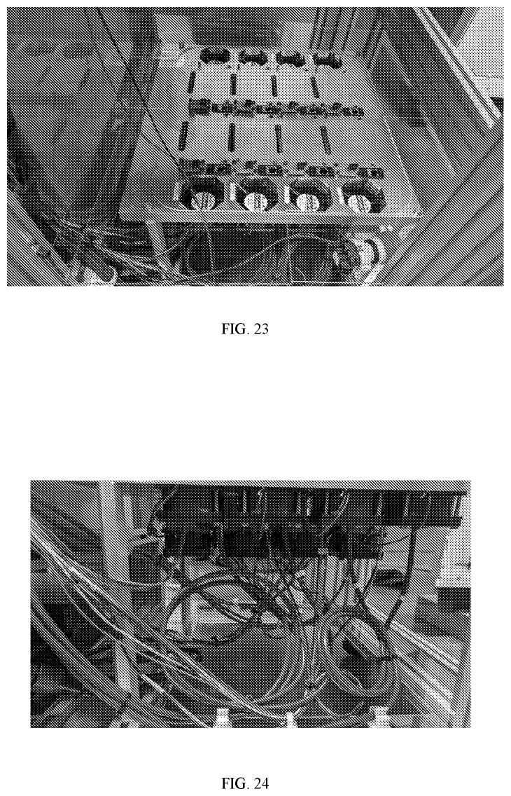

FIGS. 28A, 28B, and 28C illustrate a schematic design of the custom printed circuit board for power and data transmission throughout the projector alignment system 1700.

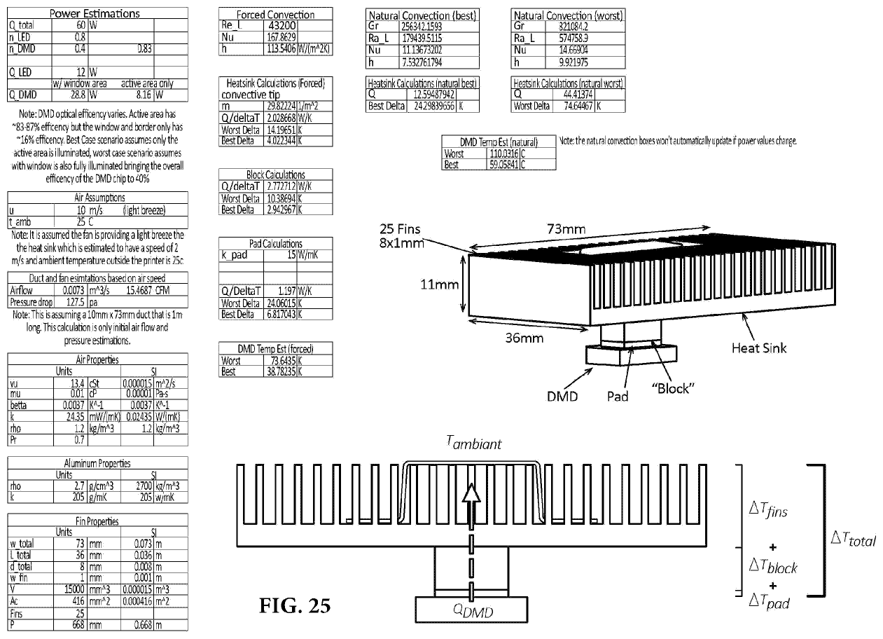

FIGS. 29A, 29B, and 29C illustrate a layout design of the custom printed circuit board for power and data transmission throughout the projector alignment system 1700.

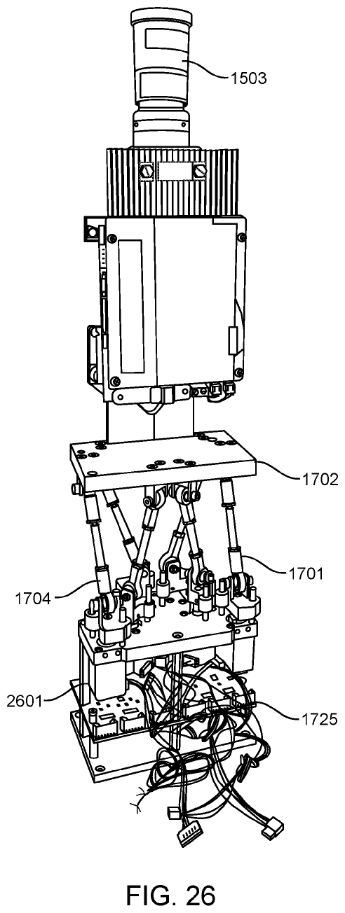

FIG. 30 is a top view illustration of the projector alignment systems 2100 projection of alignment templates 3001. FIG. 14 depicts eight projected alignment templates 3001 corresponding to the previous example of a 2×4 array 2100 (i.e., eight projector alignment systems 2100 within array 2100). Based on the depicted alignment templates 3001 in FIG. 14, the projector alignment systems 2100 are misaligned.

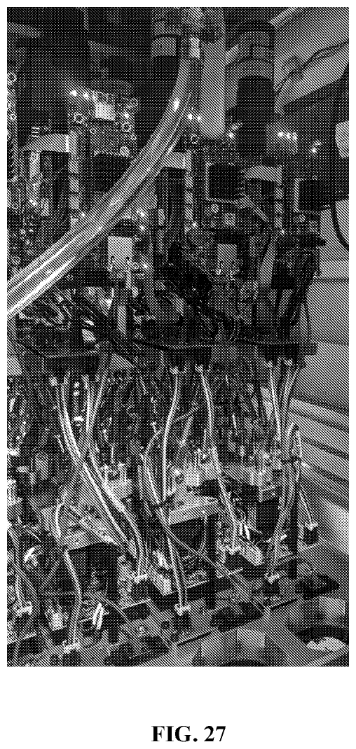

FIG. 31 is a top view illustration of a subsection of the projector alignment systems 2100 projection of alignment templates 3001. Based on the depicted alignment templates 3001 in FIG. 31, FIG. 31 depicts four projector alignment systems 2100 in alignment.

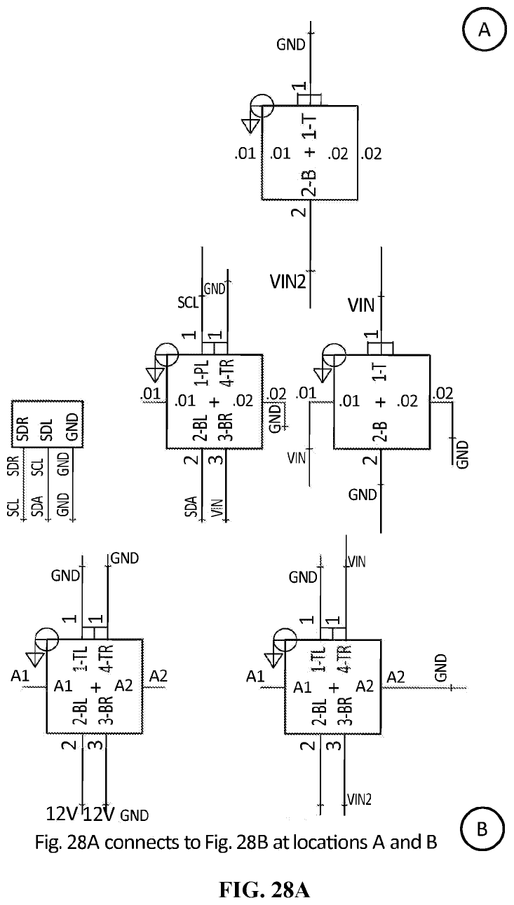

FIG. 32 is an illustration of a visual alignment system 3200. Visual alignment system 3200 comprises a high-resolution camera 3201 to capture pixels of the DLP chip. The camera 3201 is affixed to an XY gantry system 3202 to position the camera 3201 around the projection area zone 1703 to capture a set of images for use in the alignment of the projectors 1503.

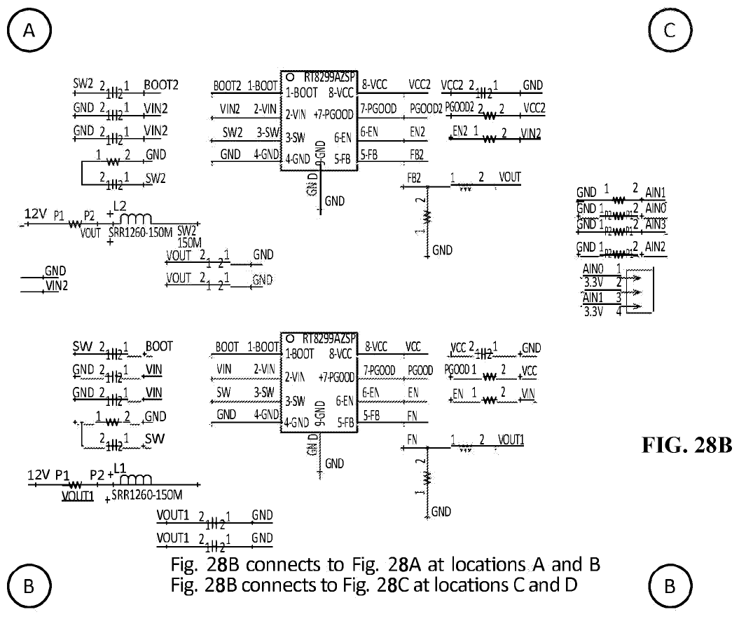

FIG. 33 is picture depicting the visual alignment system 3200 attached to a 3D printer.

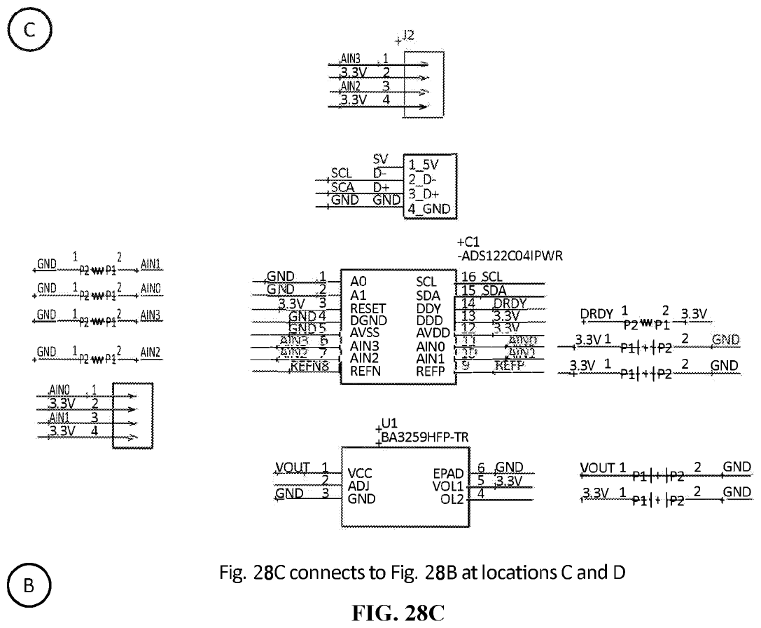

FIG. 34 is a top view picture depicting the visual alignment system 3200 supported by a post 3401 attached to the base plate 2101. FIG. 34 depicts an alternate arrangement for the visual alignment system 3200 of FIG. 32. An approximate 1:1 ratio of camera 3201 pixels to DLP pixels (projector 1503) may be achieved by placing the camera 3201 below the polymerization interface. The 2×4 array 2100 of the projector alignment systems 2100 allows for the camera 3201 to be positioned in the middle of array 2100, supported by a post 3401 that attaches to the base plate 2101 to which the projector alignment systems 2100 are secured. The camera 3201 is located closer to the projection area zone 1703 than the configuration presented in FIG. 32. The shorter distance between the camera 3201 lens and the projection area zone 1703 provides an improved ratio of camera 3201 pixels to DLP pixels (projector 1503). While the shorter distance provides an improved ratio, the shorter distance causes the camera 3201 to capture less of the projection area zone 1703. To compensate for the decrease in image area, the camera 3201 may be equipped with a fisheye, or wide angle, lens. With the fisheye lens, the camera 3201 may capture the main intersection points in the middle of the array 2100 where, in an example, four projector alignment systems 2100 line up. Additionally, predictive calculations are performed to determine the projection area zone 1703 of the light as it reaches the polymerization zone, and the projectors 1503 in the array 2100 can be aligned accordingly.

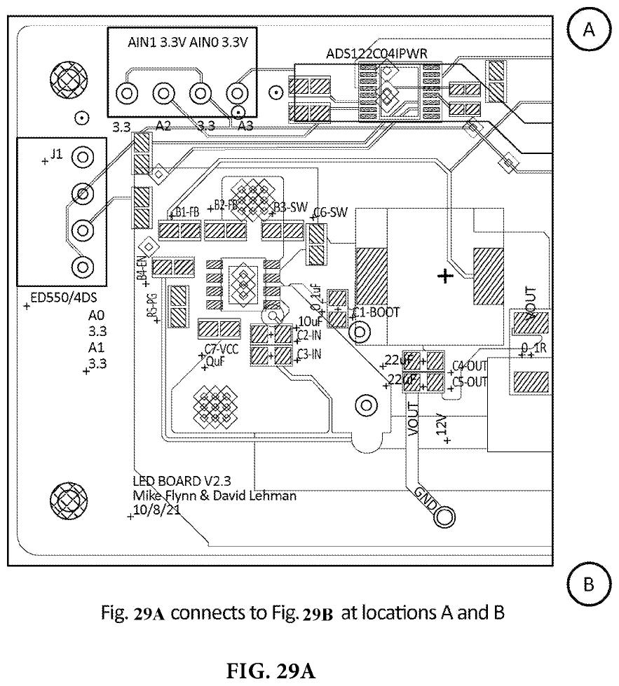

FIG. 35 is a side view picture depicting the visual alignment system 3200 supported by a post 3401.

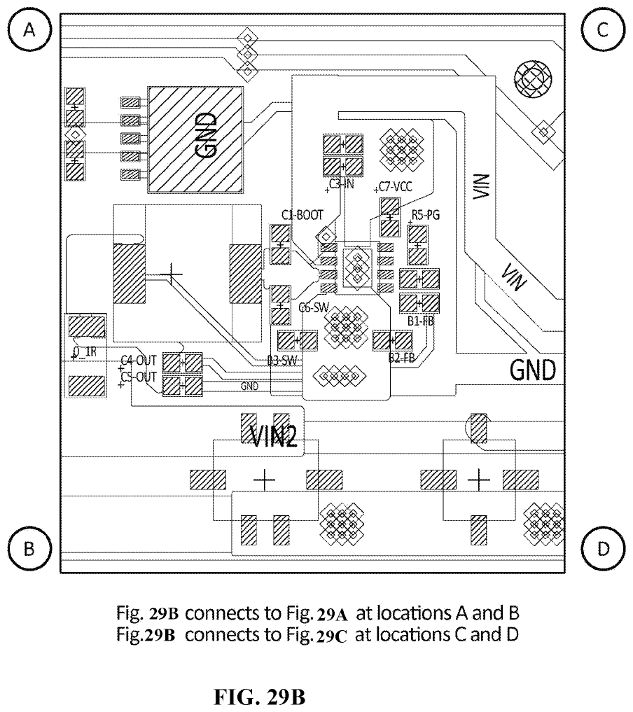

FIG. 36 is a picture depicting a portion of the projection area zone 1703 captured by the visual alignment system 3200, as discussed herein with reference to FIG. 34.

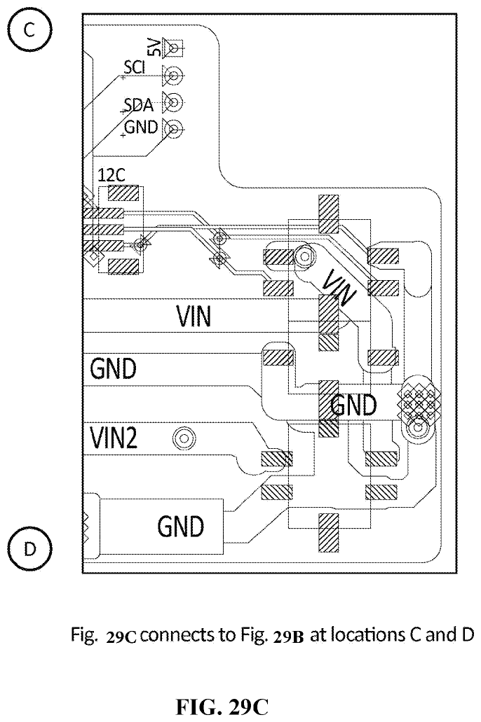

FIGS. 37A through 37C: FIG. 37A is an illustration indicating the six degrees of freedom of the projector alignment systems 2100. FIG. 37B is a top view illustration of an array 2100 of projector alignment systems 2100. FIG. 37C is a perspective view and a front view of a projector alignment system 1700.

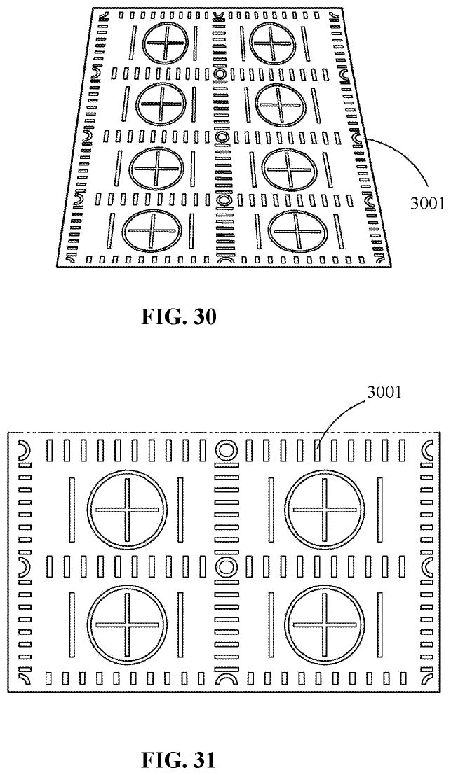

FIG. 38 is a block flow diagram depicting a method 3800 to align projectors 1503 in an array 2100 of projector alignment systems 2100 in a 3D printer, in accordance with certain examples. In block 3810, an image processing computer projects an alignment template 3001 across each projector alignment system 1700 in the array 2100. In an example, the image processing computer is dart board 1715. In an example, the image processing computer transmits instructions to each projector 1503 within each projector alignment system 1700 to project an alignment template 3001. The method for aligning each projector alignment system 1700, or module, uses a preset alignment template 3001 that is projected across each of the projector alignment systems 2100 in the array 2100. An example alignment template 3001 was illustrated in FIG. 30. The example alignment template 3001 is designed with markings to aid in the alignment of each projector alignment system 1700 to each of the adjacent projector alignment systems 2100 in the array 2100. In an example, the markings on the alignment template 3001 may comprise lines, circles, or any other geometric figure or shape to assist in the alignment of the projectors 1503. In an example, the markings may be used for computer vision aided alignment or manual alignment of the projectors 1503.

In block 3820, the image processing computer instructs the visual alignment system 3200 to capture a set of images of the projected alignment templates 3001. The visual alignment system 3200 comprises a high-resolution camera 3201 to capture the pixels of the DLP chip. The camera 3201 is affixed to an XY gantry system 3202 to dynamically position the camera 3201 around the projection area zones 1703 to capture a set of images for use in the alignment of the projectors 1503.

In block 3830, the visual alignment system 3200 transmits the image set to the image processing computer.

In block 3840, the image processing computer compares the images within the image set to determine if the projectors 1503 are in alignment. In an example, the image processing computer compares the images to determine if the marking on the projected alignment templates 3001 match or align between adjacent projector alignment systems 2100. In an example, the project alignment templates 3001 are determined to be in alignment if the markings in each dimension are within ¼ of a pixel, ⅓ of a pixel, ½ of a pixel, or any other suitable dimension.

In block 3850, the image processing computer determines if the projectors 1503 in the array 2100 of projector alignment systems 2100 are aligned. If the comparison of the images in block 2240 indicates that the markings on the projected alignment template 3001 for each projector alignment system 1700 align between each of the adjacent projector alignment systems 2100, the projectors 1503 are determined to be in alignment. If the projectors 1503 are determined to be in alignment, the method proceeds to block 3860. In block 3860, the projector 1503 alignment is completed. If the projectors 1503 are not determined to be in alignment, the method proceeds to block 3870.

In block 3870, the image processing computer calculates a distortion and displacement for each projected alignment template 3001. The image processing computer computes the mathematical calculations needed to correct the observed distortion and displacement for each projected alignment template 3001 to determine the linear actuator 1804, or arm positions, of the projector alignment system 1700 to achieve the desired location of the parallel manipulator 1701 necessary for alignment of the projectors 1503 in the array 2100 of projector alignment systems 2100. The translation matrix provides coordinates for each particular projection alignment system 1700 to adjust the particular projector alignment system's 2100 projector 1503 in the X, Y, Z coordinate system. The rotation matrix provides angular rotational values of roll, pitch, and yaw to adjust the three-dimensional angular position of the particular projector alignment system's 100 projector 1503. The combination of movements of the translation matrix and the rotation matrix aligns the markings of the alignment template 3001 between each of the projector alignment systems 2100. The image processing computer uses the translation matrix and the rotation matrix to calculate an alignment distance, or step count, that each linear actuator motor 2601 associated with each linkage 1704 needs to move.

In block 3880, the image processing computer transmits the alignment distance for each linear actuator motor 2601 to each motor control board 1725 in each projector alignment system 1700.

In block 3890, each motor control board 1725 repositions the projector 1503 in the projector alignment system 1700 in accordance with the received alignment distance. The motor control board 1725 executes linear actuator motor 2601 movement resulting in movement of the global platform 1702 in one or more of the X, Y, Z, roll, pitch, and yaw degrees of freedom. From block 3890, the method returns to block 3810 to confirm alignment of the projectors 1503 in the array of projector alignment systems 2100 in the 3D printer. The image processing computer is capable of tracking the current position of each projector alignment system 1700 and, based on the projected alignment template, calculate future movements needed for projector 1503 alignment.

In an alternate embodiment, a parallel manipulator may be designed with five linkages 1704 to achieve movement in five degrees of freedom. The parallel manipulator may be paired with a serial manipulator to achieve movement in six degrees of freedom.

In a second alternate embodiment, a parallel manipulator may be designed for movement with three degrees of freedom and paired with a serial robot, a gyroscopic rotation system, or a rotary stage to achieve movement in six degrees of freedom.

An alternate design would use tension elements to bias each linkage 1704 to a more stable position to increase the rigidity of the projector alignment system 1700.

An additional alternate design would be to use buttresses to connect each projector alignment system 1700 to the base plate 2101 to allow for easier install and uninstall of each projector alignment system 1700.

In an alternate embodiment, the parallel manipulator may be designed with linkages 1704 having a variable length. Non limiting examples of methods to alter leg length include, but are not limited to, pneumatic actuators, hydraulic actuators, and the like. This method would allow for a greater range of movement of the parallel manipulator.

In an alternate embodiment, the parallel manipulator 1701 may further comprise one or more encoders embedded within at least one of the actuator motors. The one or more encoders would be capable of sending electronic positional data to the dart board 1715 allowing for an additional method of monitoring and controlling alignment and positioning of the projectors 1503 of the projector alignment system 1700 in real time during the printing process.

In an alternate design, the housing of an array 2100 of projector alignment systems 2100 would further comprise capacitive proximity sensors. These capacitive proximity sensors would allow for the gathering of physical positional data on the different components of the individual projector alignment systems 1700, which would in provide an additional method of alignment control in real time during the printing process.

An additional alternate design would involve optimizing the cooling fan 2102 layout. Data may be collected to determine a more precise quantity of heat that each projector alignment system 1700 generates around the DLP chip. The quantity of cooling fans 2102 and the air speed of the cooling fans 2102 may be adjusted to allow the DLP chip environment to be maintained at an optimal operating temperature according to manufacturer's recommendations.

An additional alternate design would make use of a passive conduction air conditioning system in place of or in addition to the cooling fans 2102. This design would require the housing of the array 2100 of projector alignment systems 2100 to be sealed and further comprise an inlet and an outlet in coordination with an external air conditioning unit, providing temperature control. In an example, an alternate design including a passive conduction air conditioning system further comprises methods of humidity control, a suitable, non-limiting example being a dehumidifier.

An additional alternate design would make use of a liquid cooling system in place of or in addition to the cooling fans 2102. In an example, a liquid cooling system circulates coolant throughout a projector alignment system 1700 in order to regulate the temperature of the system. In an example, a suitable liquid cooling system would circulate coolant throughout an array 2100 of projector alignment systems 2100 in order to provide an additional method of temperature control. Suitable, non-limiting examples of coolants include water, ethylene glycol, propylene glycol, and combinations thereof.

Parallel manipulators 1701 allow for active adjustment of the UV projections. In an additional alternate design, the height of the parallel manipulator 1701 may be adjusted such that the projection plane can adjust for changes in oil level or build platform. Adjusting the height of the parallel manipulator 1701 can be used for process adjustment by adjusting the plane at which resin is curing. By moving the plane at which resin cures up or down with respect to the oil level, the rate and quality of printing can be adjusted.

In an additional alternate design, the parallel manipulator 1701 can adjust the alignment of the projectors 1503 so the projection area zones 1703 overlap. In an example, future materials or print speeds may require additional UV light. Overlapping the projection area zones 1703 would create areas of increased UV intensity without the need for additional hardware. For example, future materials or print speeds may require additional UV light.

In an additional alternate design, the projectors 1503 of the projector alignment system 1700 are capable of projecting light having higher wavelengths than UV in addition to UV. In an embodiment, the projectors 1503 are capable of projecting light in the visible spectrum of light. The ability of the projector 1503 to project light of higher wavelengths would allow for visual alignment method 3800 to be performed while resin is present in the resin vat 107 without initiating polymerization of the resin.

In an additional alternate design, the projector alignment system 1700 makes use of mirrors in alignment with the projection area from the projectors 1503. In an alternate design, the mirrors are further aligned with diodes present in the housing of the projector alignment system 1700. A method making use of this design would comprise projections from the projectors 1503 reflecting off of the mirrors and onto the diodes, gathering alignment data from those diodes, and repositioning the parallel manipulator 1701 accordingly. In an alternative embodiment, the mirrors are partially reflective, which would allow for real time alignment of the projector alignment system 1700 during a printing process with intensity adjustments of the projector 1503 to compensate for the intensity lost due to partial reflection.

In an additional alternate design, the projector alignment system 1700 makes use of Light Detection and Ranging sensors (LiDAR) positioned above the projectors 1503. These sensors would be capable of generating positional data from the projectors 1503 and would allow for visual alignment of the projector alignment system 1700 based on the projectors 1503 instead of or in addition to the projection area.

In an additional alternate design, the parallel manipulator 1701 can actively adjust the projector 1503 position to selectively cure resin. The area of a pixel from a projector 1503 is fixed and binary in the area the pixel cures. While the pixels are very small and typically not seen in final part geometries, the fixed nature of pixel size may be seen as a roughness or wave on exterior geometries. A parallel manipulator 1701 may move a fixed image (or be combined with a pixel controlled image) to create a more analog cure area and provide a sub pixel cure resolution to eliminate and/or reduce the roughness.

In an additional alternate design, the parallel manipulator 1701 may be controlled such that the projector 1503 could be slowly or rapidly oscillated as a part is being printed. The oscillation would create a mechanical anti-aliasing in the projected image, thereby creating smoother part geometries.

An additional alternate design, a visual alignment system makes use of a separate quality control housing for the projector alignment system 1700. In an example, this quality control housing would comprise diodes capable of determining alignment of a projection area and capacitive proximity sensors capable of determining positional data of different aspects of an individual projector alignment system 1700, particularly the projector 1503. An example method making use of a quality control housing would adjusting the parallel manipulator 1701 in a predetermined series of steps, and comparing the data gathered from the diodes and capacitive proximity sensors to expected data. This comparison would determine deviances present in individual projector alignment systems 1700 due to differences in manufacturing or breakdown of the different components over time. These deviances would be computed when aligning that particular projector alignment system 1700 in the future, allowing for greater alignment precision of individual projector alignment systems 1700. Embodiments making use of the quality control housing would have the additional benefit of monitoring intensity of the projector 1503 and alignment in a single step, allowing for better control of many aspects of the printing process over time for a given projector alignment system 1700.

In examples of the technology, a three-dimensional printer apparatus is described that includes an array of a plurality of projector systems, each of the projector systems associated with a projection area, each of the projector systems positioned adjacent to at least one other of the projector systems without a space between a projection area of each of the projector systems and a projection area of each adjacent projector system, and each of the projector systems comprising a projector and a projector alignment system; a visual alignment system configured to individually align each of the projectors; a cooling system configured to individually cool the projectors; and a base plate to which each of the projector systems is mounted.

Each respective projector alignment system of the apparatus may include a parallel manipulator comprising a plurality of linkages arranged in a single plane of symmetry pattern on first and second plates connected by the linkages. In the apparatus, each parallel manipulator and associated communication system, power system, and circuitry comprises a footprint that is not larger than the projection area of the corresponding projector to which it is attached. In the apparatus, the first plate may be fixed, the second plate may be disposed in space relative to the first plate and connected to the first plate by the plurality of linkages, and the second plate may be movable relative to the first plate by operation of the plurality of linkages.

In the apparatus, each respective linkage of the plurality of linkages may include a linear actuator and a motor, the motor driving the linear actuator to move the respective linkage to thereby move the second plate. In the apparatus, repositioning one or more of the linkages of the plurality of linkages repositions the second plate in six degrees of freedom. In the apparatus, the respective projector of each projector system may be coupled to the second plate of the parallel manipulator of the respective projector alignment system such that movement of the second plate moves the projector in six degrees of freedom.

In the apparatus, each respective project alignment system further comprising a rotational element and a rotational linkage. In the apparatus, each parallel manipulator, rotational element, and associated communication system, power system, and circuitry comprises a footprint that is not larger than the projection area of the corresponding projector to which it is attached. In the apparatus, the first plate being fixed, the second plate being disposed in space relative to the first plate and connected to the first plate by the rotational linkage and the plurality of linkages, the second plate being movable and rotatable relative to the first plate by operation of the rotational linkage and/or the plurality of linkages. In the apparatus, the second plate being rotatable in a plane in which the second plate is positioned by the parallel manipulator. In the apparatus, the rotational linkage comprising a rotational actuator and a motor, the motor driving the rotational actuator to rotate the rotational linkage to thereby rotate the second plate.

In the apparatus, the visual alignment system may include a camera and a gantry system coupled to the apparatus and to which the camera is coupled, the gantry system movably positionable with respect to the array of projector systems to capture images projected by the projector systems. In the apparatus, the gantry system is positioned to move the camera between the projectors in the array of projectors. In the apparatus, gantry system is positioned to move the camera above the projectors in the array of projectors. In the apparatus, the cooling system comprising a plurality of fans coupled to the base plate. In the apparatus, the base plate comprises power connection ports and data connection ports to operate the projector systems.

In examples of the technology, a method to align projectors in an array of projectors is described. The method includes, by one or more computing devices, transmitting, to two or more projectors in the array of projectors, instructions to project a template; requesting, from a visual alignment system, a set of images of the projected templates; receiving, from the visual alignment system, the set of images of the projected templates; comparing images from the set of images to determine an alignment of the two or more projectors; upon determining that the two or more projectors are not aligned, calculating a position for alignment for each of the two or more projectors; and transmitting, to two or more second computing devices associated with each of the two or more projectors, instructions to position one or more of the two or more projectors according to the position for alignment of the two or more projectors.

In the method, the one or more computing devices is an image processing computer. In the method, determining the alignment of the two of more projectors comprises comparing markings in the set of images of the projected templates. In the method, the position for alignment comprises a translation matrix and a rotation matrix for each of the two or more projectors. In the method, the two or more second computing devices are motor controller boards associated with each of the two or more projectors. In the method, the motor controller boards control one or more motors associated with one or more parallel manipulators to position the two or more projectors.

In the method, each parallel manipulator comprises one or more linkages repositionable by the one or more motors to move a respective projector in six degrees of freedom. The method may include receiving, from the one or more computing devices, the position for alignment for a particular projector of the two of more projectors and repositioning, by the one or more motors of the parallel manipulator, each the one or more linkages of the parallel manipulator in accordance with the position for alignment.

In the method, the visual alignment system comprises a camera and a gantry system. The method may include, by the visual alignment system, receiving a request for the set of images of the projected templates; positioning, by the gantry system, the camera above a first portion of the projected templates; capturing an image of the first portion of the projected templates; repositioning, by the gantry system, the camera above a second portion of the projected templates; capturing an image of the second portion of the projected templates; repeating the repositioning and capturing of images until at least one image has been captured of each of the projected templates; and transmitting, to the one or more computing devices, the captured images as the set of images.

In examples of the technology, a platform positioning apparatus is described. The platform positioning apparatus includes a processor to transmit one or more signals to position a first platform. The first platform is affixed to a second platform with a plurality of linkages and is disposed in space relative to the second platform. The first platform is movable relative to the second platform by operation of the plurality of linkages based on the one or more signals transmitted by the processor to position the first platform.

In the apparatus, the platform positioning apparatus is a parallel manipulator. In the apparatus, the plurality of linkages are arranged in a pattern with a single plane of symmetry. In the apparatus, the arrangement of the plurality of linkages allows simultaneous movement of each linkage of the plurality of linkages without interference from remaining linkages of the plurality of linkages. In the apparatus, the first platform and the second platform are of a same size in at least two dimensions.

In the apparatus, each respective linkage of the plurality of linkages comprises a linear actuator and a motor, the motor driving the linear actuator to move the respective linkage to thereby position the first platform. In the apparatus, the plurality of linkages position the first platform in six degrees of freedom.

The technology includes a projector system as shown and described.

The technology includes a projector alignment system as shown and described. The technology includes a visual alignment system for a projector array as shown and described. The technology includes a three-dimensional printing system as shown and described. The technology includes a method to align projectors in an array of projectors as shown and described.

### Fluid and Cooling Interface Systems

In another aspect, embodiments described herein provide fluid and cooling interface systems, and methods of use thereof, that allow a 3D printer to 1) create and control the laminar liquid resin/interface material interface; 2) align the flowing liquid resin/interface material interface with the mechanical and optical elements of the 3D printer; and 3) manage the temperature and level of the liquid resin and interface material.

The interface material can comprise a flowing fluid. Examples of flowing fluids include an aqueous liquid, an organic liquid, a silicone liquid, and a fluoro liquid. The terms interface material, PFPE, PFPE oil, perfluorocarbons (“PFCs”), fluoro oil, or oil, may be used throughout the specification to represent any suitable interface material used in the liquid/interface material system.

Alternatively, aqueous liquids used as the immiscible liquid can include, but are not limited to, water, deuterium oxide, densified salt solutions, densified sugar solutions, and combinations thereof. Example salts and their solubility limit in water at approximately room temperature include NaCl 35.9 g/100 ml, NaBr 90.5 g/100 ml, KBr 67.8 g/100 ml, MgBr2 102 g/100 ml, MgCl2 54.3 g/100 ml, sodium acetate 46.4 g/100 ml, sodium nitrate 91.2 g/100 ml, CaBr2 143 g/100 ml, CaCl2 74.5 g/100 ml, Na2CO3 21.5 g/100 ml, NH4Br 78.3 g/100 ml, LiBr 166.7 g/100 ml, KI 34.0 g/100 ml, and NaOH 109 g/100 ml. Thus, for example, a 100 ml solution of 35.9 g NaCl has a density of 1204 kg/m3.

Example sugars used as the immiscible liquid and their solubility limit in water at approximately room temperature include sucrose 200 g/ml, maltose 108 g/100 ml, and glucose 90 g/100 ml. Thus, for example, a 60% sucrose water solution has a density of 1290 kg/m3 at room temperature. Silicone liquids can include, but are not limited to silicone oils. Silicone oils are liquid polymerized siloxanes with organic side chains. Examples of silicone oils include polydimethylsiloxane (“PDMS”), simethicone, and cyclosiloxanes. Fluoro liquids can include, but are not limited to, fluorinated oils. Fluorinated oils generally include liquid perfluorinated organic compounds.

Examples of fluorinated oils used as the immiscible liquid include perfluoron-alkanes, perfluoropolyethers, perfluoralkylethers, co-polymers of substantially fluorinated molecules, and combinations of the foregoing. Organic liquids can include, but are not limited to, organic oils, organic solvents, including but not limited to chlorinated solvents (e.g., dichloromethane, dichloroethane and chloroform), and organic liquids immiscible with aqueous systems. Organic oils include neutral, nonpolar organic compounds that are viscous liquids at ambient temperatures and are both hydrophobic and lipophilic. Examples of organic oils include, but are not limited to higher density hydrocarbon liquids. In embodiments, the immiscible liquid comprises a silicone liquid, a fluoro liquid, or a combination thereof.

FIG. 15 is an illustration of a liquid vat 107 of a 3D printer 100 and the interface material flow path. The liquid vat stores a vat 107 of polymerizable ink 1501. The resin 1501 cures into a solid part 15021502 upon exposure to the light from the light engine 1503. In the illustrated system, the active cooling of the liquid resin and the cured resin part is achieved by creating a laminar flow of interface material in a mobile phase 1506 beneath and interface with the liquid resin 1501. The interface material is pumped through the liquid vat 107 in the 3D printer. In certain conventional 3D printers, when a layer of cured resin 1502 is formed at the bottom of the liquid vat 107 on the surface of the window, the cured resin 1502 will adhere to the build plate, previously cured layers, and the window 108 at the bottom of the liquid vat 107. The 3D printers may pump the interface material through the bottom of the liquid vat 107 under an interface with the liquid resin 1501. The thin layer of interface material under an interface with the resin provides a continuous layer 15061506 for dewetting the cured resin 102. The interface material in the mobile phase 1506 is pumped through the liquid vat 107 continuously or periodically to allow the part to be raised without adhering to the window, to allow the interface material and the liquid resin to be cooled, and to have contaminants removed.

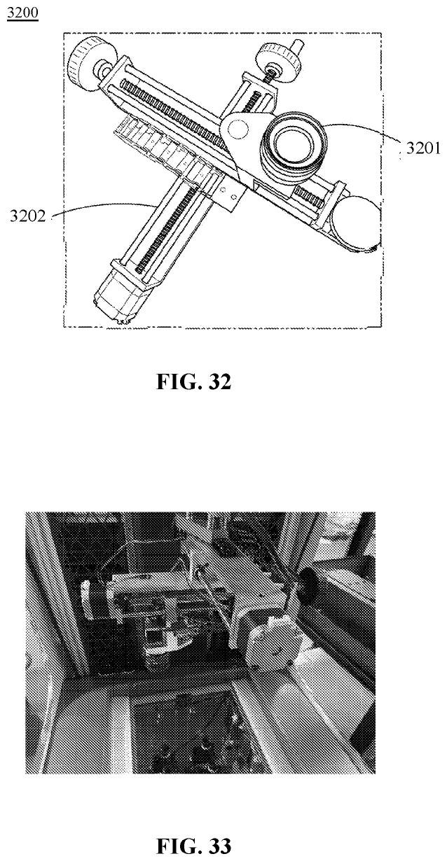

FIG. 39 is picture of a liquid vat 107 without any liquid resin present. As described with respect to FIG. 1, the liquid vat 107, when filled, stores the liquid photopolymerizing resin and the moving layer of interface material below the liquid resin. The solid 3D printed part is drawn up out of the liquid vat as the resin solidifies. In certain examples, the liquid vat 107 is referred to as an “aquarium.” In alternate embodiments, the technologies herein may be applied to 3D printing that uses a top down approach in which the build plate is lowered into a liquid vat of resin.

### Flow Manifolds

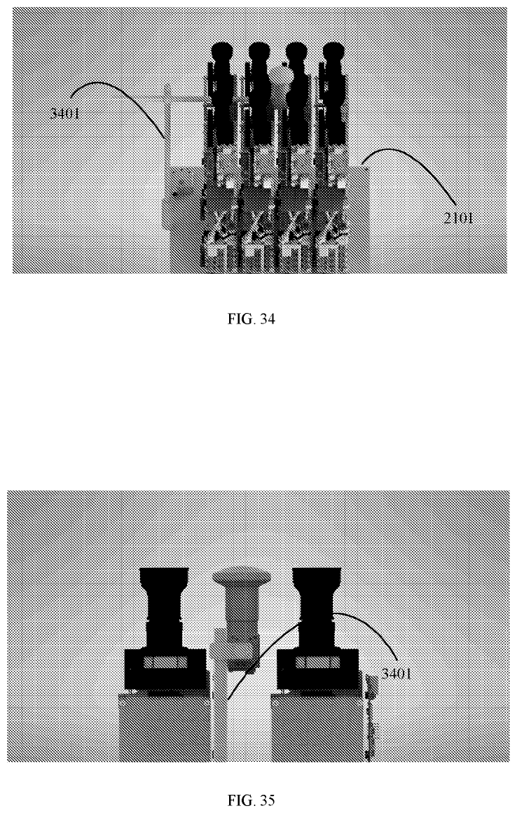

FIG. 40 is an illustration of the liquid vat 107 with flow manifolds 4001, 302 denoted. During the 3D printing process, the interface material is pumped from the left manifold 4001 to the right manifold 4002. In alternate examples, the interface material may be pumped in any suitable direction, such as right to left. The manifolds 4001, 4002 are configured to ensure that the flow of interface material is laminar and has a minimal variation in velocity across the flow profile. Laminar flow is preferred over turbulent flow for to maintain the interface between the interface material and the liquid resin because the laminar flow removes the heat more evenly, provides a flatter, more stable interface, provides more accurate level measurement, prevents shaking or disturbing the printed part, and has other suitable properties.

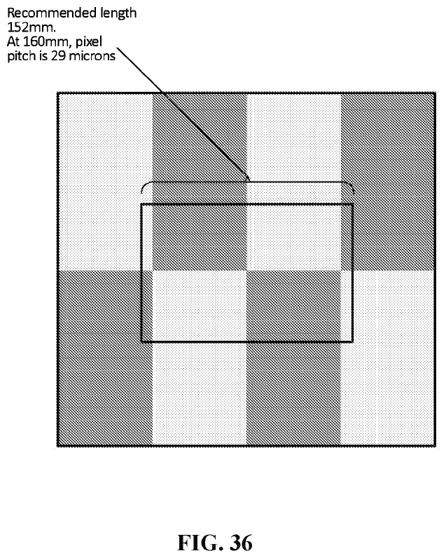

The details of the manifolds 4001, 4002 are described in FIG. 41-43.

FIG. 41 is an illustration of an isobaric flow divider 4100. The flow divider 4100 is a portion of the left manifold 4001. The flow divider 4100 is illustrated with an inlet 4102 that directs interface material into the flow divider 4100 for flowing into the liquid vat 107. The inlet 4102 is illustrated with a manual valve 4103, such as a ball valve, to open and close the flow of interface material to the flow divider 4100. The flow divider 4100 receives the interface material flow and splits the flow up into many different, smaller branches. At each junction the flow velocity is evenly divided into smaller branches, such as at branch 401. The result of the flow splitting is a manifold with many small branches with equal fluid velocity outputs. If the flow divider 4100 were a single cavity, the flow profile of the interface material would include a wide variation in fluid velocity, with the flow velocity being highest in the center and slowest at the edges of the flow. The small branches of the isobaric bifurcating flow divider 4100 prevent this from occurring by splitting the flow into many branches that are simultaneously fed into the liquid vat 107 at substantially the same flow rate and the same pressure.

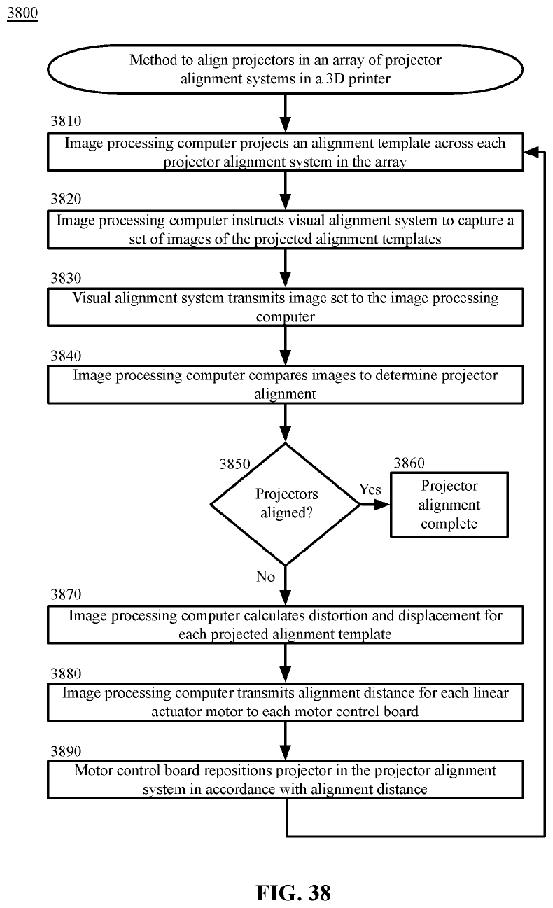

As illustrated in FIG. 41, the flow inlet 4102 directs the interface material into the flow divider 4100 vertically from the bottom. In alternate examples, the flow inlet 4102 directs the interface material into the flow divider 4100 at other angles, such as 30 degrees from vertical, 45 degrees from vertical, or 60 degrees from vertical. Any angle of entry may be used to minimize the space requirements for the flow path. The flow may enter horizontally in alternate examples. Turning the flow to a horizontal entry into the liquid vat 107 would create turbulence that would cause variation in the fluid flow profile and interfere with the interface. Flow straighteners are utilized to prevent the turbulence, as described in FIG. 43.

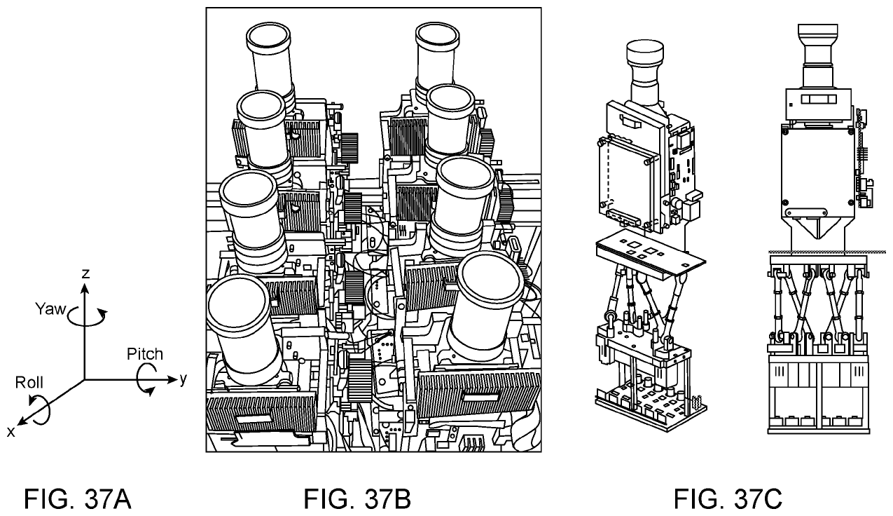

FIG. 42 is an illustration of the outlet of the flow divider 4100. The holes 4201 are the outlet through which the divided interface material flows out of the flow divider 4100. In the example, the flow is initially upwards vertically but is turned to horizontal for input into the liquid vat 107, as depicted by the arrow 4202.

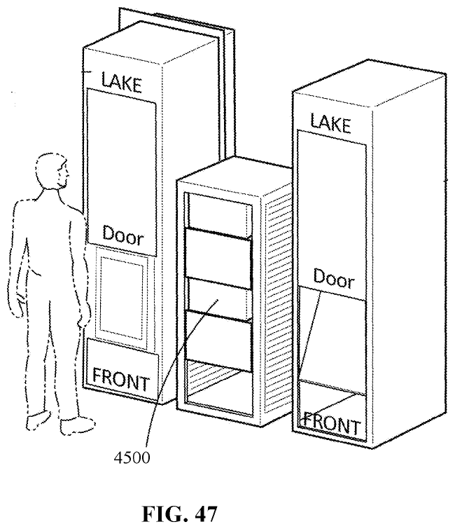

FIG. 43 is an illustration of flow straighteners 600. The straighteners 600 have pockets that cover each outlet of the isobaric bifurcating flow divider 4100, such as holes 4201 in FIG. 52. The straighteners 4300 direct the flow down a channel of very narrow fins 4301. These narrow channel fins 4301 force the turbulent flow to become laminar again before the interface material is introduced to the liquid vat 107 and exposed to the resin/interface material interface. The channel fins 4301 are designed to be long enough to remove the turbulence from each flow path based on the flow rates, viscosity, and density of the interface material being straightened. For example, a interface material with less viscosity may require a longer channel fins 4301 or a greater number of smaller channel fins 4301.

Manifold 4002 receives the interface material flow on the opposing, or right, side of the liquid vat 107. The manifold 4002 may have flow straighteners and flow dividers to direct the flow back to a single tube or pipe for removal from the 3D printer. The interface material may be directed to an fluid handling and thermal management system for cooling, cleaning, pumping, and return to the 3D printer.

In an example, a method to use the manifolds may comprise installing the manifolds, filling the manifolds with interface material, opening a ball valve in the inlet of the left manifold, turning on a pump to force interface material through the manifolds, monitoring the appearance of the flow and the interface, monitoring the level and temperatures of the interface material, and adjusting the flow rate to achieve stable laminar flow at an appropriate flow rate and temperature. An operator may perform these methods manually or via computer control. An operator may adjust any variables to improve the performance, such as by adjusting the pump speed, the printing speed, the interface material level, or any other variable. Some or all of the methods, such as adjusting the pump speed, may be performed by a computer controller, such as a flow computer on the 3D printer.

### Fluid Handling and Thermal Management System

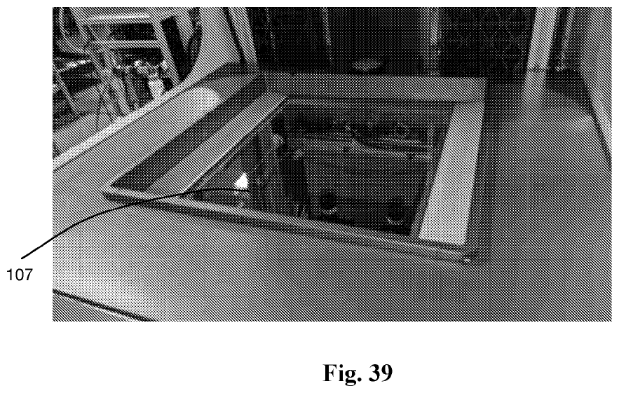

FIG. 44 is a picture of an example fluid handling and thermal management system. The unit is rack mounted on a portable rack. The details of the fluid handling and thermal management system and chiller are illustrated in the drawings and pictures herein.

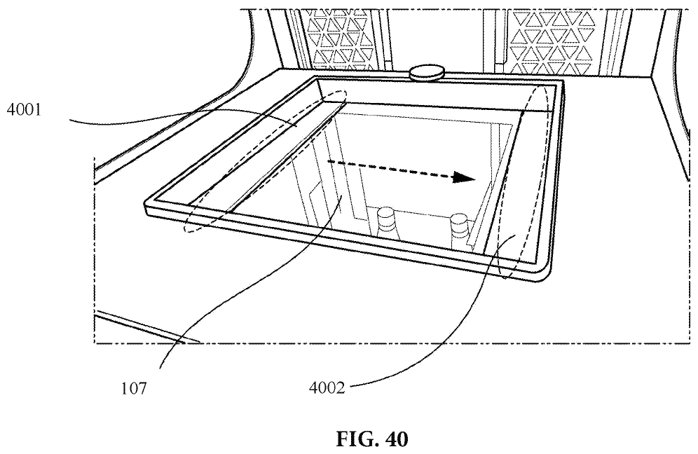

FIG. 45 is an illustration of an fluid handling and thermal management system 4500. An example fluid handling and thermal management system 4500 includes a volumetric pump 4503, filters 4508, a heat exchanger 4507, a fan 4501, an enclosure case 4502, quick disconnects 4505, electronics 4506, and various control sensors (including a computer, pressure, and temperature sensors). The heat exchanger 4507, or chiller, is represented as a rackmount plate heat exchanger unit. The fluid handling and thermal management system 4500 may be integral to the 3D printer, affixed to the 3D printer, or located separately from the 3D printer. The fluid handling and thermal management system 4500 may be a part of the 3D printer without being located on the same rack with the 3D printer. The fluid handling and thermal management system 4500 may be scaled to service more than one 3D printer as described herein.

The fluid handling and thermal management system 4500 may include a material separator (not pictured). In an example, a material separator device may be configured that uses buoyancy, while another example material separator utilizes changes in flow direction to enhance the buoyancy of the contaminants. The material separator uses an inlet for the interface material flow, an outlet for the interface material flow, a collection region (or stagnation region) for resin, air, or other contaminants to collect, and a vent near the collection region. The material separator can be configured to perform these tasks while being small enough to include onboard a 3D printer device.

One version of the material separator utilizes a “reverse J bend.” The device is shaped like a question mark or an upside-down J, as illustrated herein. As interface material flows through this version, the flow is initially upwards toward the vent and then changes direction downwards toward the outlet. Any trapped bubbles or resin will float into a collection zone near a vent at the topmost point of the flow tube. The separation of the contaminants from the interface material is aided by the initial upwards flow direction of the interface material. The advantages of the reverse J bend separator over a column separator are that the collection region is separate from the interface material flow and the reverse J bend separator is shorter than the column separator, which allows the reverse J bend separator to fit in a smaller housing.

An alternate version of the material separator is a column separator that primarily utilizes a vertical tube with caps for interface material inlet, interface material outlet, and a vent. The column separator is sufficiently tall such that any air or resin captured in the interface material will float to the top before the interface material reaches the outlet of the column separator.

The volumetric pump 4503 is a pump that creates a constant volume of fluid every rotation/actuation of the pumping mechanism that is constant regardless of the pressure in the system. For example, the pump 4503 may be a piston pump, a gear pump, a screw pump, a diaphragm pump, or other type of positive displacement pump. The volumetric pump 4503 will provide a steady flow of interface material even when a portion of the system is creating more back pressure, such as by a clogging of the filters 4508. One advantage of the volumetric pump 4503 is that the pump 4503 allows for the fluid handling and thermal management system 4500 to be removed from the 3D printer as a means of vibration isolation. If mounted on the machine, vibrations from the pump (even with vibration dampening) may disturb the resin/interface material interface, which is sensitive to vibration. Further, the constant volume flow rate provided by the pump 4503 enables the changing of the amount of interface material in the system and the location of the fluid handling and thermal management system 4500 relative to the 3D printer without any adjustment to pump operation. Changing interface material levels and moving the fluid handling and thermal management system 4500 relative to the 3D printer will result changes in system pressure. These changes in system pressure would require a pump that is not a volumetric pump to need tuning for each location of the fluid handling and thermal management system 4500 as well as interface material levels to obtain precise repeatable interface material flow needed for the 3D printer. The pump 4503 may be sized to provide a volume of interface material at which the 3D printer operates most efficiently depending on the conditions, the part being produced, or any other suitable factors. The pump 4503 may pump the interface material such that the Reynolds number of the interface material inside the print vat is <1000, <2000, <3000, or <5000.

Another advantage of the fluid handling and thermal management system 4500 design is the ability to stack fluid handling and thermal management system 4500 components in a tower. This tower stacking saves space on the factory floor. A rack of fluid handling and thermal management systems 4500 are able to support up to four 3D printers. Sharing the rack space enables easy scaling of the system to industrial applications. Since the fluid handling and thermal management system 4500 is not incorporated in the body of the 3D printer, the system allows for the printers to be constructed with a smaller footprint.

Another benefit of the fluid handling and thermal management system 4500 design is enabled by the modularity of the fluid handling components. The filters 4508 in the fluid handling and thermal management system 4500 need regular servicing, and pumps 4503 are commonly one of the first things to fail in a system. As these parts require more frequent maintenance, the inclusion of dripless quick disconnects 805 allows the fluid handling and thermal management system 4500 (and most of the fluid handling system) to be switched out for a new working unit with minimal down time to the 3D printer. An operator may simply disconnect the fluid handling and thermal management system 4500 from the 3D printer and install a new rack with an fluid handling and thermal management system 4500. The new fluid handling and thermal management system 4500 may be connected back to the 3D printer with the quick disconnect fittings 805.

The side fan 4501 is positioned in the enclosure 4502 to blow air out of the enclosure 4502. The fan 4501 is used for heat and condensation control in the enclosure 4502. The filters 4508 are side mounted to fit inside of the enclosure 4502 of the fluid handling and thermal management system 4500. The filters 4508 may be mechanical particle filters or other similar filters designed to remove contaminants in the interface material. The heat exchanger 4507 may be a plate heat exchanger. The heat exchanger 4507 may use cold or chilled water to remove heat from the interface material. In another example, other cooling liquids or gases may be used to remove the heat. In another example, other types of heat exchanges may be used, such as a shell and tube heat exchanger, a finned tube heat exchanger, a cooling tower, coiled pipes, or any other heat exchanger type. The heat exchanger 4507 cools the interface material to allow the interface material to be returned to the liquid vat 107. The cooled interface material returns to the liquid vat 107 and removes heat from the liquid vat 107 to prevent the system from overheating.

The heat exchanger 4507 may heat or cool the interface material as required. That is, certain 3D printing systems operate more efficiently when the interface material is cooled to a certain temperature, while other 3D printing systems operate more efficiently when the interface material is heated to a certain temperature. For example, the heat exchanger 4507 may cool the interface material to room temperature, <20 C, <10 C, <5 C, <0 C, or <−5 C. In other examples, the heat exchanger 4507 heats the mobile interface material to a temperature >10 C, >25 C, >50 C, or >100 C.

The electronics 4506 may represent any computing or electronic devices that measure, monitor, or control the operations of the components of the fluid handling and thermal management system 4500 and/or the 3D printer. For example, the electronics 4506 may be a computer controller that receives inputs of level, temperature, flow rate, pump outputs, control valve positioning, pressure sensors, or any other input and uses the inputs to control the operations of the components. For example, the computer controller may be a flow controller. The flow controller may receive an input of the temperature devices and determine that the temperature is higher than a threshold. The flow controller may increase the speed of the volumetric pump 4506 to increase the amount of interface material in the liquid vat. In another example, the computer controller receives inputs from a user or another device with instructions that the interface material is being provided to two different 3D devices. The computer controller determines how much to open a control valve that provides oil flow to a first 3D printer and how much to open a second control valve that provides oil flow to a second 3D printer. Details of an example computer system are further discussed in FIG. 111.

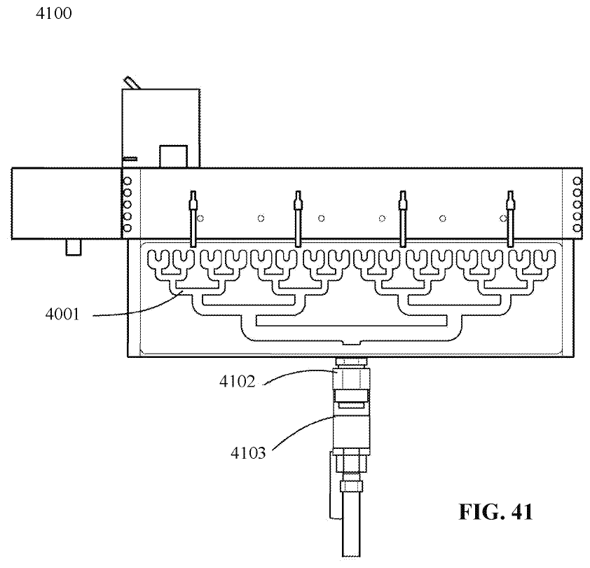

FIG. 46 is a picture of the fluid handling and thermal management system 4500. The fluid handling and thermal management system 4500 is pictured with a volumetric pump 4503, filters 4508, a heat exchanger 4507, quick disconnects 4505, and electronics 4506.

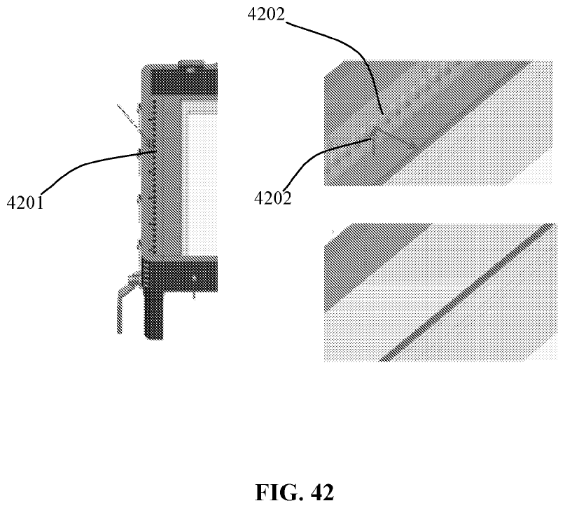

FIG. 47 is an illustration of a single rack of fluid handling and thermal management systems 4500 servicing two 3D printers. The fluid handling and thermal management system 4500 is located separate from either of the 3D printers 100 to prevent vibrations and other issues from disturbing the 3D printing process. By servicing multiple 3D printers, factory floor space is conserved.

In an example, a method to use the fluid handling and thermal management system 4500 may comprise installing the fluid handling and thermal management system 4500, filling the lines with interface material, opening a ball valve in the inlet of the fluid handling and thermal management system 4500, turning on the pump 4503 to force interface material through the system, monitoring and replacing the filter elements 808, monitoring the temperatures of the interface material exiting the heat exchanger, and adjusting the flow rate of the pump 4503 to achieve stable laminar flow at an appropriate flow rate and temperature. An operator may replace parts by stopping the flow and disconnecting the fluid handling and thermal management system 4500 from a 3D printer. An operator may connect more than one 3D printer to a single fluid handling and thermal management system 4500. An operator may perform these methods manually or via computer control. An operator may adjust any variables to improve the performance, such as by adjusting the pump speed, the printing speed, the interface material level, or any other variable.

### Hard-Mounted Z-Arm

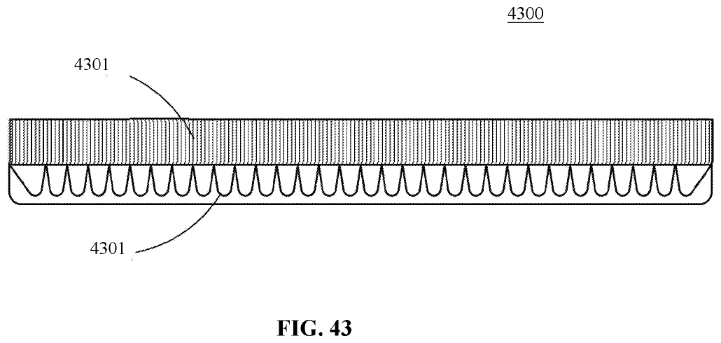

FIG. 48 is an illustration of a 3D printer with a hard mounted Z-arm 4801. The build plate 4804 on which the 3D printed part is affixed is more efficient and effective when properly aligned with the resin/oil interface on the printer. However, since the interface material is a free-flowing liquid the orientation of the resin-oil interface is determined by gravity and other external factors. When combined with standard assembly tolerances and installation and operation errors, proper alignment of the mechanical components, liquid components, and the optical components of the 3D printer is difficult to achieve and maintain. One cause of misalignment is due to the large size of the build plate and z-arm providing very little room for the precise tolerances required for alignment with the interface. Typically, to prepare consistent and accurate parts, the build plate and the angle of the Z-arm 4801 with respect to the interface material can only vary by 0.01 degrees. A basic tolerance analysis indicates that to achieve this with everything being an independent assembly each part would need to be assembled and the machine leveled to a 0.005 deg precision.

A tolerance analysis example calculation is provided for a tolerance of 0.01 degrees:

$$\begin{matrix}Tolerance = √ ( {( gravity )}^{2} + {( build plate )}^{2} + {( liquid vat )}^{2} ) \\ 0.01 \approx \sqrt{3 {x}^{2}} \\ x \approx 0. 005\end{matrix}$$

While under specific conditions, precisely designing and assembling each of the parts to this high tolerance level is possible, but industrial and other commercial users are unable to achieve this level of precision in practice in an industrial setting. Factors such as changing environmental conditions, active personnel movements, unsteady work surfaces, and other factors hinder the stability of the Z-arm. To compensate for the imprecision, hard mounting the Z-arm 4801 to the liquid vat 107 is utilized.

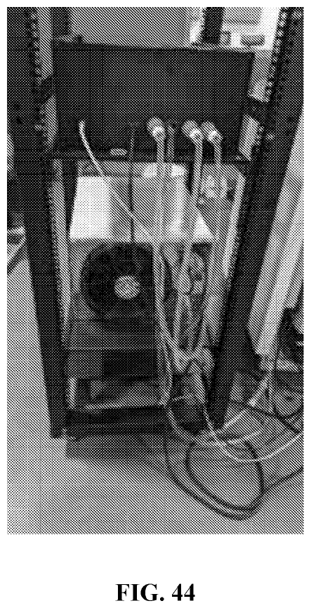

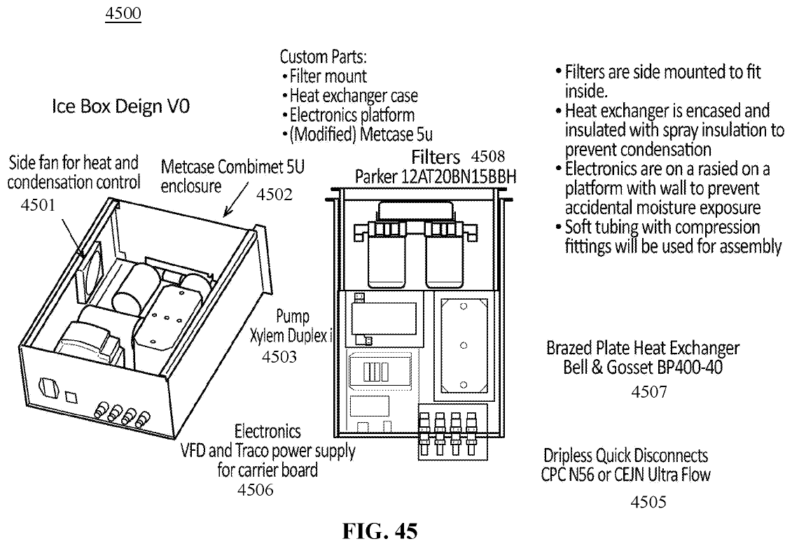

The Z-arm 4801 is illustrated connected to the body of the liquid vat 107 at the mounting brackets 4802. The mounting bracket configuration is illustrated further in FIG. 49 and FIG. 50. The Z-arm 4801 has an adjustable carriage 4803 for drawing a 3D printed part out of the liquid vat 107. The carriage 4803 may be automated to extract the part at an appropriate speed as the part is printed. The carriage 4803 may be raised and lowered by any suitable mechanical driver. For example, the carriage 4803 may be connected to a screw assembly that turns a screw to raise and lower the carriage 4803. In another example, a drive belt may raise and lower the carriage 4803. In another example, a hydraulic system may raise and lower the carriage 4803.

The Z-arm 4801 has a build plate 4804 to adhere to the part as the part is printed. The build plate 4804 is extracted from the liquid vat 107 by the carriage 4803 with the part affixed thereto. The build plate 4804 is required to remain stable and level to achieve a part that is free of defects.

The light engine 15031503 is illustrated under the liquid vat 107. The light engine 15031503 causes the photosensitive resin to cure into a part.

FIG. 49 is an illustration of the mounting bracket 4802 for the Z-arm 4801. The hard mounting of the liquid vat 107 to the Z-arm 4801 utilizes bolts and alignment pins to reduce the precision needed for assembly. The alignment of the Z-arm 4801 to the liquid vat 107 is adjustable via the bolts and pins to allow a simple yet precise alignment. The rigid mounting reduces the precision needed to assemble and align the 3D printer. After the Z-arm 4801 is aligned to the liquid vat 107, only the leveling of the 3D printer itself affects the tolerance of the build plate 4804 and the Z-arm 4801 to the interface material because when the 3D printer moves to a different alignment, the Z-arm 4801 moves to the same alignment.

FIG. 50 is an illustration of the mounting bracket 4802 for the Z-arm 4801. The mounting of the Z-arm 4801 to the liquid vat 107 via the mounting bracket 4802 is illustrated from the opposing side. An example alignment bolt 5001 is illustrated. The alignment bolts 5001 are configured to provide a preferred alignment within specified tolerances. That is, the alignment bolts 5001 are designed and manufactured such that, when the Z-arm 4801 is affixed to the liquid vat 107 via the mounting bracket 4802, the Z-arm 4801 is aligned at a preferred position in relation to the liquid vat 107. When the liquid vat 107 is adjusted, such as to achieve a level configuration, the Z-arm 4801 is simultaneously adjusted.

In an alternate example, the alignment bolts 5001 provide an adjustable alignment for the Z-arm 4801. In the alternate example, by screwing the alignment bolts 5001 in or out, the Z-arm 4801 alignment to the liquid vat 107 is adjustable. In an example, if a first alignment bolt 5001 is screwed in clockwise, the Z-arm 4801 may tilt to the right. If the first alignment bolt 5001 is screwed in counter-clockwise, the Z-arm 4801 may tilt to the left. A second alignment bolt 5001 may tilt the Z-arm 4801 forward towards the liquid vat 107 when screwed in one direction and away from the liquid vat 107 when screwed in the other direction. Any other suitable alignments may be configured to be adjustable by turning or otherwise adjusting the alignment pins.

After adjustments, the Z-arm 4801 is affixed to the liquid vat 107 and moves when the liquid vat moves 107. That is, a user may adjust the level of the entire 3D printer without having to individually adjust the liquid vat 107 and then the Z-arm 4801. When the liquid vat 107 is adjusted, such as to achieve a level configuration, the Z-arm 4801 is simultaneously adjusted.

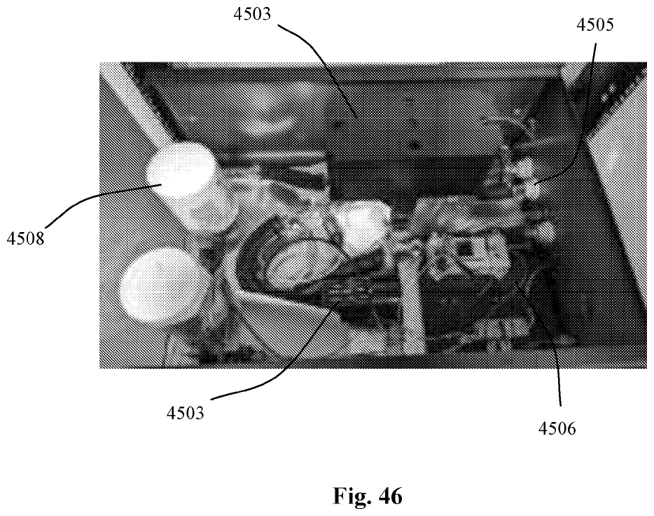

FIG. 51 is a picture of the Z-arm 4801 unassembled. The mounting bracket 4802 is illustrated where the mounting bracket 4802 would be mounted to the rim of a liquid vat 107.

FIG. 52 is an illustration of the Z-arm 4801 being assembled. The mounting bracket 4802 is mounted to the rim of a liquid vat 107.

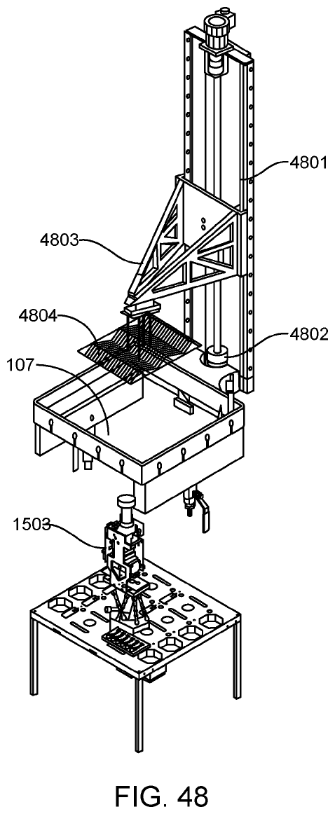

FIG. 53 is a picture of the Z-arm 4801 being assembled. The mounting bracket 4802 is available to be mounted to the rim of a liquid vat 107.

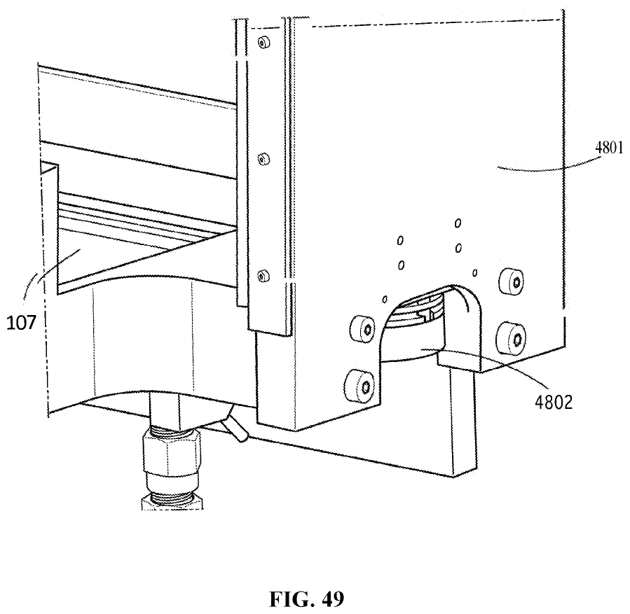

FIG. 54 is an illustration of the Z-arm 4801 and liquid vat 107 being assembled. The Z-arm 4801 is mounted to the rim of a liquid vat 107. The build plate 4804 is above the surface of the liquid vat 107. A bubble level 5401 is being used to level the liquid vat 107 (and thus the affixed Z-arm) to ensure that the resin layer, the interface, and other variable surfaces are level. Any other means of achieve a level configuration may be used, such as a laser level.

In an example, a method to install and use the Z-arm 4801 may comprise placing the Z-arm 4801 on a liquid vat 107, aligning the connections between the Z-arm 4801 and the liquid vat 107, screwing in the bolts to connect the Z-arm 4801 to the liquid vat 107, adjusting the bolts and the alignment pins to hard-mount the Z-arm 4801 to the liquid vat 107, and leveling the system. An operator may replace parts by removing the Z-arm 4801 from the liquid vat, or any parts of the Z-arm 4801.

### Temperature Control

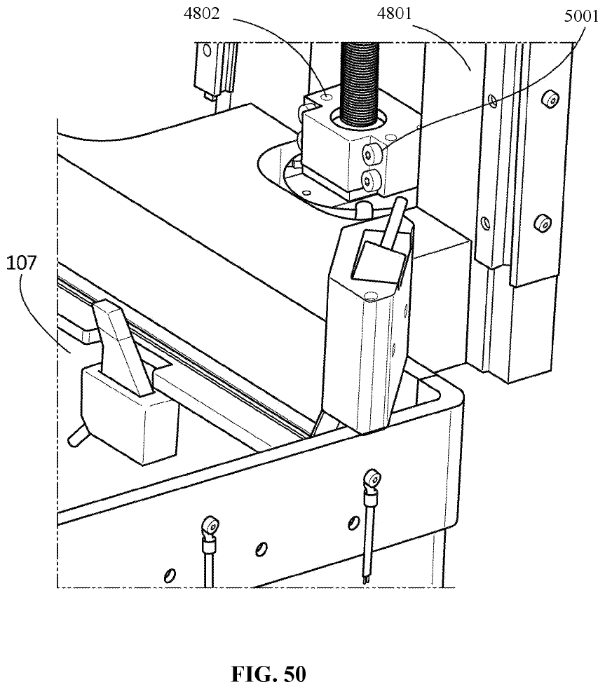

FIG. 55 is an illustration of temperature sensors 5501 arrayed on a liquid vat 107. The sensors 5501 may be any suitable type of temperature sensor 5501, such as a thermistor, resistance temperature detectors, thermocouples, infrared, or any other suitable temperature sensor. The sensors 5501 gather temperature data of the resin and interface material before, during, and after a 3D printing session. The temperature of the resin and the interface material during a print can change dynamically in accordance with the amount of energy being dissipated through the interface material/resin interface.

The curing of the resin creates heat and the flowing interface material removes heat from the 3D printer when the interface material is pumped out of the 3D printer to a heat exchanger or other cooling module. The changes in temperature may be localized or may be spread throughout the liquid vat 107 depending on factors such as the size and complexity of the part being printed, the flow rate of the interface material, the depth of the interface material, the ambient temperature, or other factors. In an example, the sensors 5501 being utilized are direct contact thermistors 5501 that measure the temperature of the metal of the liquid vat 107 to which the thermistors 5501 are attached.

The use of many sensors 5501 located around the liquid vat 107 allows the system to measure a temperature gradient for both the resin and interface material. The system measures a gradient across the perimeter because the temperature of the interface material and resin affect the quality of the 3D printed parts and the process. Once known, the temperature gradient within the interface material and resin can be used to adjust factors affecting the printing process. Based on the temperature profile provided by the sensors 5501, the system may adjust the flow rate of the interface material, the amount of cooling of the interface material by the heat exchanger, and speed of the 3D printing of the part, or any other suitable factors to achieve a desired temperature profile.

For example, if the temperature of the exiting interface material is higher than a configured benchmark, then the system may take an action such as increasing the velocity of the interface material that is flowing through the liquid vat 107 or decreasing the temperature of the interface material that is provided to the liquid vat 107. In another example, if the temperature of the interface material entering the liquid vat 107 at the manifold 4001 is too high, then the system may increase the cooling capacity of the heat exchangers, such as by lengthening the residence time of the interface material in the heat exchanger.

In an example arrangement, four sensors 5501 are installed on the outside right and left walls of the aquarium, and another four on the outside of the front wall opposite the Z-arm. On the manifolds, one sensor 5501 is installed on the entry of the inlet manifold 4001 to verify that the interface material coming into the aquarium is at the desired temperature. Seventeen sensors 5501 are installed on the outlet manifold 4002 to record the temperature of the interface material coming out of the aquarium. The temperatures exiting the manifold 4002

An example of the temperature calculations done to verify the effectiveness of the interface material is provided in Table 5.

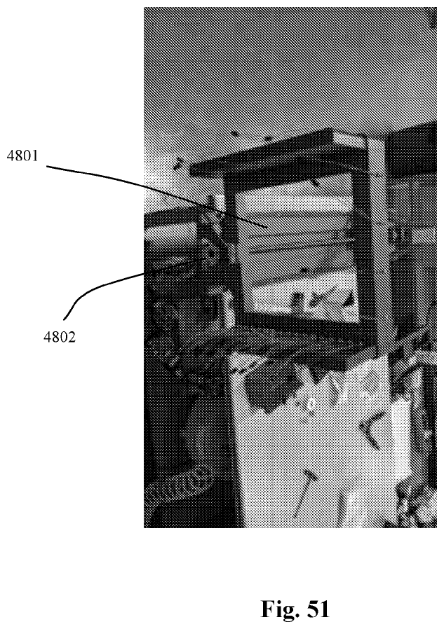

FIG. 56 is an illustration of sensors 5501 arrayed on an outlet manifold 4002 of a liquid vat 107. One sensor 5501 is installed at the outlet valve of the manifold 4002, which is illustrated as being below the other sensors 5501.

A computing or electronic device may measure, monitor, or control the operations of the components of the fluid handling and thermal management system and/or the 3D printer based on the temperature inputs. For example, the controller may be a computer controller that receives inputs of temperature or any other input and uses the inputs to control the operations of the components of the 3D printer or fluid handling and thermal management system. For example, the computer controller may be a flow controller. The flow controller may receive an input of the temperature devices 1801 and determine that the temperature is higher than a threshold. The flow controller may increase the speed of the volumetric pump 4503 to increase the amount of interface material in the liquid vat.

In another example, the computer receives inputs of the temperature sensors 5501 and creates a gradient or profile of the liquid vat. For example, by knowing the locations of each sensor 5501, the computer may input the temperatures into a computer model of the liquid vat. With the temperature of each location on the liquid vat known, a model of the entire liquid vat may be created by interpolating the temperatures for each portion of the liquid vat. The model may further use the temperature changes for each sensor 5501 over time to create a model of how the temperature flows and changes inside the liquid vat as a part is printed. The model may be used to identify problem areas, identify hot spots, identify locations that require more flow or cooling, identify resin depths that function more efficiently, or determine any other characteristics of the liquid vat temperature that affect efficiency.

### Resin Depth

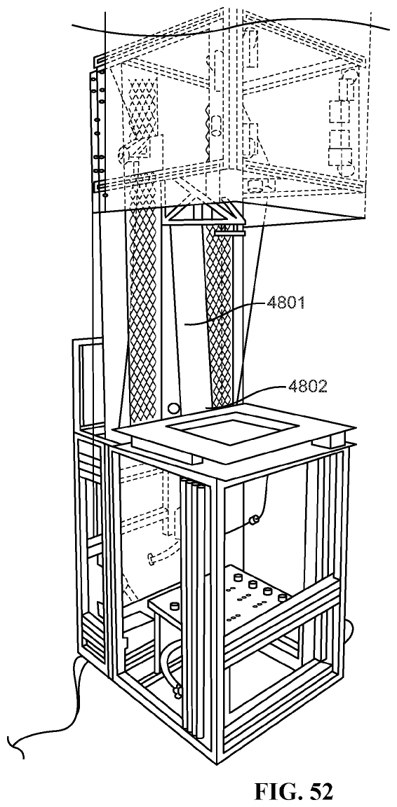

FIG. 57 is an illustration of a liquid vat 107 with an upper-level sensor 5702 and a lower-level sensor 5701. The 3D printer operates more efficiently and consistently when the resin depth is known, and the build plate 4804 is aligned at the proper depth.

The 3D printer utilizes level sensors, such as upper-level sensor 5702 and a lower-level sensor 5701 to measure the depth of the resin in the liquid vat 107 and the depth of the resin/interface material interface. The sensors 5701, 5702 may be based on any suitable level technology, such as laser sensors, optical sensors, proximity switches, float sensors, or any other sensor. In the examples herein, the level sensors 5701, 5702 are laser sensors.

In the example, the system uses one laser sensor 5701 mounted underneath the liquid vat 107 and one laser sensor 5702 mounted above the liquid vat 107. For the lower laser distance sensor 5701, the laser passes through a window in the floor of the liquid vat 107 and the optically clear interface material and is reflected from the resin on top of the interface. The interface level subtracted from a known height of the window at the bottom of the liquid vat 107 gives the interface material height f. The upper laser sensor 5702 is reflected from the upper surface of the resin in the liquid vat 107. Subtracting the height of the interface from the upper surface of the resin, the system can easily calculate the amount of resin in the liquid vat 107. By knowing the height of the interface material in real time the height of the Z-arm can be held constant with respect to the interface material height. By holding the build plate 4804 constant with the interface, the resin may build at the interface level and utilize the benefits provided by the interface.

In this configuration, even if small variations in oil height occur the Z-arm can be adjusted in real time. That is, if the level of the interface material is higher than expected, the system will recognize that the interface is higher than expected and raise the Z-arm, which raises the build plate 4804 to the new, higher level of the interface.

A computing or electronic device may measure, monitor, or control the operations of the components of the fluid handling and thermal management system and/or the 3D printer based on the level inputs. For example, the controller may be a computer controller that receives inputs of level or any other input and uses the inputs to control the operations of the components of the 3D printer or fluid handling and thermal management system. For example, the computer controller may be a flow controller. The flow controller may receive an input of the level devices 5701, 5702 and determine that the level of the interface material is lower than a threshold. The flow controller may increase the speed of the volumetric pump 4503 to increase the amount of interface material in the liquid vat.

### Printed Circuit Board

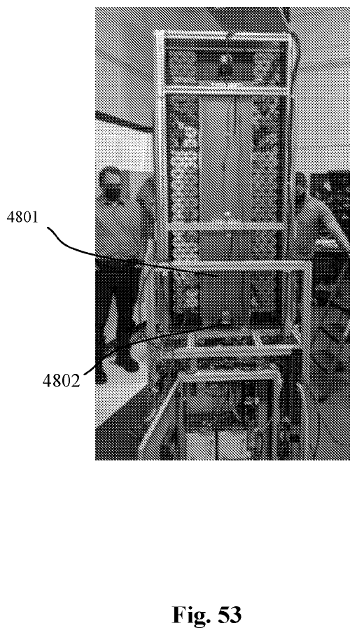

FIG. 58 is a schematic for a custom designed printed circuit board (“PCB”). The PCB may be located onboard the 3D printer to take measurements from the temperature sensors, the interface material/resin level sensors, and other analog sensors in a centralized manner. The PCB connects with small custom computers integrated into the control system of the 3D printer. The board enables collection of an analog voltage signal series of Analog-to-Digital Converter (“ADC”) Integrated Chips (“ICs”) that are coupled with voltage divider circuits for the temperature sensor readings and current sensor circuits for the level sensors. The ICs are selected with multiple ADC channels and I2C addresses. I2C is a low-level digital communication protocol, which allows the number of inputs to be scaled up to 64 on a single I2C bus.

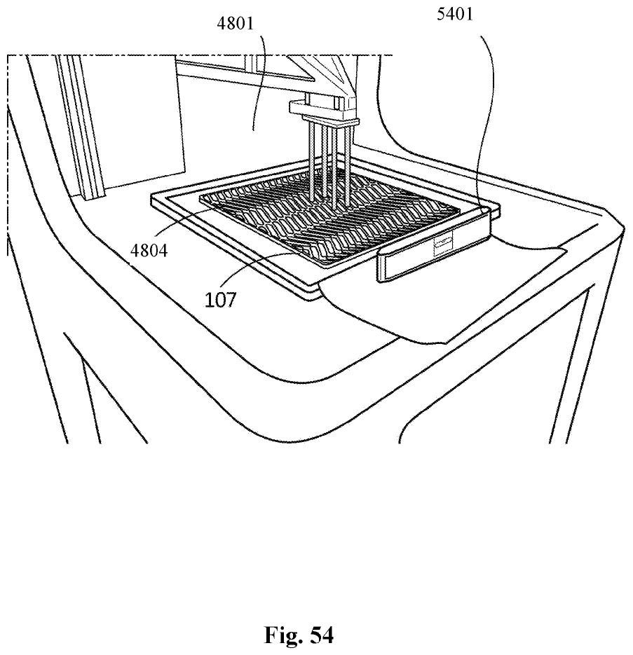

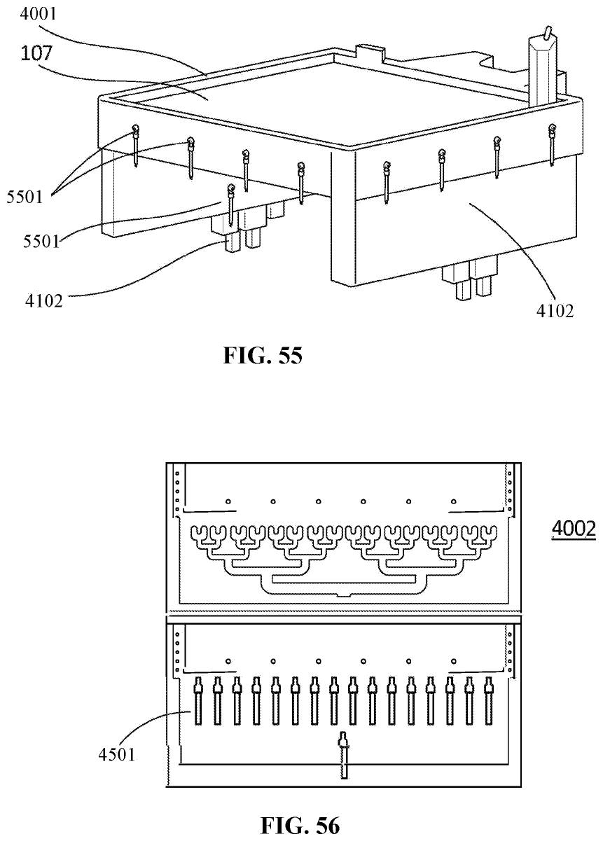

FIG. 59 and FIG. 60 are layouts for the custom designed PCB. FIG. 59 connects to FIG. 60 at locations A and B. When joined at connections A and B, FIG. 59 and FIG. 60 create a single PCB layout.

### Alternative Designs

An improvement to the fluid handling and thermal management system design as depicted and described herein may include using computer-controlled flow control valves that would enable a single fluid handling and thermal management system to provide cooling interface material flow to two or more 3D printers simultaneously. For example, the cooled, filtered interface material exiting a fluid handling and thermal management system may have the flow split, and each split flow would be controlled by a control valve, such as a gate valve. The control valves would allow the single fluid handling and thermal management system to provide flow to two separate liquid vats on two separate 3D printers. Changing the pump speed may affect both 3D printers, so using a control valve to control the flow allows the 3D printers to have flow rates of interface material changed independently.

In another example, flow control valves may be added to a heat exchanger to allow a single heat exchanger to support two fluid handling and thermal management systems. That is, the pump from two separate 3D printers would pump interface material to a single heat exchanger, either jointly or alternately. The output of the single heat exchanger would then be split and pumped back to the fluid handling and thermal management systems.

A typical configuration of the technology herein would use a tower of four stacked chillers and four stacked fluid handling and thermal management systems supporting four 3D printers. However, using a configuration of control valves as described would allow the same output with a single tower of one chiller and two fluid handling and thermal management systems supporting four 3D printers. This configuration would save space and costs.

Another improvement may be made to the laser detection of interface material and resin height. The current system works with resin that has color but not for resin that is optically clear and without color. The optically clear resin may not reflect a laser signal due to the refractive index of the resin. A laser reflection is required for the current laser sensors to work.

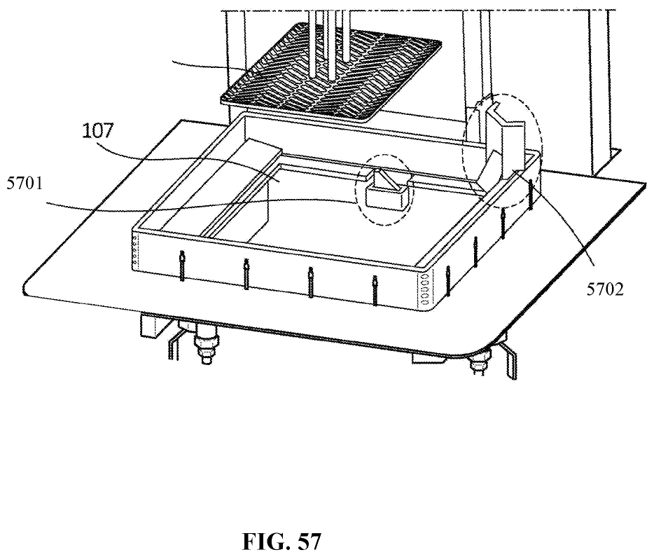

To overcome this issue, alternative sensors may be used to detect interface material and resin in the 3D printer. A first sensor alternative uses ultra-sonic sensors mounted above the liquid vat. The first sensor will detect the combined height of the main liquid vat filled with both interface material and resin. The second ultra-sonic sensor will be mounted above a channel that only has interface material in it. The channel has an opening underneath that allows interface material to flow between the channel and the liquid vat but not resin. With these two measurements, a system would be able to know the height of both the interface material and the resin. The system is described in greater detail in FIG. 61.

FIG. 61A is an illustration of a system with ultra-sonic sensors with a interface material channel. A first sensor 6101 is mounted over the combined resin and interface material in the liquid vat 107. The ultrasonic sensor 6101 bounces a signal off the resin surface and measures the height of the resin surface. A second sensor 6102 is positioned over a channel 6103 of only interface material. The channel 6103 is not in the liquid vat 107, but is allowed to equalize the height of the interface material because the channel 6103 is open to the interface material in the liquid vat 107. FIG. 61B is a top view of the liquid vat 107 and the channel 6103. A divider between the liquid vat 107 and the channel 6103 has one or more holes or cutouts to allow the interface material level to equalize. The channel 6103 may be located in any suitable position, such as parallel to the liquid vat 107 or in any other configuration. The second sensor 6102 bounces a signal off the surface of the channel 6103 and determines the height of the interface material. By subtracting the surface of the interface material from the surface of the resin, the total height of the resin may be calculated, and the height of the interface may be determined.

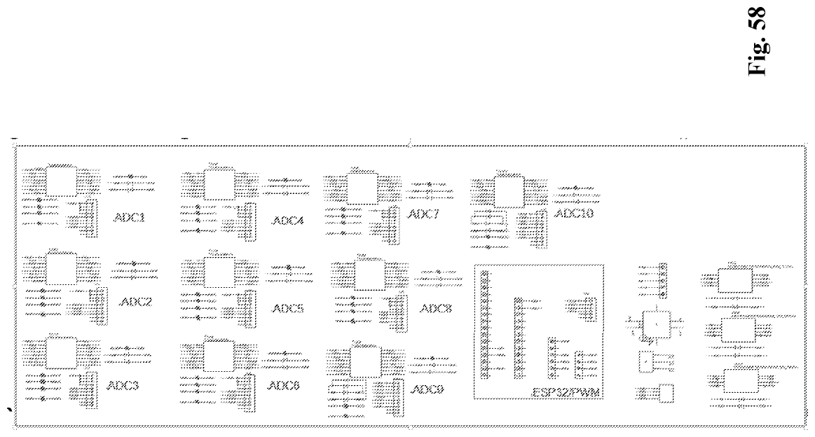

In another alternative design, submerged lasers are utilized in the liquid vat. FIG. 62 is an illustration of a submerged laser level 6201 with mirrors 6202. Instead of the laser being placed above or below the liquid vat 107, the laser is submerged into the resin in the liquid vat 107. While the index of refraction of the resin (and interface material) does not allow for a laser to bounce of its surface and return to the sensor, the index of refraction does allow for the optical property of Total Internal Reflection (“TIR”). TIR is the same phenomenon utilized in fiber optic cables where the laser can bounce inside the resin. When a laser module 2601 is placed inside the resin and angled with the critical angle needed for TIR, the laser can then be made to bounce from the interface of the interface material and the resin. In FIG. 62, the signal bounces off the interface and reflects from a series of mirrors 6202 to bounce back off the interface a second time. The signal is received by the submerged laser level 6201. The laser is able to use the received signal to determine the height of the interface. Alternatively, the laser may bounce the signal upwards off the inner surface of the resin to detect the total height of the liquid vat 107.

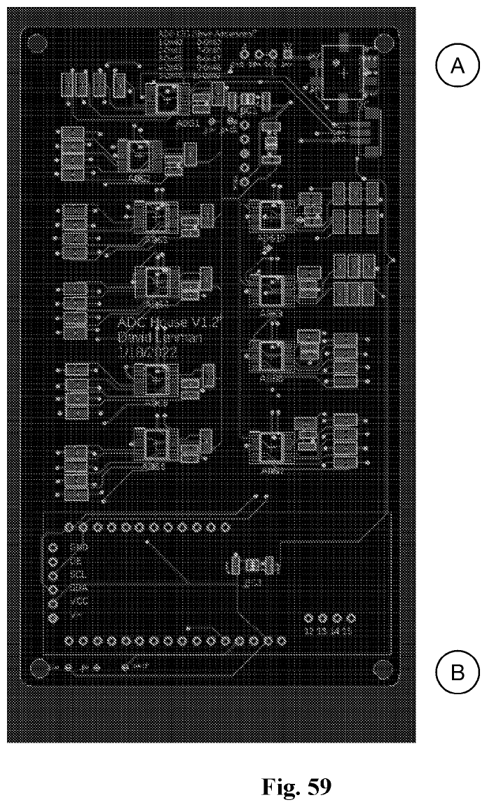

FIG. 63 an illustration of a submerged laser level signal generator 6301 with a separate detector 6302. In this example, the laser level signal generator 6301 produces the laser signal and bounces the signal off the interface of the resin and interface material. The signal is received by the detector 6302. In this manner, the level is determined from a single bounce of the signal off of the interface. Alternatively, the laser may bounce the signal off the surface of the resin to detect the total height of the liquid vat 107.

### Build Plate

During the 3D printing process as described, the printed part remains affixed to the build plate until removed after printing is completed. If at any point in the printing process the adhesion between the printed part and the build plate fails, the printed part can fall, tilt, or otherwise change position relative to the build plate, resulting in additional failure modes. After the printed part is complete, a technician or an industrial machine separates the printed part from the build plate. The separation should be complete and without compromising the integrity of the potentially fragile printed part. The printed part should adhere to the build plate to remain securely affixed throughout the printing process while still being easily separated after the print is completed.

Various methods may be used to modify the adhesion of the printed part to the build plate. The material of the build plate may be changed to increase or decrease adhesion. Materials used to construct build plates range from plastics, such as polyethylene or polypropylene, to metals, such as stainless steel or aluminum. Different materials create different amounts of adhesion of the printed part to the build plate. The surface of the build plate can also be mechanically or chemically modified to promote or curb adhesion. Increasing the surface area for adhesion, such as by increasing the cross-sectional area of the build plate itself, scoring, sanding, or introducing surface topologies, increases an adhesion between the printed part and the build plate. Similarly, if the surface of the build plate is chemically modified to introduce functional groups that chemically bond with the photosensitive resin, adhesion can be increased. If the functional groups introduced are chemically distinct and incompatible with the photosensitive resin, adhesion can be decreased.

A high surface area is desired to maintain sufficient adhesion of an object to the build plate throughout the printing process. However, having a build plate with a large cross-sectional area can introduce multiple difficulties to the printing process. For example, in the initial stages of printing, the build plate is positioned close to the printing interface, and as the build plate moves upward, the build plate exerts a force on the printing interface that is directly proportional to the cross-sectional area of the build plate. Large forces exerted on the printing interface have the potential to damage or deform the printing interface or the object being printed. In an example, the forces may be created by a swirling effect in the liquid resin and/or interface created by the movement of the build plate. The rising build plate may force liquid resin above the build plate to flow around the build plate. The rising build plate may cause liquid resin to flow under the build plate to fill the space left as the build plate is raised upward. For example, the rising build plate may create a vacuum effect as the build plate movement creates a void of low pressure in the space from which the build plate moves. This vacuum effect creates a cavitation force on the interface which can disturb and in some cases damage the interface. The fluid from above the build plate flows to the low pressure zone.

As described herein, the print interface comprising the interface material on which the liquid resin rests may come in a variety of materials and compositions. The interface material may be a fluoro oil, but may also include materials such as coated solids, films, soft hydrogels, and other liquids. Some of these materials are more vulnerable to disturbances or damage to the interface than others. Maintaining the integrity of the printed object and the printing interface makes objects reliable and repeatable in a photopolymer 3D printer.

As the build volume of a photopolymer 3D printer becomes larger, larger printing interfaces and build plates are used. The larger build plate area promotes adhesion of the printed part or parts throughout the entire build volume, which must balance against the problems caused by the high forces applied to the printing interface. Additionally, when the build plate is near the interface and in a continuous production mode, the liquid resin will not be able to fill the gap due to surface tension and capillary forces.

One conventional method to increase the size of the build plate relies on using rigid print interfaces that minimize deformation when acted upon by the flow forces. Using rigid interfaces excludes soft print interfaces, such as hydrogels, liquids, and other soft print interfaces. In another conventional method, the force exerted on the print interface can be reduced by slowing the upward movement of the build platform in the initial stages of the print. However, this approach reduces printing speeds and negatively affects the throughput of the 3D printer. In certain examples, a completely solid build platform over a large enough area cannot be slowed enough to mitigate the forces on the interface. For this reason, perforations in the build platform can be used.

The perforations provide gaps in the continuous area of the build plate, which reduces the force the build plate exerts on the print interface as the build plate is raised away from the interface. In an example, the liquid resin surrounding the build plate flows through the perforations instead of being forced to flow around a perimeter of the build plate. With a smaller and slower flow path required to fill the space of the rising build plate, smaller swirling and other forces are placed on the liquid resin above the interface between the liquid resin and the interface material. As the liquid resin flows through the perforations of the build plate to occupy available space as the build plate moves, the liquid resin is more readily supplied to the location where the resin is cured at the printing interface.

A potential obstacle presented by the perforations is that resin can solidify into the perforation hole, which makes it harder to remove that part from the stage without damaging the part. The removal process may require additional labor or time. When the resin is solidified in the perforation, further process steps are required, such as using printed raft supports or sanding the part where the part touches the perforations. These types of further steps are undesirable as the steps increases cost and waste material.

The technology discussed herein involves customizing the build plate by adding perforations in designed locations to promote adhesion of the object to the build plate and to minimize the forces exerted on the printing interface. The 3D printing process has been predominately used for prototyping or making many different parts on a single printer. As such, the build plate operates more efficiently when the build plate is constructed to be as universal as possible. With the advances in throughput from technologies as described herein, 3D printing can be used in production manufacturing of parts with the same or similar geometries in volume. Customizing the plate to a specific part further increases productivity in the manufacturing process.

The perforations can be placed in locations custom to the part being printed. The build plate may be constructed with a continuous or mostly continuous build plate surface in the areas where the part is affixed or where printed supports come into contact with the build plate. The combination of custom solid surfaces where the part is affixed with perforations in the non-contact regions provides improved resin flow with reduced suction forces. This combination also provides a clean face where the part is affixed to the build platform.

Some examples of build plates may have >80%, >50% or >25% of the perforated section open. For example, for a given build plate total area, more than 80% of the total area is the open space of a perforation and less than 20% of the total area comprises metal surfaces of the build plate. Some examples may have the continuous section where the part is affixed be <50%, <20%, <10%, <5%, or 0% open.

Some embodiments only have continuous sections where the part is affixed to the build plate with the other portions of the build plate having perforations. In another example, a build plate may have continuous sections enclosing the outer perimeter of the cross section of the face of the part that is in contact with the build plate but certain portions of the affixed region being open with one or more perforations. In another example, a build plate may have continuous sections enclosing the outer perimeter of the cross section of the face of the part that is in contact with the build plate but the majority of the affixed region being open with one or more perforations.

In another example, the build plate may have a solid custom surface that covers a particular region of the build plate. Multiple printed parts that may have an outer perimeter smaller than the outer perimeter of the solid surface may use the single custom build plate. The printed parts may have different shapes that affix to the build plate, but if the affixed sections are inside the perimeter of the custom solid surface, then the print may use the build plate. Thus, a single build plate may be used for multiple parts shapes while still having perforations outside of the solid surface.

Example build plates may have a <1 mm, <5 mm, <10 mm, or <25 tolerance of the perimeter of the continuous section relative to the part cross section in contact with the build plate. Other example build plates may have a continuous section that is a simplified version of the perimeter such as a circle, rectangle, polygon, that covers all or most of the cross section of the part. For example, the continuous section may be a circle that encompasses the outer perimeter of a 3D part whose shape is complex. The circle may be a more efficient interchangeable shape than constructing a build plate with a continuous section the exact, complex shape of the part.

In some embodiments, the 3D printed part requires support structures to be printed during the process where the contact points for the supports on the build stage are continuous. In some embodiments, the 3D printed part require support structures to be printed during the process where the contact points for the supports on the build stage are perforated.

The technology may utilize the interface material/liquid resin interface for 3D printing as described herein. For printed objects to adhere to the build plate in this described system, the build plate is initially positioned near the interface of the interface material and liquid resin. In examples, the distance may be within approximately 500 to 1500 microns of the interface for optimal curing. The derivation of Stefan's adhesion law illustrates that for a flat, circular plate separated from a flat surface by a layer of fluid, the force, F, required to separate the plate is inversely proportional to the cube of the height of the fluid layer, h, directly proportional to the fourth power of the radius of the plate, r, the viscosity of the fluid, μ, and the velocity at which the plate is lifted, v:

$$Stefan adhesion law : F = \frac{3 π μ {R}^{4}}{2 {h}^{3}} v$$

Applying this formula to the present technology illustrates that at the time that a 3D printed part first begins to cure, the area of the build plate and the height of the resin layer underneath are two of the factors that determine the force exerted on the interface material/liquid resin interface. When the forces are above a threshold value, the forces may deform the interface as described herein. If a height of the resin layer beneath the build plate is increased farther from the window at the bottom of the liquid vat, the intensity of the UV light that polymerizes the resin will exponentially decay within the resin. The printed part will not adhere to the build plate when the light intensity drops below a minimum threshold. Accordingly, the present technology changes the area of the build plate to avoid large forces deforming the interface material/liquid resin interface. Reduction and control of this force is beneficial for the scaling of a 3D printing process to higher production levels. If a large solid plate, such as a two feet by two feet square, or a poorly perforated plate was used as the build plate in an industrial application, the stefan adhesion force could possibly break the glass one the bottom of the liquid vat that holds the interface material/liquid resin or cause the print to fail.

The present technology uses perforated build plates that allow for changing the area of the build plate to mitigate the forces detrimental to the interface. Creating different shapes and sizes of perforations across the build plate controls how much effective area the build plate spans at the interface level.

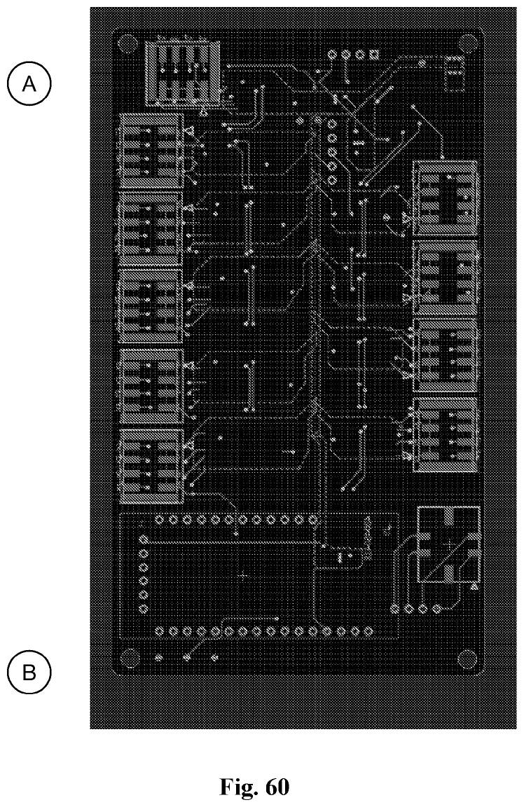

FIG. 64 is an illustration of a build plate 4804 with perforations 6402. The picture illustrates a build plate 4804 with perforations 6402 in a chevron pattern perforated out of the solid plate surface 6401. Between the rows of perforations 6402, a solid framework 6403 is disposed to provide structural strength to the build plate 4804. With the perforations 6402, the effective area of the build plate 4804 is significantly reduced, and in turn, the force exerted on the interface below by flowing liquid resin is reduced. The liquid resin may flow through the perforations 6402 when the build plate 4804 is raised or otherwise moved. The solid plate surface 6401 may have the printed part affixed to raise or otherwise move the printed part. The movement will create less swirling, turbulence, or other forces on the liquid resin, the interface, the printed part, or the interface material because a lesser amount of liquid resin is being displaced.

Further, liquid resin above the build plate 4804 can flow through the perforations to occupy available space as the build plate 4804 moves away from the interface. This allows liquid resin to flow into this available space in a shorter distance than if the liquid resin was required to flow in from the sides of the build plate 4804 only, as with a non-perforated build plate. An object that is printed needs a consistent supply of liquid resin with a shorter, slower, and more controlled flow. Additionally, a deeper column of liquid resin creates a higher hydrostatic pressure at the interface, as a deeper level of liquid resin exerts more weight on the interface material layer. The higher pressure exerts a downward force on the interface material layer which counteracts the upward force exerted by the build plate 4804 as it moves upward. The deeper level of liquid resin also allows for a consistent supply of resin to the growing printed part.

When using a liquid print interface such as a fluoro oil or other mobile interface material, the build plate can push into the liquid interface without damaging it. The interface will return to its original location and configuration after the build plate 4804 has lifted out of the interface as long as the distance past the interface is less than the thickness of the liquid interface. With solid or membrane print interfaces, pushing the build plate 4804 below the print interface will damage the print interface. For liquid interfaces, the build plate does not need to be flat relative to the interface. Parts can be printed using a build plate 4804 with a 3D surface.

In some embodiments, the build plate 4804 can have another object on it that the printed part is printed onto that form a single object after printing. In other embodiments, the contour of the build plate 4804 is to replace all or part of the printed support structure.

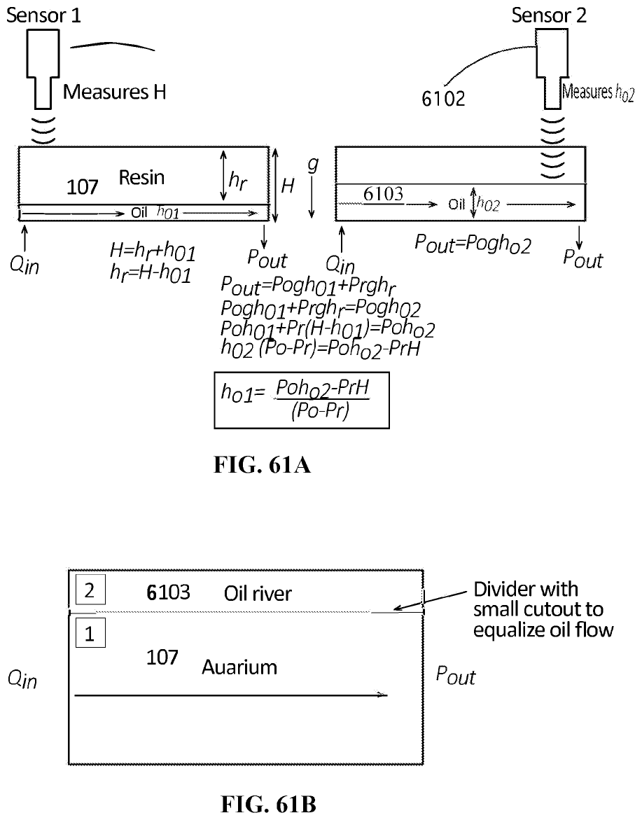

FIG. 65 is an illustration of fluid flow in a liquid vat 107 using a build plate 4804 with perforations. The illustration depicts a 3D printing process as described herein in FIG. 1 and other figures with a flowing interface material layer 1506, a liquid vat 107 with liquid resin, a build plate 4804 supporting a printed part 1502, and a light engine 1503 providing light/energy to cure the resin in desired locations. The arrows in the illustration depict a model flow of the interface material 1506 and the liquid resin in the liquid vat 107. The liquid resin is depicted by the arrows as flowing downward through perforations in the build plate 4804 and under the printed part 1502. Without the perforations in the build plate 4804, the liquid resin would follow a longer path with increased turbulence and swirling effects.

The chevron pattern illustrated in FIG. 64 has varying amount of surface area and perforation area across the entire build plate 4804. For example, the solid framework 6403 between the rows has a greater amount of surface area of build plate 4804 than the surface area of the sections encompassing the chevron perforations 6402. This inconsistency may alter the outcome of a printed part depending on the section of the build plate to which the printed part was attached. To mitigate the inconsistency of the build plate 4804 surface area, a more consistent linear pattern may be utilized as depicted in FIG. 30. The linear pattern does have sections of solid framework 2803 interrupting the perforations 6402.

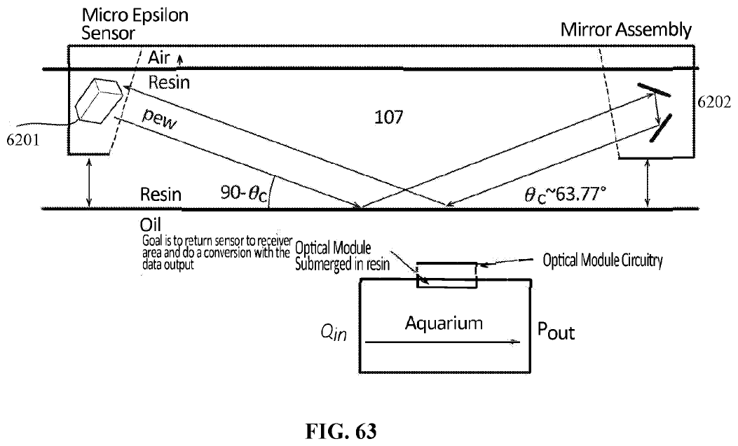

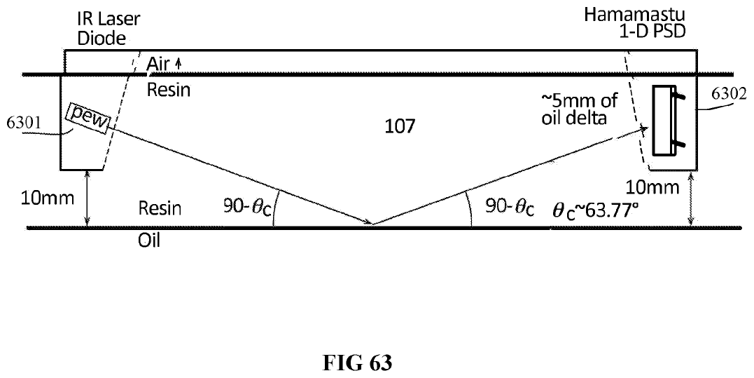

FIG. 66 is a is a picture of a build plate 4804 with perforations 6402. The picture illustrates a build plate 4804 with perforations 6402 in a linear pattern perforated out of the solid plate surface 6401. FIG. 67 is a picture depicting a custom build plate 4804 pattern. The build plate 4804 with perforations 6402 is not limited to constant patterns for general prototyping use. The build plate 4804 with perforations may be used for custom applications or objects being printed. The outline of the initial, first layer of the printed part may be patterned onto the build plate 4804 either exactly or with some variation such that the first layer of the printed part adheres to a similar outline on the build plate 4804. Matching the build plate surface 6401 to the shape of the printed part maximizes the adhesion area of the printed object to the build plate 4804 while minimizing the area of the build plate total surface 6401. The build plate surface 6401 may further be configured to impart a surface finish on the top layer of the printed object. For example, an etching in the surface 6401 may be imparted onto the top layer of the printed part. 2

The custom build plate 4804 patterns provide flat surfaces where the part is affixed to prevent cured resin from affixing inside the perforations 6402. When the first layer of a printed part covers one or more perforations, the resin will cure into the perforation holes. The adhesion between the printed part and the build plate 4804 is improved when resin cures in the perforations 6402, however, this may create difficulties in removing the printed part from the build plate 4804 after printing. The part is not flush with the build plate 4804 and must be peeled out of the perforations 6402 to remove the part. The part may further require sanding or other methods to make the surface flat or smooth. Alternatively, the system may utilize a raft support. A raft support is a printed support layer to make a flat surface for printing the part to avoid the level of sanding needed when the parts cure into the perforations. Customizing the build plate 4804 to have flat sections where the part comes in contact lowers post processing and support needs while having perforations enable better resin flow and lower adhesion forces. Each custom build plate 4804 may require custom manufacturing to match the printed part. The matching of custom build plates 4804 to the printed part allow for faster printing speeds and improves the quality of the printed part.

In an example, the build plate 4804 of FIG. 67 is configured for a 3D printing of face shield bands. The build plate has a general outline of eight face shields to be printed onto a build plate 4804 tailored for the 3D printer. The outline of the build plate surface 6401 matches the outline of the face shield bands, while the rest of the build plate area is filled with perforated slots to reduce the effective area in those regions. In an example, the build plate surface 6401 is manufactured and aligned to provide a submillimeter tolerance between the edges of the build plate surface 6401 and the edges of the printed part affixed to the build plate surface 6401. Any other shape of build plate surface 6401 may be utilized to match to the shape of the printed part.

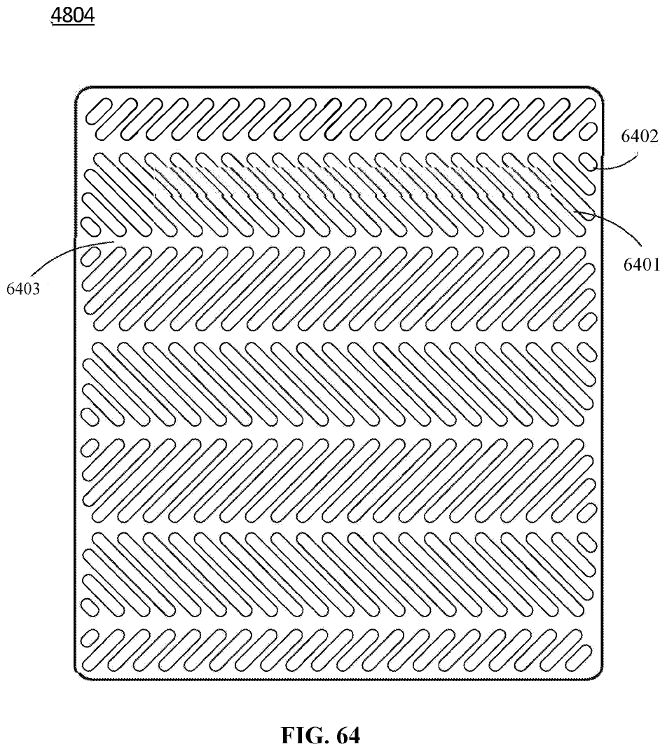

FIG. 68 is an illustration of a build plate design 6801 and a picture of the build plate 4804 associated with the design 6801. A computer-generated image of a build plate design 6801 may be designed for specific 3D printing uses or for a generic application. The design 6801 is illustrated with an example of an intended printed part design. The design 6801 of the spacing, size, orientation, and shape of the perforations 6402 in the build plate 4804 may be balanced according to the needs of the printed part. For example, more or larger perforations 6402 and a lesser amount of build plate surface 6401 will allow more liquid resin to flow through the build plate 4804 but will provide less surface area to which a printing part may adhere. The example design 6801 is for a build plate 4804 designed for use with objects that span a nine-inch circular outline. The printed parts that would utilize this design 6801 may consist of a base layer designed to connect a modular array of customizable features. The design 6801 includes a constant slotted array of perforations 6402.

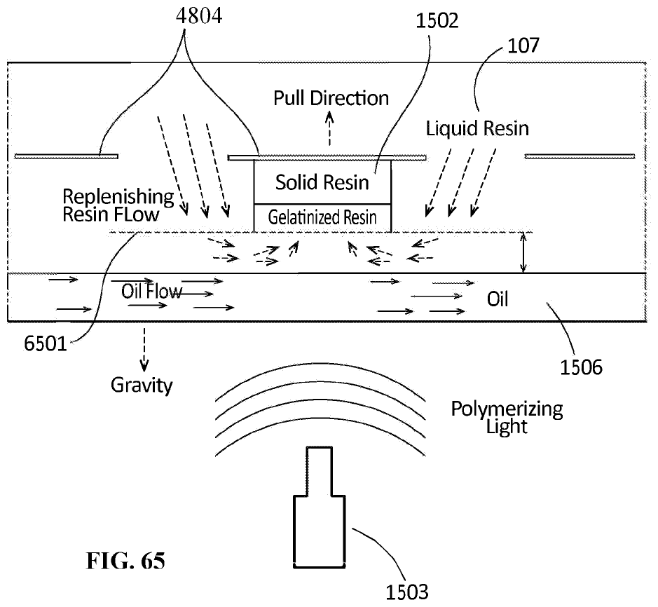

FIG. 69 is an illustration of a build plate design 6802 and a picture of the build plate 4804 associated with the design. This design 6802 is for a build plate 4804 with circular perforations 6402 in the locations of customizable features. The design 6802 is illustrated with an example of an intended printed part design. The circular perforations 6402 and the solid surface 6401 are located based on the customizable features of the printed part. Any suitable design, such as 6801 and 6802, may be designed and manufactured to create the build plate 4804 needed to create a custom printed part based on the flow forces, the shape of the printed part, the adhesion required, the speed of the printing required, or any other suitable variables.

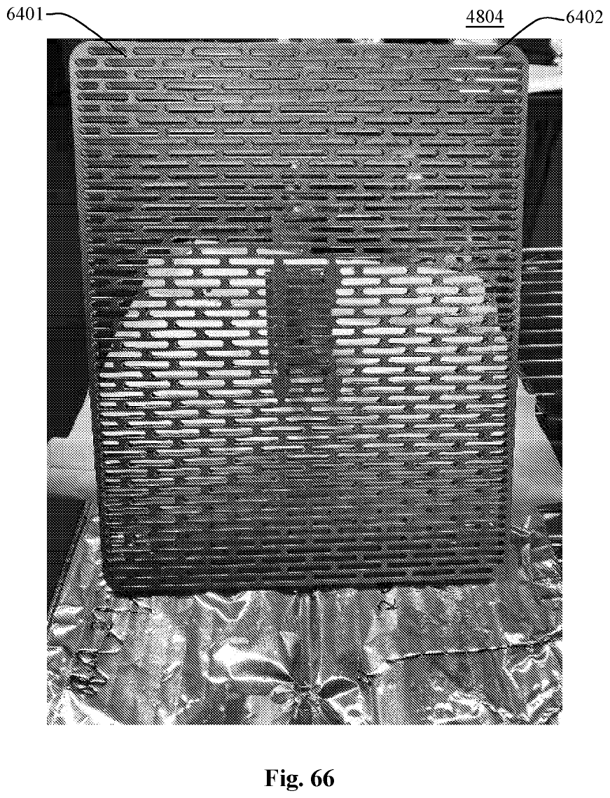

FIG. 70 is a picture of a build plate 4804 with a varying thickness. The build plate 4804 can be customized to have varying thicknesses throughout. Certain applications operate more efficiently with build plates 4804 with thin build plate surfaces 6401 reinforced by thicker bands 7001 to maintain planarity. A thinner plate surface 6401 may be beneficial to provide a higher resin column over it without filling the print vat with more resin. The thinner plate surface 6401 will displace less liquid resin while the addition of the bands 7001 will still provide structural support.

Additionally, columnar legs 7002 are illustrated in FIG. 70. The legs 7002 reduce displacement of liquid resin in the liquid vat because the legs 7002 are thinner and stronger than conventional connections for the build plate 4804. The smaller displacement allows for a more predictable control of the resin flow through the build plate 4804 and the filling of the 3D printer liquid vat.

In alternative examples, other build plates 4804 may be constructed to provide different 3D printing benefits or features. For example, the build plate 4804 may have angled walls on the perforation 6402 to provide a three-dimensional character to the adhesion of the printed part to the build plate 4804. The angled wall may reduce the effective surface area further on the bottom facing side of the build plate 4804 while having a larger area on top, where the larger surface area 6401 will have a lesser effect on the interface and still provide additional structural rigidity of the build plate 4804. Similarly, a modular build 4804 plate can be provided having a second, removable surface in communication with the bottom surface onto which a part is printed. In an embodiment, this surface can take the form of a mesh, a coating, a grate, a stage, or any other similar structure. In an embodiment, this surface is capable of being detached from the part through non-mechanical means, such as dissolving the surface, in order to detach the part from the modular build plate 4804. This would be beneficial for parts having delicate mechanical properties which have a high likelihood of deforming during mechanical separation of the part. In an example, a modular build plate 4804 is capable of making use of multiple different second, removable surfaces.

In another example, a modular build plate 4804 may be provided comprising a counter plate, the counter plate having a face with plugs in alignment with the perforations 6402 of the modular build plate 4804. The counter build plate would be capable of being positioned such that when its plugged face placed on the top surface of the modular build plate 4804, the plugs will fill the perforations 6402 of the build plate 4804. In an example, the plugs are long enough such that they extend through the bottom surface of the modular build plate 4804. In an example, after the printing process is complete, the counter build plate is placed onto the top surface of the modular build plate 4804 such that the plugs extend through the perforations 6402 and the bottom surface of the modular build plate 4804 in order to facilitate mechanically detachment of the printed part from the modular build plate 4804. In an example, the counter build plate is a modular counter build plate capable of altering the positioning, length, and quantity of the plugs to adapt to the structure of the modular build plate 4804.

In another example, a modular build plate 4804 may be provided that can quickly be customized to different applications. Examples of this modular approach include having a “backbone” plate in which perforations 6402 can be plugged and unplugged to create different outlines as desired to adapt to different objects. Similarly, a build plate 4804 may be provided with a grid of actuating elements that can conform to different shapes. The actuating elements could automatically adapt the bottom surface of the build plate 4804 to the outline of the part being printed. The actuating elements may include sliding surfaces, hinged surfaces, clip in surfaces, retractable surfaces, or any other type of surface that can be modified to change the shape of the build plate 4804.

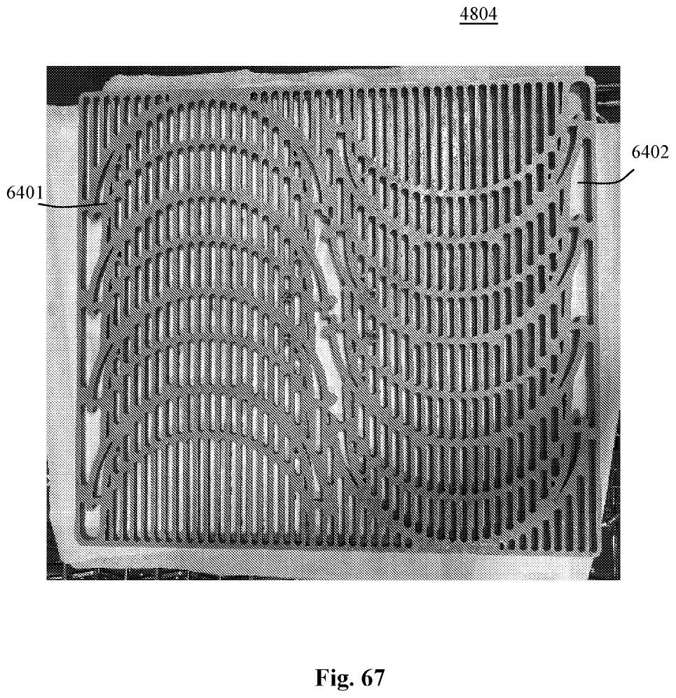

FIG. 71 is an illustration of a perspective view of a mounting system 7100 for a build plate 4804. In typical usage, the build plate 4804 is repeatedly taken out of the 3D printer after each part is printed and needs to be quickly and easily placed back with a high degree of precision. The Z-arm 4801, as described herein, has an adjustable carriage 4803 that moves the build plate 4804 vertically as a part is printed. The mounting system 7100 for the build plate 4804 has a large handle 7102 that enables a technician to easily manipulate the build plate 4804. The handle 7102 is affixed to the build plate 4804 to allow the build plate 4804 to be mounted to the carriage 4803. The handle 7102 has a dove tail connection 7103 that is held in place using spring plungers. The dove tail connection 7103 may have grooves and projections on opposing portions of the handle 7102 and the carriage 4803. The grooves and projections or other dove tail mating structures may mate to allow the handle 7102 to slide securely into a slot on the carriage 4803 for mounting. The spring plungers are engaged when the handle 7102 is installed to align and affix the handle 71027102 to the carriage 4803. The spring plungers are stiff enough to hold the build plate 4804 in place during printing but still allow a technician to remove the build plate 4804 without the need to actuate a lock, a clamp, a toggle, or other mechanism. The dove tail connection 7103 positions the build plate 4804 because the angles on the grooves and the spring plungers of the dove tail connection 7103 align the build plate 4804 in a consistent position relative to the carriage and thus the liquid vat.

Multiple build plates 4804 as described herein may be utilized with a single Z-arm 4801 in a single resin vat 107. The mounting system is capable of affixing multiple build plates 4804 to a single carriage. In another example, the mounting system for the build plates 4804 includes multiple Z-arms, each Z-arm 4801 coupled to one of the multiple build plates 4804.

In an example, each build plate 4804 is independently removable from the Z-arm 4801. In an example, each build plate includes a handle 7102 that is couplable to a Z-arm of the mounting system. In an example, the handles 7102 couple to the mounting system 7100 via a dovetail connection as described herein. In an example, the handles couple to the mounting system 7100 via a kinematic coupling as described herein.

When each of the multiple build plates 4804 is lowered to the resin vat 107 as described herein, a part may be formed on each build plat 4804 such that multiple parts are printed concurrently.

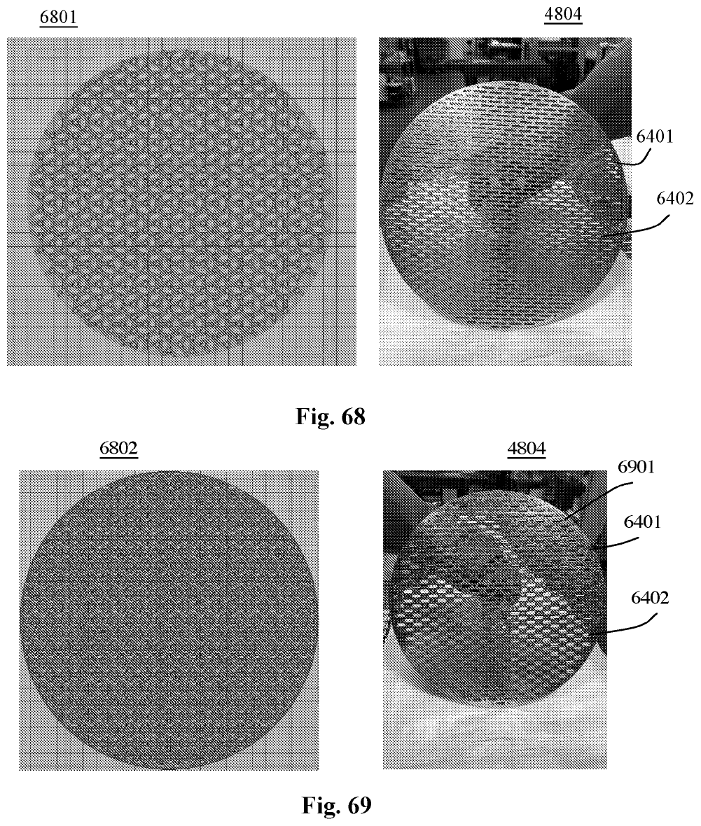

FIG. 72 is an illustration of a front view of a mounting system 7100 for a build plate 4804. As described, the handle 7102 has a dove tail connection 7103 that mounts into the carriage 4803. The build plate 4804 is affixed to the handle and suspended from the carriage 4803 for positioning in the liquid vat.

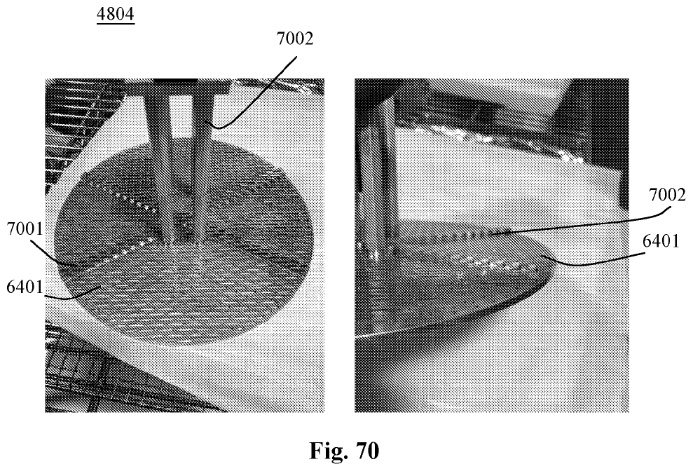

FIG. 73 is an illustration of a side view of a mounting system 7100 for a build plate 4804. As described, the handle 7102 mounts to the carriage 4803. The build plate 4804 is affixed to the handle and suspended from the carriage 4803 for positioning in the liquid vat.

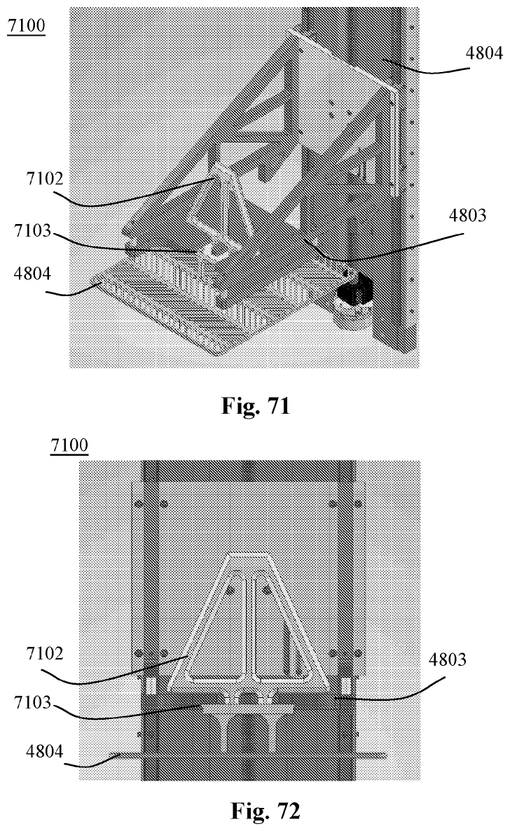

FIG. 74A is an illustration of a kinematic coupling mechanism 7400. The kinematic coupling mechanism 7400A may be used to precisely locate the build plate 4804 relative to the carriage. The kinematic coupling mechanism 7400A is a fixture that using spheres and grooves to precisely align two plates together. Due to the interaction of the spheres and the groove, the kinematic coupling mechanism 7400A provides a consistent alignment. The kinematic coupling mechanism 7400A may also include tilt adjustments to adjust the angle of the build plate 4804. The details of the kinematic coupling mechanism 3800 are shown in greater detail in FIG. 74B.

FIG. 74B is an illustration of a sphere and groove assembly 7400B of a kinematic coupling mechanism 7400B. As illustrated, the sphere and groove assembly 7400B of a kinematic coupling mechanism 7400B includes spheres 7501 that align in grooves 7402 based on a force of gravity to align the assembly 7400B to a carriage 4803. The build plate 4804 dangles from the assembly 7400B in a substantially horizontal plane unless intentionally tilted to a desired angle.

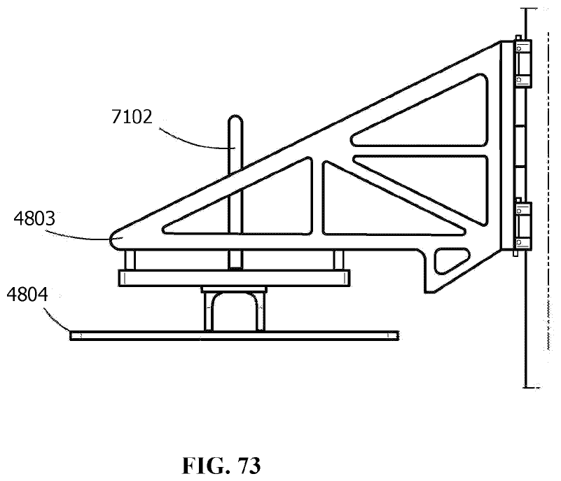

FIG. 75 is an illustration of a removable insert 7501 in a resin vat 107. The insert 107 may be coupled to the interior walls of the resin vat or in any other suitable fashion. The insert 107 may further comprise a plurality of independent wells. Said independent wells, in total, may comprise a smaller volume that the resin vat allowing for the concurrent manufacture of multiple articles using a smaller volume of resin. Additionally, each independent well of the resin vat insert can, be filled with a different resin formulation. This allows for the concurrent manufacture of multiple different articles using the printing process. In an example, multiple removably couplable build plates are utilizing during a printing process, each removably couplable build plate in coordination with one of the plurality of independent wells of the resin vat insert. The insert 107 can be placed into the resin vat 107 and allow for reduced overall resin usage.

The insert 7501 creates a smaller insert vat 7502 within the resin vat 107. The resin may be stored in the insert vat 7502 and not in the remainder of the resin vat 107 such that a lesser volume of resin is used. The build plate 4804 may be a smaller build plate that only requires a smaller cross-sectional area of resin to create a part. In an example, the removably couplable insert 7501 includes a plurality of independent insert vats 7502, as shown in the two circular insert vats 7502 in FIG. 75. In this example, a plurality of build plates 4804 may be used to generate two or more parts at a time on the build plates 4804.

The insert 7501 may have dividing walls to create multiple wells inside of the resin vat 107. The dividing walls may define one or more a cylindrical insert vats 7502 that contain the resin. In alternate examples, the dividing walls may define one or more insert vats 7502 that are rectangular, square, triangular, or any other suitable shape. The insert vats 7502 may have a custom shape that matches a shape of the build plate 4804.

The insert vats 7502 can be filled with different resin formulations during a single printing process allowing for the concurrent printing of different articles. The insert 7501 may be constructed of any suitable material, such as a metal, plastic, or fiberglass. Each insert 7501 may include connections or channels to support any or all of the components described herein, such as valves and inlets to allow resin to flow through each of the insert vats 7502. The insert vats 7502 may be removable to allow for different shapes or sizes of insert vats 7502 to be inserted into the resin vat 107. The insert vats 7501 may be paired with build plates of similar sizes and shapes.

In examples of the technology, a flow manifold to create laminar interface material flows in a 3D printer is described. The flow manifold includes an inlet through which interface material flows into a liquid vat; an outlet through which the interface material flows from the liquid vat, the inlet and outlet positioned below an operational level of liquid resin in the liquid vat; a flow divider that distributes the interface material from the inlet across an entrance to the liquid vat, the flow divider comprising flow splitting channels that provide the interface material from the inlet at a consistent pressure and consistent flow velocity across a width of the entrance; and a flow straightener comprising fins that straighten the interface material flow and that remove turbulence in the interface material flow.

In the flow manifold, the interface material flowing out of the flow straighteners forms a layer of interface material on a bottom of the liquid vat and below the resin floating in the liquid vat above the interface material. In the flow manifold, the interface material is piped vertically to the inlet. In the flow manifold, the interface material exits the flow divider vertically or at an angle. In the flow manifold, the interface material flowing vertically out of the flow divider is directed horizontally to the flow straightener.

The flow manifold includes an outlet comprising an exit flow manifold that receives the interface material as at an opposing end of the liquid vat and directs the flow to a cooling system. The flow manifold includes an inlet valve coupled to the inlet and controlling flow to the inlet.

In the flow manifold, at least a portion of the resin in the liquid vat is cured to form 3D printed parts.

In examples of the technology, a flow manifold to create a laminar interface material flow in a liquid vat is described.

A method for a flow manifold to create a laminar interface material flow in a liquid vat is described.

In examples of the technology, an interface material processing apparatus for a 3D printer is described. The apparatus includes an inlet through which interface material flows into the apparatus; a pump that pumps interface material through the inlet into the apparatus; a filter through which the interface material flows, the filter filtering contaminants from the interface material; a heat exchanger through which the interface material flows, the heat exchanger removing at least a portion of heat retained by the interface material from contact with a liquid vat in a 3D printer; and an outlet through which the interface material flows to return the interface material to the liquid vat of the 3D printer.

The interface material processing apparatus includes a housing, the housing being a separate from the liquid vat of the 3D printer. The interface material processing apparatus includes a material separator coupled to the interface material processing apparatus to remove contaminants from the pumped interface material.

In the interface material processing apparatus, the heat exchanger is a plate heat exchanger. In the interface material processing apparatus, the pump is positive displacement pump. In the interface material processing apparatus, the inlet includes quick disconnect connectors that connect the interface material processing apparatus to tubes that carry the interface material from the 3D printer. In the interface material processing apparatus, the outlet includes quick disconnect connectors that connect the interface material processing apparatus to tubes that carry the interface material to the 3D printer.

The interface material processing apparatus includes inlet control valves that control inlet interface material flow from two or more liquid vats of two or more 3D printers. The interface material processing apparatus includes outlet control valves that control outlet interface material flow to two or more liquid vats of two or more 3D printers

In examples of the technology, a support structure affixed to a liquid vat of a 3D printer is described. The structure includes a liquid vat comprising resin that is cured to form a 3D printed part; a build plate that is submerged in the resin to form a structure on which the cured resin is initially affixed; a carriage that raises the build plate as the part is printed; and an upward support structure that supports the carriage, the upward support structure being connected to the liquid vat such that an adjustment to an alignment of the liquid vat simultaneously adjusts an alignment of the upward support structure.

In the support structure, the upward support structure is affixed to the liquid vat via alignment pins. In the support structure, the alignment pins are configured to affix the upward support structure in relation to the liquid vat. In the support structure, the carriage is raisable and lowerable on the upward support structure via a mechanical drive. In the support structure, multiple build plates are removably attached to the carriage. In the support structure, multiple carriages are supported by the upward support structure.

In the support structure, each of multiple build plates are removably attached to one of a set of multiple carriages attached to the upward support structure. In the support structure, each of the multiple build plates comprises a handle coupled to the build plate, and a mounting system configured to mount the build plate to the carriage via a dove tail connection of the handle to the plate. In the support structure, the handle utilizes a kinematic coupling mechanism to affix the build plate to the carriage.

In examples of the technology, a temperature control system for a liquid vat of a 3D printer is described. The controls system includes a liquid vat comprising resin that is cured to form a 3D printed part, the liquid vat having four side walls; an exit flow manifold on a first sidewall, that receives a flow of interface material that forms a layer on a bottom of the liquid vat and that creates an interface with a resin that floats above the interface material; a first array of temperature sensors disposed on the first sidewall, a second sidewall adjacent to the first sidewall, and a third sidewall opposite to the first sidewall; a liquid vat temperature sensor measuring a temperature of interface material flowing into the liquid vat; a second array of temperature sensors that measure the temperature of the interface material flowing through the exit flow manifold; and a controller that varies a flow rate of the interface material based an output of the temperature sensors.

In the temperature control system, the controller includes a 3D printer computer control system. In the temperature control system, the temperature sensors provide an output to a flow computer that controls the speed of a volumetric pump that pumps the interface material to the liquid vat. In the temperature control system, the temperature sensors outputs are used to create a temperature profile of the liquid vat by monitoring the temperature of the interface material in the liquid vat at each point in the first array and the second array and applying the monitored temperatures to a model of the liquid vat. The temperature control system includes a temperature sensor located at the inlet.

In examples of the technology, a level control system for a liquid vat of a 3D printer is described. The control system includes a liquid vat comprising liquid resin that is cured to form a 3D printed part, the resin disposed on an interface material in the liquid vat comprising four side walls and a bottom surface comprising a window into the liquid vat; a first level sensor disposed under the window, the first level sensor directing a signal to the liquid resin in the liquid vat by directing the signal through the window and through the interface material under the liquid resin in the liquid vat to a bottom surface of the resin; a second level sensor disposed above the liquid vat, the second level sensor directing a signal to the liquid resin in the liquid vat by directing the signal downward to a top surface of the liquid vat.

In the level control system, a controller determines a level of the bottom surface of the liquid resin in the liquid vat based on a returning signal detected by the first level sensor. In the level control system, a controller determines a level of the top surface of the resin in the liquid vat based on a returning signal detected by the second level sensor. In the level control system, the system determines an amount of resin in the liquid vat by subtracting a level of and the bottom surface of the resin in the liquid vat based on a returning signal detected by the first level sensor from a level of the top surface of the resin in the liquid vat based on a returning signal detected by the second level sensor.

In the level control system, the level control system controls a speed of a volumetric pump that pumps the interface material to the liquid vat based on the level of the bottom surface of the liquid resin. In the level control system, the temperature sensors provide an output to a flow computer that controls a position of a build plate of the 3D printer relative to a determined height of the interface material.

In examples of the technology, a level control system for a liquid vat is described. The level control system includes a liquid vat comprising liquid resin that is cured to form a 3D printed part, the resin disposed on an interface material in the liquid vat comprising four side walls and a bottom surface comprising a window into the liquid vat; a level sensor transmitter submerged in liquid resin in the liquid vat, the level sensor directing a signal through the liquid resin that bounces off an interface between an interface material layer under a resin layer in the liquid vat; and a level sensor receiver that receives the bounced signal and uses the received signal to determine a depth of the interface.

In the level control system, the level sensor transmitter and the level sensor receiver are a single device. In the level control system, the signal is directed back to the level sensor receiver by at least one mirror. In the level control system, the level sensor transmitter and the level sensor receiver are separate devices. In the level control system, a controller determining an amount of resin in the liquid vat by interpreting the received signal to the level sensor receiver.

In the technology, a build plate for printed parts in a 3D printer is described. The build plate includes a plate comprising a plurality of perforations and configured for use with a liquid vat of a 3D printer, the plate being configured such that continuous, non-perforated sections of a surface of the plate are shaped to match a shape of a 3D-printed part.

In the build plate, the perforations sized to allow liquid resin in the liquid vat to flow through the perforations as the build plate is raised during 3D printing. In the build plate, continuous sections of the plate surface that are shaped to match a shape of a 3D-printed part have a non-flat surface. In the build plate, the plate comprising thin sections and support bands, the first sections comprising a thinner profile than the support bands. In the build plate, the perforations being shaped in three dimensions based on a shape of the 3D printed part. In the build plate, the perforations being configured such that when liquid resin in the liquid vat flows through the perforations as the plate is raised during 3D printing, the flowing liquid resin does not disturb an interface between the liquid resin and an interface material flowing below the liquid resin.

The build plate includes a handle coupled to the plate; and a mounting system configured to mount the plate to a carriage of a 3D printer affixed to the liquid vat, the mounting system comprising a dove tail connection to the handle coupled to the plate. In the build plate, the mounting system utilizing a kinematic coupling mechanism to affix the build plate to the carriage. In the build plate, the carriage being configured to raise the build plate as the 3D printed part is printed and comprising an upward support structure that supports the carriage, the upward support structure being connected to the liquid vat.

The technology includes a method to use build plate in a 3D printer. The method includes providing a liquid vat comprising resin that is cured to form a 3D printed part; providing a plate comprising an array of perforations sized to allow liquid resin in the liquid vat to flow through the perforations; submerging the plate in the resin to provide a structure on which the cured resin is initially affixed; and raising the plate with the cured resin affixed to the plate, the liquid resin flowing through the perforations as the build plate is raised.

In the method, the perforations configured such that remaining build plate surface around the perforations is shaped to match a shape of a 3D-printed part. In the method, the plate comprising thin sections and support bands, the first sections comprising a thinner profile than the support bands. In the method, the perforations shaped in three dimensions based on a shape of the 3D printed part. In the method, the perforations configured such that when liquid resin in the liquid vat flows through the perforations as the plate is raised during 3D printing, the flowing liquid resin does not disturb an interface between the liquid resin and an interface material flowing below the liquid resin.

In the method, the plate further comprising a handle coupled to the plate and a mounting system configured to mount the plate to a carriage of a 3D printer affixed to the liquid vat, the mounting system comprising a dove tail connection to the handle coupled to the plate. In the method, the mounting system utilizing a kinematic coupling mechanism to affix the build plate to the carriage. In the method, the carriage being configured to raise the build plate as the 3D printed part is printed and comprising an upward support structure that supports the carriage, the upward support structure being connected to the liquid vat.

In examples of the technology a removable insertable vat for printed parts in a 3D printer is described. The removable insertable vat includes a resin vat insert removably coupled to a liquid vat of a 3D printer, wherein the resin vat insert contains a smaller volume of resin than the liquid vat.

In the removable insertable vat, the resin vat insert comprises a plurality of resin vats that are insertable into the resin vat. In the removable insertable vat, the plurality of resin vats cumulatively contain a smaller volume of the resin than the liquid vat. In the removable insertable vat, each the plurality of resin vats may contain a different resin than another of the plurality of resin vats. In the removable insertable vat, each of the plurality of resin vats are sized and shaped to match a size and a shape of a build plate of the 3D printer on which parts are formed. In the removable insertable vat, each the plurality of resin vats is used by each corresponding build plate to construct a different 3D printed part.

### Sensor Feedback Systems

In another aspect, sensor feedback embodiments described herein operates within a 3D printer environment to provide feedback loops in 3D printing to control 1) the temperature of a 3D printed part and surrounding environment, 2) the forces applied to the 3D printed part, 3) the amount and rate of UV light that is applied to the 3D printed part, and 4) a supply of resin to the active print area.

The interface material can comprise a flowing fluid. Examples of flowing fluids include an aqueous liquid, an organic liquid, a silicone liquid, and a fluoro liquid. The terms interface material, PFPE, PFPE oil, fluoro oil, or oil, may be used throughout the specification to represent any suitable interface material used in the liquid resin/interface material system.

Alternatively, aqueous liquids used as the interface material can include, but are not limited to, water, deuterium oxide, densified salt solutions, densified sugar solutions, and combinations thereof. Example salts and their solubility limit in water at approximately room temperature include NaCl 35.9 g/100 ml, NaBr 90.5 g/100 ml, KBr 67.8 g/100 ml, MgBr2 102 g/100 ml, MgCl2 54.3 g/100 ml, sodium acetate 46.4 g/100 ml, sodium nitrate 91.2 g/100 ml, CaBr2 143 g/100 ml, CaCl2 74.5 g/100 ml, Na2CO3 21.5 g/100 ml, NH4Br 78.3 g/100 ml, LiBr 166.7 g/100 ml, KI 34.0 g/100 ml, and NaOH 109 g/100 ml. Thus, for example, a 100 ml solution of 35.9 g NaCl has a density of 1204 kg/m3.

Example sugars used as the interface material and their solubility limit in water at approximately room temperature include sucrose 200 g/ml, maltose 108 g/100 ml, and glucose 90 g/100 ml. Thus, for example, a 60% sucrose water solution has a density of 1290 kg/m3 at room temperature. Silicone liquids can include, but are not limited to silicone oils. Silicone oils are liquid polymerized siloxanes with organic side chains. Examples of silicone oil include polydimethylsiloxane (“PDMS”), simethicone, and cyclosiloxanes. Fluoro liquids can include, but are not limited to, fluorinated oils. Fluorinated oils generally include liquid perfluorinated organic compounds.

Examples of fluorinated oils used as the interface material include perfluoron-alkanes, perfluoropolyethers, perfluoralkylethers, co-polymers of substantially fluorinated molecules, and combinations of the foregoing. Organic liquids can include, but are not limited to, organic oils, organic solvents, including but not limited to chlorinated solvents (e.g., dichloromethane, dichloroethane and chloroform), and organic liquids immiscible with aqueous systems. Organic oils include neutral, nonpolar organic compounds that are viscous liquids at ambient temperatures and are both hydrophobic and lipophilic. Examples of organic oils include, but are not limited to higher density hydrocarbon liquids. In embodiments, the interface material comprises a silicone liquid, a fluoro liquid, or a combination thereof.

FIG. 15 is an illustration of a liquid vat 107 of a 3D printer 100 and the interface material flow path. The liquid vat stores a vat 107 of polymerizable ink 1501. The resin 1501 cures into a solid part 1502 upon exposure to the light from the light engine 1503. In the illustrated system, the active cooling of the liquid resin and the cured resin part is achieved by creating a laminar flow of interface material in a mobile phase 1506 beneath and interface with the liquid resin 1501. The interface material is pumped through the liquid vat 107 in the 3D printer. In certain conventional 3D printers, when a layer of cured resin 1502 is formed at the bottom of the liquid vat 107 on the surface of the window, the cured resin 1502 will adhere to the build plate, previously cured layers, and the window 108 at the bottom of the liquid vat 107. The 3D printers may pump the interface material through the bottom of the liquid vat 107 under an interface with the liquid resin 1501. The thin layer of interface material under an interface with the resin provides a continuous layer 1506 for dewetting the cured resin 102. The interface material in the mobile phase 1506 is pumped through the liquid vat 107 continuously or periodically to allow the part to be raised without adhering to the window, to allow the interface material and the liquid resin to be cooled, and to have contaminants removed.

Various independent variables affect the performance of the 3D printing of the part. The variables may affect 1) the temperature of the printed part and surrounding environment, 2) the forces applied to the printed part, 3) the amount and rate of UV light that is applied to the part, and 4) the supply of resin to the active print area. For example, a temperature of the printed part is directly affected by how fast the part is printed, which in turn affects the rate UV light is delivered to the part. Efforts to control the temperature of the printed part through increased oil flow and printing speed adjustments increase the forces applied to the part. Increasing the printing speed may deplete the liquid resin in the liquid vat because the system may polymerize the resin faster than the liquid resin can be replaced. In certain example printing applications, acceptable temperature, forces, amount of polymerizing light, and resin supply may be dependent on the specific material and geometry being printed.

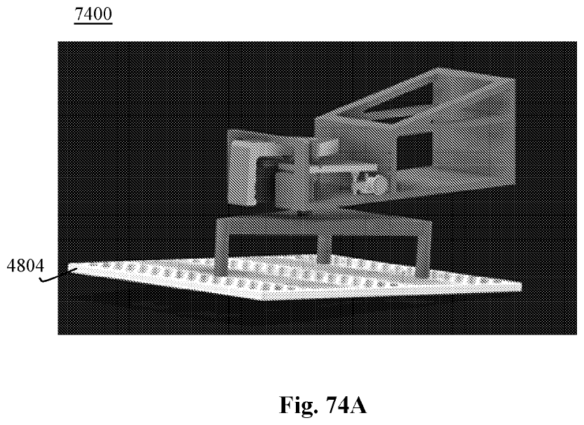

FIG. 76 is a block flow diagram illustrating a feedback loop for a 3D printer. As illustrated, a reference block 7601 includes the materials used to create the printed part, such as liquid resin, interface material, and the mechanical devices. Block 7601 includes a geometry of the printed part, the shape and size of the liquid vat, the build plate, the flow manifolds, and any other geometry that affects the printing process. Block 7601 includes a modelling of the process, such as a computer model of the printing system based on flow rates, liquid levels, temperatures, and other input data.

The controller block 7602 includes software or hardware on an interconnected computer network or device. The computer device or network may be operating on the 3D printer, a connected network device, or any other suitable computing device, such as on a cloud computing service. The software may manage the operations of the 3D printing process, create models of the system, manage data transfers incoming and outgoing, or perform any other suitable tasks. The software may receive inputs of data from the sensors, such as flow, level, tilt, humidity, and temperature sensors, and use the inputs to manage the operations of the 3D printing process.

The feedback block 7603 includes process parameters that may be determined from the sensor data. The parameters may include flow rates, liquid levels, temperatures, and other input data. The data may be obtained from the sensors and transmitted back to the controller block 7602 for processing. The data changes based on the operations of the 3D printer as directed by the controller block 7602.

The output block 7604 includes the actual conditions created based on instructions from the controller 7602 to the process instruments, modules, valves, pumps, and other components that create the fluid flows, part printing, and other processes. The process components controlled by the output 7604 cause the system to operate with specific, configured characteristics based on the optimization of the process by the controller 7602 and based on the feedback 7603.

While each process can be implemented independently, the complex interrelationship of the 3D printing process is managed in parallel. The interrelated processes become a Multi Input Multi Output (“MIMO”) system when operated together. MIMO systems are complicated because often the variables have unexpected, nonobvious, and nuanced interactions. Multiple methods or approaches have been developed for controlling a MIMO system, such as statistical approaches (Monte Carlo, Machine Learning, and AI), deterministic approaches (Finite Element, Implicit and Explicit Solvers), Linear Optimizers (Genetic algorithms, the simplex algorithm, and Simulated annealing), and Nonlinear optimizers (Quadratic Programming), and Design of Experiments.

### Gelation Height Control

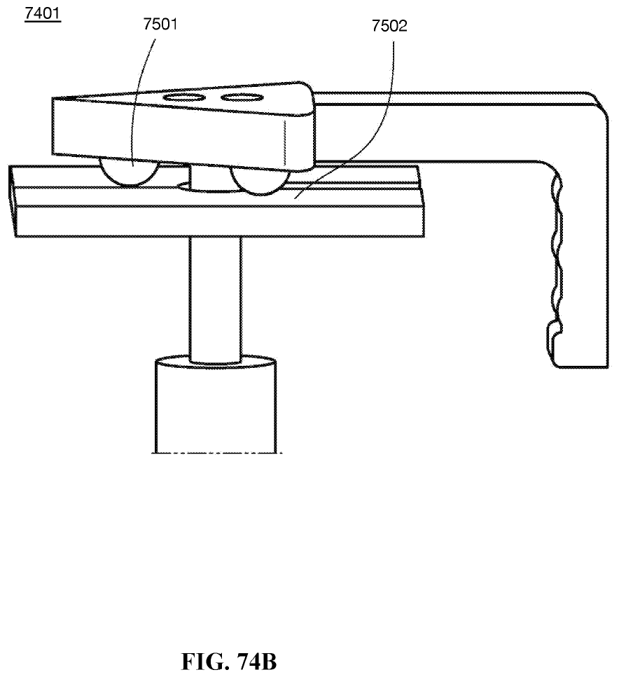

FIG. 77 is an illustration of fluid flow in a liquid vat 107 using a build plate 4804. The illustration depicts a 3D printing process as described herein in FIG. 1 and other figures with a flowing interface material layer 1506, a liquid vat 107 with liquid resin, a build plate 4804 supporting a printed part 1502, a gelatinized resin layer 7705, and a light engine 1503 providing light/energy to cure the resin in desired locations. The arrows in the illustration depict a model flow of the interface material 1506 and the liquid resin in the liquid vat 107. The liquid resin is depicted by the arrows as flowing downward through perforations in the build plate 4804 and under the printed part 1502. Without the perforations in the build plate 4804, the liquid resin would follow a longer path with increased turbulence and swirling effects.

During the printing process liquid resin does not instantly turn into the desired solid part when exposed to UV light. The UV light must deliver a required amount of light/energy to the liquid resin. The required amount of light/energy may be referred to as the critical dosage (E_{c}). As the build plate 4804 is being lifted out of the liquid vat 107, the liquid resin receiving the UV light will, at a certain height between the interface with the fluorinated oil and the solid printed part 1502, transition from the liquid resin to a gelatinized state to the solid part 1502. The gelatinized resin in the transition from liquid to solid is constantly replaced by the surrounding liquid resin to make a continuous 3D printing process. The part 1502 is drawn upwards at a speed not faster than the liquid is cured into the solid part 1502. As the part 1502 is drawn upwards additional liquid flows to the bottom of the gelatinized resin layer 7705. The newly arriving liquid resin receives the UV light and forms a new gelatinized resin layer 7705.

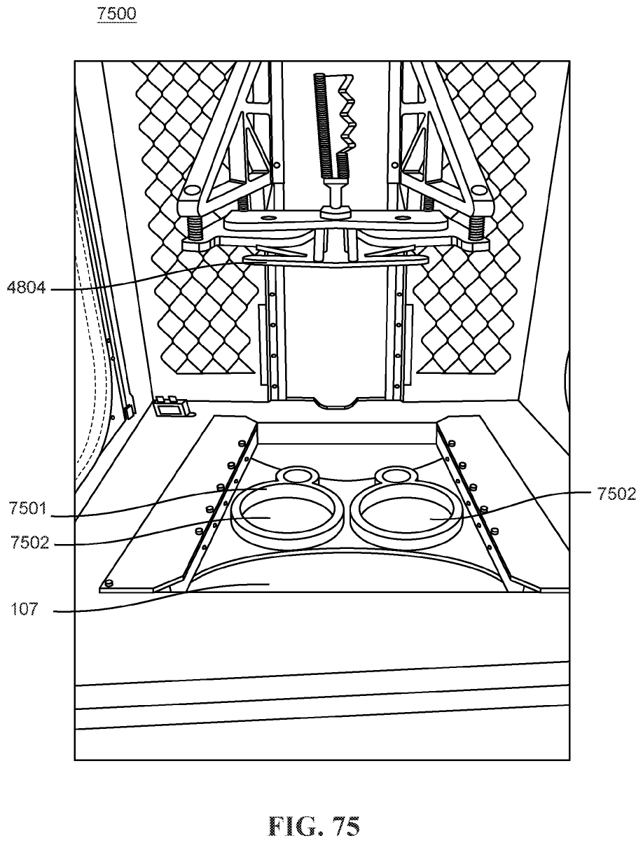

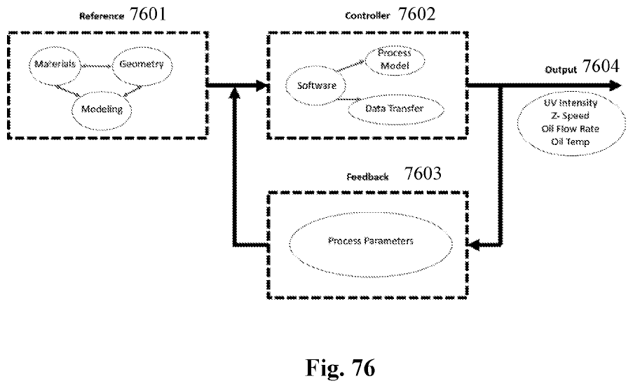

FIG. 78 is an illustration of fluid flow in a liquid vat 107 with a resin void 7801.

The density and height of the liquid resin in the liquid vat 107 above the gelation zone will not change significantly during a printing operation if the liquid resin is replenished continuously, so the reflow pressure may remain constant. Back pressure can be adjusted by using a different size or style of build plate or making other suitable adjustments. In an example, a printing process may reduce the viscosity of the liquid resin or a width of a part 1502 as much as possible, but limits exist beyond which the parameters may not be reduced or should not be reduced if an integrity of a part is to be maintained.

In certain system conditions, the liquid resin is unable to completely replace the gelatinized resin that is lifted away from the UV light by the build plate 4804. This condition typically occurs when printing speeds are faster than the liquid resin can flow or for parts 102 that utilize more resin, such as a larger or wider part 1502. The inability of liquid resin to fill the void 7801 occurs because the primary force of pressure that causes resin to flow into the area is created due to gravity and surface tension. Gravity and surface tension are proportional to the equations:

Reflow Pressure∝pgh & 2γ cos θ

In the equation, ρ is the density of the resin, g is gravitational acceleration, h is the total height of the resin above the gelation zone, γ is the surface tension of the resin, and θ is the contact angle between the resin and the interface material.

The reflow pressure may not be sufficient to overcome pressure that resists the reflowing of resin, such as back pressure. The back pressure is proportional to the equation:

$$Back pressure ∝ \frac{μ L}{{h}_{gelation}^{2}}$$

In the equation, u is the resin viscosity, L is distance that the resin needs to flow in this case the width of the part, and h_{gelation} is the gelation height.

In the illustration, the gelatinized resin 7705 is being raised by the build plate 4804. The liquid resin in replenishing the space beneath the gelatinized resin 7705 as indicated by the flow arrows. The gelation height 7802 is the distance between the oil flow zone 1506 and the gelatinized resin 7705. The force of gravity and surface tension are not sufficient to overcome the back pressure, and the liquid resin does not completely fill the space under the gelatinized resin 7705. In this circumstance, a resin void 7801 is created. The resin void 7801 may be a region in which liquid resin does not cure into a solid part 1502 or may not even reach the void leaving an air space or bubble. The resin void 7801 may result in a part 1502 that has a hole or void space instead of a solid surface.

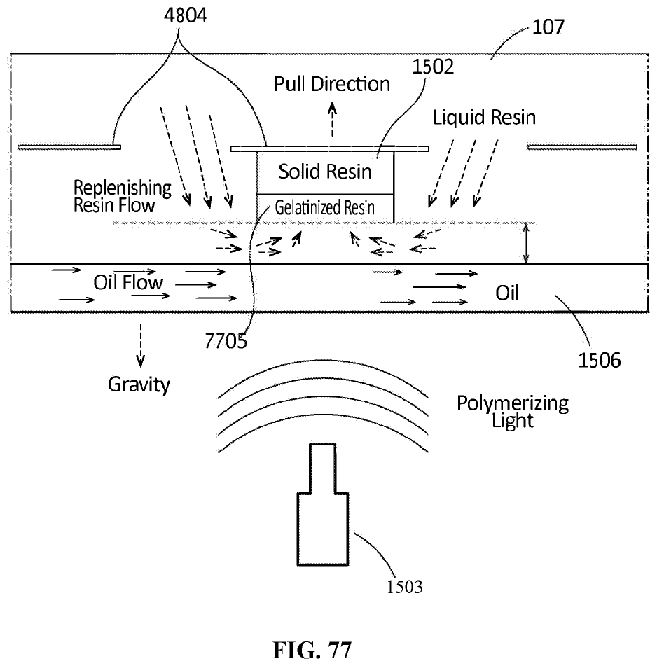

FIG. 80 is an illustration of fluid flow in a liquid vat 107 with variable UV light intensity. An example solution to overcome resin voids 7801 in the printed part 1502 includes varying the amount of UV light that is delivered to the liquid resin. The UV light is selectively modulated to adjust the typical gelation height 7802 to create a variable gelation height 7901. When less intense UV light is delivered to the resin, the variable gelation height 7901 increases and when more intense UV light is delivered to the resin, the variable gelation height 7901 decreases. As illustrated in FIG. 80, less intense UV light is delivered by the light engine 1503 on the left side of the gelatinized resin 7705 and more intense UV light is delivered on the right side of the gelatinized resin 7705. The resulting gelatinized resin 7705 has a higher gelation height 7901 on the left side and a lower gelation height 7802 on the right side. The varying height of the gelation resin 7705 allows for resin to flow more readily to replace gelatinized resin 7705. As indicated by the arrows illustrating a flow of liquid resin in the liquid vat 107, the liquid resin on the left side of the part 1502, has more room to flow and less back pressure is created. As provided in the back pressure equation, the greater the gelation height 7802, the lower the back pressure will be. Lower back pressure causes the liquid resin to flow more freely. When the liquid resin flows more freely, a resin void 7801 is less likely to form.

The control of the variable gelation height 7901 is achieved through a combination of gray scaling on the UV projector of the light engine 1503. To create the gray scaling effect, the UV intensity of a single pixel of the light engine 1503 is individually controlled based on specific details of the optical properties of the resin. Each light engine 1503 is individually calibrated on a pixel level to vary the light intensity across the area of the gelation resin zone 7705. In an example, each single pixel is turned on and off in a configured frequency and duration based on the amount of light intensity desired. For example, a pixel may blink with short periods where the pixel is off to create greater intensity. Longer periods in which the pixel is off will create a lower intensity. The pixels may work in concert with one another. For example, a group of pixels may reduce the intensity from certain pixels while not reducing the intensity from other pixels to create an overall intensity for a region of light. Any configured pixel blinking pattern may be employed to achieve a preferred light intensity.

When UV light contacts the resin, some of the light is absorbed but some of the light will penetrate deeper. This light penetration is represented in the Bee Lambert Law, where I is light intensity, I₀ is the initial intensity, a is the attenuation coefficient (how well light penetrates), and z is the deep of penetration of the light. The equation is:

$$I = {I}_{0} {e}^{- az}$$

Different resin components will affect the penetration of UV light and resin formulations may be tightly controlled, characterized, and tailored to enable this behavior. That is, by varying the resin formulation, the depth of the light penetration may be controlled to achieve the level of curing desired. When the depth of the light penetration is known and controlled, the variable gelation height 7901 may be accurately controlled. When the variable gelation height 7901 is tightly controlled, the resin may flow more freely and resin voids 7801 are avoided.

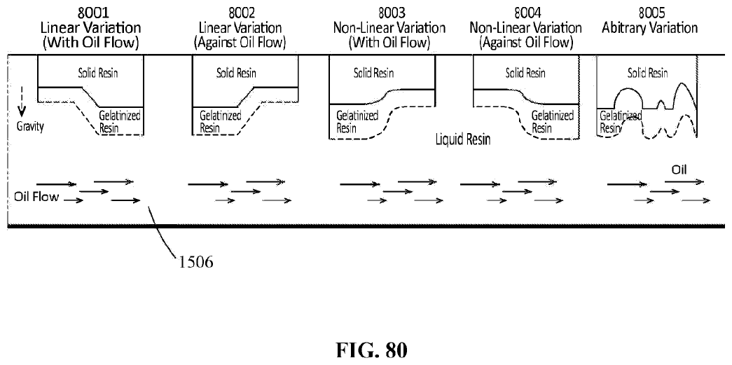

FIG. 80 is an illustration of multiple gelation height 7901 options. Varying the gelation height 7901 may serve multiple purposes based on the requirements of the part 1502 being printed. One benefit of varying the gelation height 7901 is to optimize the reflow of liquid resin to replace the gelatinized resin 7705. Another benefit includes temporary optimizations that reduce the drag of the cooling oil flow on the structure allowing faster oil flow 106, which enables the oil flow 1506 to cool the liquid vat 107, the liquid resin, and the part 1502 more efficiently. Another benefit includes reducing the “suction” force created by Stefans adhesion force based on the Stefan adhesion law, which is explained in greater detail with respect to FIG. 83A and FIG. 83B.

As illustrated in FIG. 80, the variable gelation height 7901 may be linear, non-linear, or arbitrary. Illustration 8001 is linear in the direction of oil flow 106. The variable gelation height 7901 is higher at the upstream side of the oil flow 106 and gets smaller on the downstream side of the oil flow 1506. The decrease is linear with a steady decrease in height over a fixed length of the gelatinized resin 7705. Illustration 8002 is linear against the direction of oil flow 1506. The variable gelation height 7901 is lower at the upstream side of the oil flow 1506 and gets higher on the downstream side of the oil flow 1506. The increase is linear with a steady increase in height over a fixed length of the gelatinized resin 7705.

Illustration 8003 is non-linear in the direction of oil flow 1506. The variable gelation height 7901 is higher at the upstream side of the oil flow 1506 and gets smaller on the downstream side of the oil flow 1506. The increase is non-linear with a varying, non-linear increase in height over a fixed length of the gelatinized resin 7705. Illustration 8004 is non-linear against the direction of oil flow 1506. The variable gelation height 7901 is higher at the upstream side of the oil flow 1506 and gets lower on the downstream side of the oil flow 1506. The decrease is non-linear with a varying, non-linear decrease in height over a fixed length of the gelatinized resin 7705.

Illustration 8005 is arbitrary and independent of oil flow 1506. The variable gelation height 7901 is illustrated as moving higher and lower independent of the position on the gelatinized resin 7705 with respect to the oil flow 1506.

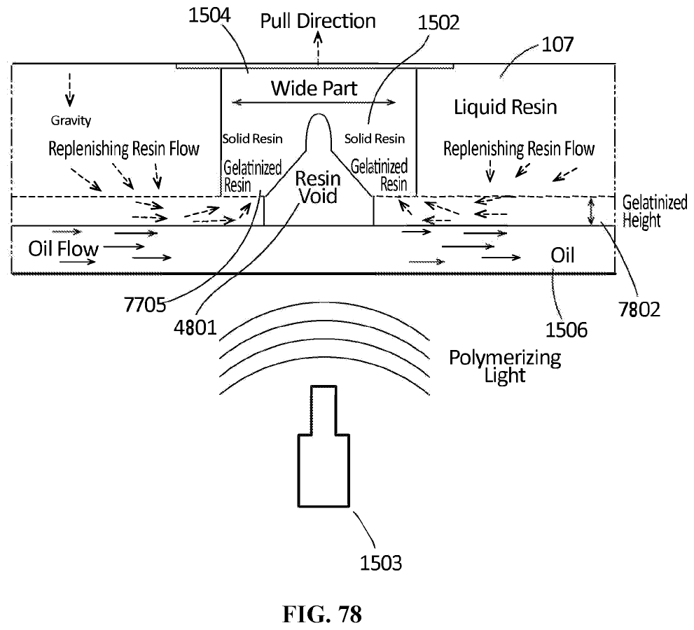

FIG. 81 is an illustration of a printed part 1502 in which gelation height 7901 was not controlled. The part 1502 has voids and roughness 8101 due to the liquid resin being prevented by back pressure or other reasons from flowing to the bottom of the gelatinized resin 7705 when needed. The lack of liquid resin caused the part 1502 to have voids and other imperfections in the surface of the part 1502.

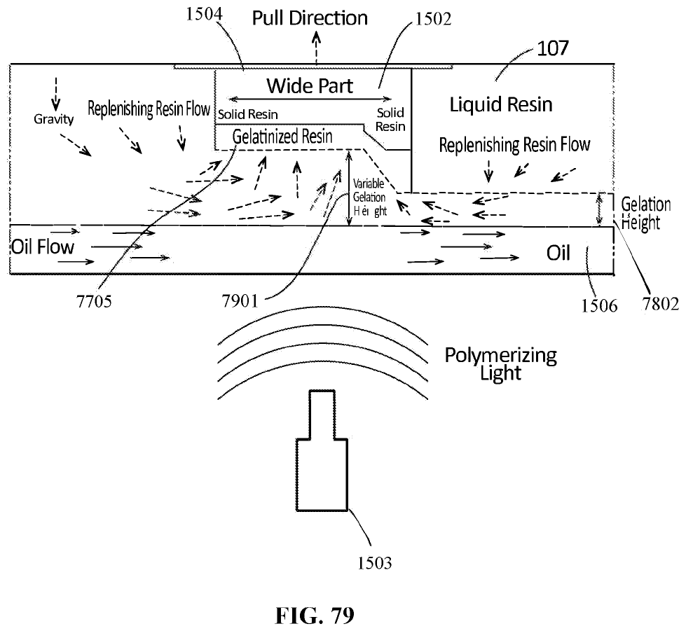

FIG. 82 is an illustration of a printed part 1502 in which gelation height 7901 was appropriately controlled. The part 1502 does not have voids and roughness on the surface 8201 as in FIG. 81 because the liquid resin was not prevented by back pressure or other reasons from flowing to the bottom of the gelatinized resin 7705 when needed. The surface 8201 is smoother than in FIG. 81 and voids were not created.

### Gray Scaling of Pixels

The system uses gray scaling of pixels to modulate the UV light intensity to create varying gelation heights. In grey scaling, individual pixels are turned off and on rapidly to change the intensity of the pixel's light/energy output. The pixel intensity is presented as a gray scale image to the light engines. However, scaling the intensity to multiple projectors becomes difficult because gray scale images contain a large amount of data, and streaming the images may consume a significant percentage of the available communication bandwidth. To quickly and efficiently generate and transmit gray scale images, the process includes several software algorithms.

FIG. 83A is an illustration of a slice 8300 of a printed part 1502 with controlled gelation heights using a straight-line skeleton and graphic illumination algorithm.

In this process, a slice 8300 is divided into polygons, such as polygon 8302. The polygon may be a square a triangle, a rectangle, or any suitable polygon. A straight-line skeleton algorithm is used on each polygon on the slice 8300. The algorithm draws a center line through the polygon. Straight-line skeleton algorithms can be used to create a three-dimensional object out of a two-dimensional polygon where the skeleton forms the equivalent of a “roof line” of the polygon. The vertices of the polygon are converted from 2D vertices to 3D vertices. The roof line vertices can be set to a normalized value of −1 while all the peripheral vertices are set to 0.

Using graphics techniques to create simulated light sources, the 3D polygon can be rendered to have gradient shading using a technical process called z-shading. Parts of the 3D polygon may be rendered as in the shadow of the light source. The position of the light source can also be used as a control that can influence the shading.

FIG. 83B is an illustration of a slice 8300 of a printed part 1502 with controlled gelation heights using a polygon offset algorithm. The polygon offset algorithm uses a technique to shrink the perimeter of the polygon into smaller concentric polygons, such as polygon 8301 or 8302. This technique produces step gradients where the outer polygon has higher intensity values, such as polygon 8302, while the interior polygons have lower intensity values toward the center, such as polygon 8301. All vertices are 2D. The inverse gradient is also possible depending on the application.

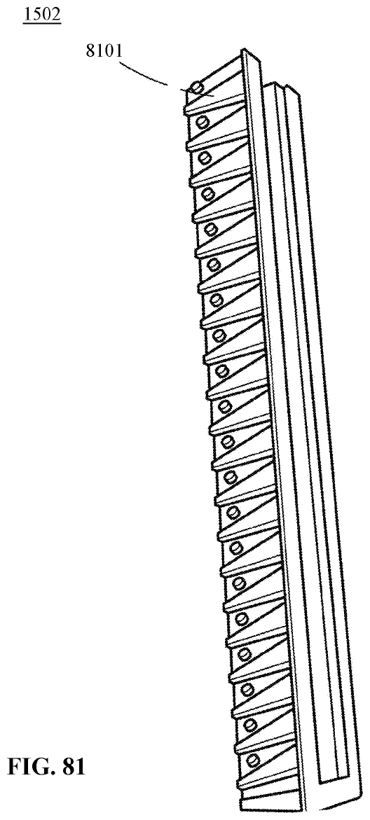

FIG. 84 is an illustration of a slice 8300 of a printed part 1502 with controlled gelation heights using a gradient polygon offset algorithm. Instead of using flat gradient for concentric polygons, the outer and all inner concentric polygon vertices are converted from 2D to 3D, such as with polygons 8301 and 8302. Instead of using a flat gradient for concentric polygons, the outer and all inner concentric polygon vertices are converted from 2D to 3D. The z-values of the outer perimeter are set to 0, the inner most perimeter is set to a normalized value of −1 and all the intervening concentric polygons have their z-values set to a straight line between 0 and −1. The same shading techniques using graphic light sources as described in FIG. 83B are used. A benefit of this method over straight-line skeleton is that the created gradients may be more uniform than with the polygon offset algorithm of FIG. 83B.

### Force Measurement

Control of the forces applied to a part as its being printed prevents potential defects and failures. When a part is being printed the UV light will turn the liquid resin into a solid. However, the solid resin part does not reach full strength until a certain period of time after the print is complete. The strength of the part before full strength is reached is called the green strength of the material. The green strength makes the printed part more fragile and deformable than after the curing is complete and full strength is reached. If certain precautions are not taken during the printing process the forces inherent to the process can deform or break the part before full strength is reached. Three forces that may affect the part include 1) gravity, 2) fluid drag from the flowing oil, and 3) adhesion forces. If any of these forces, a combination these forces, or other similar forces make the stress (Force/Area) on the part larger than the green strength, the part will fail. An example fail stress criterion that can quickly be applied to a body is the von Mises yield criterion. If the combination of stresses from the three described forces are less than the von Mises yield criterion the part will not fail.

To use the von Mises criterion efficiently, certain characteristics of the part are determined. The first characteristic is the center of mass of the printed part as the part is being printed. The second is the moment of inertia of the printed part as the part is being printed. The third is the moment of inertia for each layer of the printed part as the part is being printed. The fourth is the cross-sectional area of the printed part as the part is being printed. The sixth is the perimeter of each layer of the printed part as the part is being printed. These characteristics can be calculated before printing using the slices that are generated as part of the printing process. From these characteristics, the stresses on the printed part may be calculated.

The force from gravity is equal to the mass of each layer combined with each other printed layer. By knowing the cross-sectional area of each layer, the mass of a layer can be computed using the formula:

$$Layer Mass = {Layer}_{area} * {Layer}_{height} * {Resin}_{Density}$$

The gravity stress may be calculated using the formula:

$$Gravity Stress = \frac{{\sum }_{L ayers above each layer} Layer Mass * Gravity}{Current area cross sectional area}$$

Stefan adhesion forces are created by fluid resisting the separation of two plates. The force, F, required to separate the plate is inversely proportional to the cube of the height of the fluid layer, h, directly proportional to the fourth power of the radius of the plate, R, the viscosity of the fluid, u, and the velocity it is lifted at, v. The formula is represented as:

$$Stefan adhesion law = F = \frac{3 π μ {R}^{4}}{2 {h}^{3}} v$$

In a 3D printing process, the interface material layer and printed part are represented as the plates and the gelation height is represented as the height of the fluid layer.

Since each layer is not typically a perfect circle, an approximation is performed using hydraulic diameter. Hydraulic diameter is a way to equate a non-circular area to circular area for the purpose of fluid calculations. The equation is:

$$Hydraulic Diamter = \frac{4 * Cross Sectional Area}{Permieter}$$

Using the hydraulic diameter allows the calculation to estimate the stress on each layer from Stefan adhesion by dividing the current Stefan adhesion force created by the last printed layer by each preceding layers cross-sectional area. This method to calculate the forces may not be an exact calculation for every potential part but may provide a computationally efficient method to obtain an approximation that can inform the printer settings and any feedback measurements.

Another force to use in the calculation is the drag force created by the flowing interface material. The flowing interface material will impart a slight drag on the bottom of the printed part. This drag force can be approximated using the drag equation:

$$Force Drag = \frac{1}{2} ρ {v}^{2} {C}_{d} A$$

In the equation, p is the density of the oil, v is the fluid velocity, C_{d} is the drag coefficient of the exposed section of the 3d printed part, and A is the cross-sectional area at the end of the printed part.

While the exact drag force may be complicated to calculate analytically, simpler correlations may be used to calculate approximations of the drag coefficient using the Bejan number correlation, Be, of drag:

$${C}_{d} = 2 \frac{{A}_{w}}{{A}_{f}} \frac{Be}{R e}$$

In the equation, A_{w} is the cross-sectional area of the part, A_{f} is the area exposed to the oil flow, and Re is the Reynolds number of the fluid flow. The Bejan number and the Reynolds number can be determined by knowing the speed of the oil flow, the density of the resin/oil, and the hydraulic diameter. With this correlation the force from drag can be calculated. Using the moment of inertia for the part at that specific time, the drag stress changes as each layer is printed. The stress imparted by the drag force may use the equation:

$$Drag Stress = \frac{Force Drag * layer Height * L}{Moment of Intertia}$$

In the equation, L is the perpendicular distance from the center of mass of each layer to the outer edge of each layer.

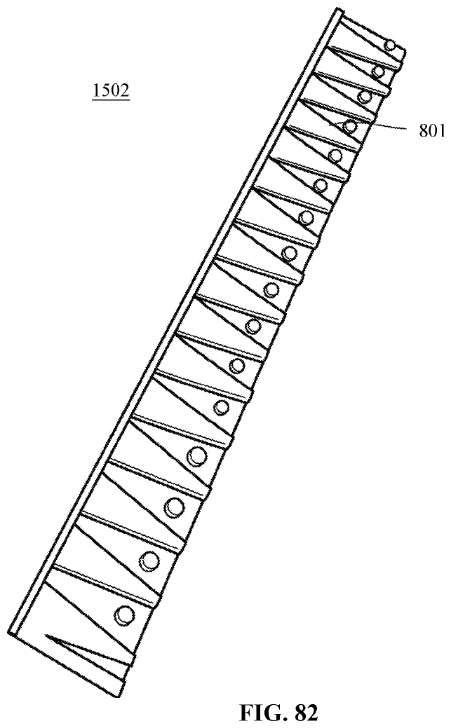

FIG. 85 is an image of a 3D printer comprising multiple sensors. To utilize the feedback loop to manage force control on a part 1502, the system may use sensors for monitoring the forces and fluid flow. For example, to monitor certain forces, the torque on the servos 8502 servos 8502 on the upright support 8505 for the build plate 4804 may be monitored and compared against the theoretical values given by the gravity and Stefan adhesions. A load cell 8501 may be attached to the build plate 4804 to monitor gravity, Stefan, and Drag forces. Comparing the two values from a load cell 8501 and the torque on the servos 8502 servos 8502 may cancel out noise or other potential sources of error and improve a confidence level in the theoretical values. The system may monitor the interface material flow at the bottom of the liquid vat 107 using level and flow monitors. The system may use strain gauges 8503 on the build plate 4804 to monitor the forces on the printed part and the build plate 4804.

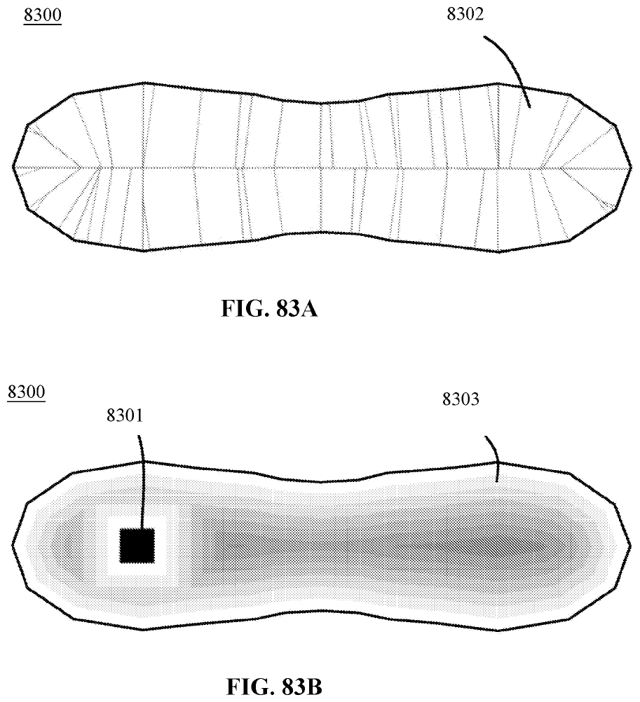

FIG. 86 is an illustration of strain gauges 8503 that are connected to fingers on a build plate 4804. The deflections of the build plate 4804 are measured by the strain gauges and may be correlated to the forces acting on the printed part as illustrated.

### Temperature Control

The next process that is important for the printer is temperature control. The temperature of the resin and the interface material during a print can change dynamically in accordance with the amount of energy being dissipated through the oil/resin interface to create a print. The changes in temperature can be localized or spread throughout the liquid vat. Measurements from many locations are needed to capture the changing temperature behavior and generate a temperature gradient for the resin and interface material.

Temperature of the interface material and resin can impact the quality of the 3D printed parts and the process. If the temperature is known at various locations of the liquid vat as determined by the temperature gradient, other printing input parameters, such as oil flow speed, oil cooling level, light intensity, print speed may be adjusted to be compensate for temperature changes and improve part quality.

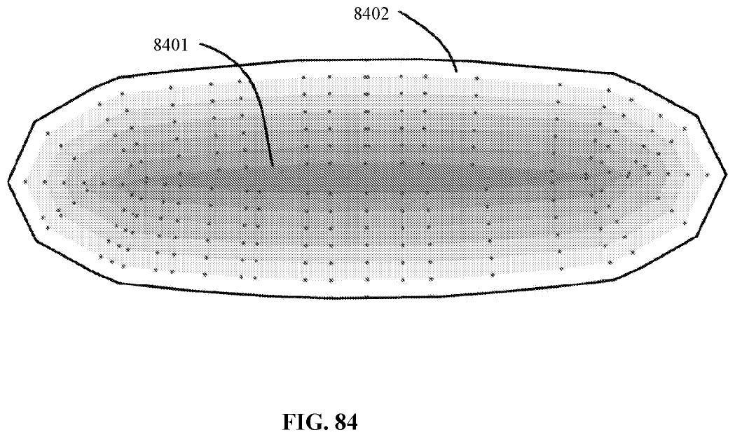

FIG. 87 is an illustration of temperature sensors 8701 arrayed on a liquid vat 107. The sensors 8701 may be any suitable type of temperature sensor 8701, such as a thermistor, resistance temperature detectors, thermocouples, infrared, or any other suitable temperature sensor. The sensors 8701 gather temperature data of the resin and interface material before, during, and after passing through a 3D printing session. The temperature of the resin and the interface material during a print can change dynamically in accordance with the amount of energy being dissipated through the interface material/resin interface.

The curing of the resin creates heat and the flowing interface material removes heat from the 3D printer when the interface material is pumped out of the 3D printer to a heat exchanger or other cooling module. The changes in temperature may be localized or may be spread throughout the liquid vat 107 depending on factors such as the size and complexity of the part being printed, the flow rate of the interface material, the depth of the interface material, the ambient temperature, or other factors. In an example, the sensors 8701 being utilized are direct contact thermistors that measure the temperature of the metal of the liquid vat 107 to which the thermistors are attached.

The use of many temperature sensors 8701 located around the liquid vat 107 allows the system to measure a temperature gradient for both the resin and interface material. The system measures a gradient across the perimeter because the temperature of the interface material and resin affect the quality of the 3D printed parts and the process. Once known, the temperature gradient within the interface material and resin can be used to adjust factors affecting the printing process. Based on the temperature profile provided by the sensors 8701, the system may adjust the flow rate of the interface material, the amount of cooling of the interface material by the heat exchanger, and speed of the 3D printing of the part, or any other suitable factors to achieve a desired temperature profile.

For example, if the temperature of the exiting interface material is higher than a configured benchmark, then the system may take an action such as increasing the velocity of the interface material that is flowing through the liquid vat 107 or decreasing the temperature of the interface material that is provided to the liquid vat 107. In another example, if the temperature of the interface material entering the liquid vat 107 at the manifold 4001 is too high, then the system may increase the cooling capacity of the heat exchangers, such as by lengthening the residence time of the interface material in the heat exchanger.

In an example arrangement, four sensors 8701 are installed on the outside right and left walls of the aquarium, and another four on the outside of the front wall opposite the Z-arm. On the manifolds, one sensor 8701 is installed on the entry of the inlet manifold 4001 to verify that the interface material coming into the aquarium is at the desired temperature. Seventeen sensors 8701 are installed on the outlet manifold 4002 to record the temperature of the interface material coming out of the aquarium.

An example of the temperature calculations done to verify the effectiveness of the interface material is provided in Table 6.

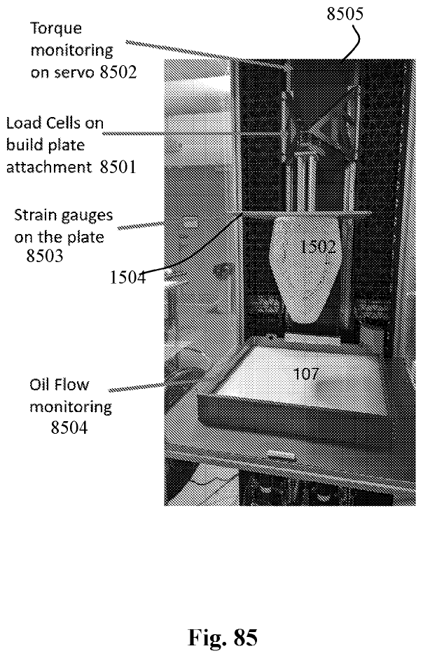

FIG. 88 is an illustration of temperature sensors 8701 arrayed on an outlet manifold 4002 of a liquid vat 107. One sensor 8701 is installed at the outlet valve of the manifold 4002, which is illustrated as being below the other sensors 8701.

A computing or electronic device may measure, monitor, or control the operations of the components of the fluid handling and thermal management system and/or the 3D printer based on the temperature inputs. For example, the controller may be a computer controller that receives inputs of temperature or any other input and uses the inputs to control the operations of the components of the 3D printer or fluid handling and thermal management system. For example, the computer controller may be a flow controller. The computing device may receive an input of the temperature sensors 8701 and determine that the temperature is higher than a threshold. The computing device may increase the speed of the volumetric pump 806 to increase the amount of interface material in the liquid vat.

In another example, the computing device receives inputs of the temperature sensors 8701 and creates a gradient or profile of the liquid vat. For example, by knowing the locations of each sensor 8701, the computing device may input the temperatures into a computer model of the liquid vat. With the temperature of each location on the liquid vat known, a model of the entire liquid vat may be created by interpolating the temperatures for each portion of the liquid vat. The model may further use the temperature changes for each sensor 8701 over time to create a model of how the temperature flows and changes inside the liquid vat as a part is printed. The model may be used to identify problem areas, identify hot spots, identify locations that require more flow or cooling, identify resin depths that function more efficiently, or determine any other characteristics of the liquid vat temperature that affect efficiency.

The energy intensive process in which the light engine dissipates energy on the vat can create an excess of heat that needs to be managed. Some of the consequences of excessive heat may include the resin catching fire or uncontrolled clouding of the resin. However, if the interface material is cooled to a temperature below a threshold or the flow of interface material is too high, the printing of the part may suffer from lowered reaction rates that may limit adhesion of the print to build plate due to the lack of heat. This lack of adhesion and lower cure rates may result in a failed print.

Temperature of the resin and interface material is an input parameter for the temperature and oil flow control that can be mitigated by increasing or decreasing the flow of interface material. However, the flow of interface material also has other effects that need to be considered when setting the optimal parameters for the printing process. If the temperature is too high, and the flow of the interface material needs to be increased because of the increased temperature, the flow of interface material will have a maximum flow rate for completing a successful printing. If the flow of interface material is over the maximum flow rate, then the momentum of the interface material can create enough shear force to delaminate the resin that is curing on the build plate. The excessive flow may create fluid drag on the part being printed, causing defects throughout the printed part. If the excessive flow encounters gelling resin that is not yet fully cured, the gelling resin may flow off into the liquid vat 107. If the flow of interface material is not sufficiently high for the required printing process, increasing temperatures may ensue and cause the defects and print failures discussed herein.

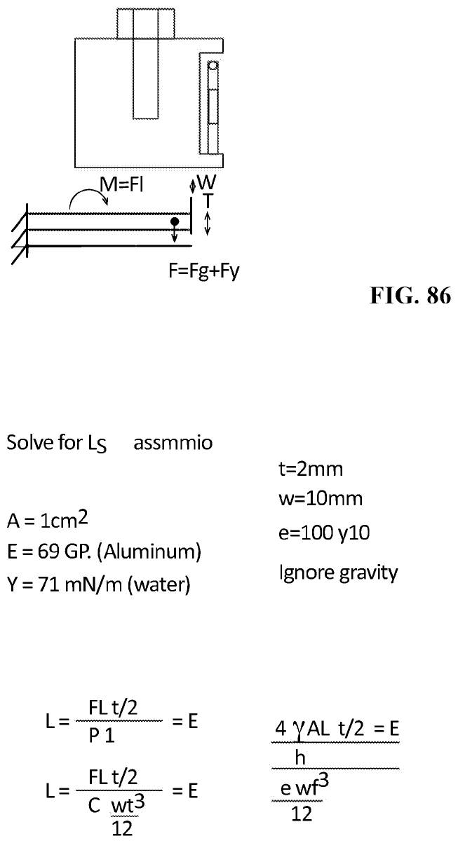

FIG. 89 is a block flow diagram depicting a feedback loop to control interface material flow based on temperature and interface material flow rates. As illustrated, the geometry, material being used in the printing process, and the speed of the print are factors or characteristics of the printing process being used to print a particular part. The temperature and interface material flow control systems set an output for the interface material flow rate based on the known print process characteristics. The resulting interface material flow rate causes a temperature to be achieved in the interface material and the resin. The resulting temperatures and flow rates are compared to a target temperature and flow rate. During the resulting printing process, the thermistors 1401 continuously or periodically report a temperature across the liquid vat, the inputs, the outputs, and/or the manifolds. The pump reports an operating condition based on the pulse-width modulation (“PMW”) speed control. Based on the pump speed and the temperatures reported, the computing system or other manager of the printing process changes the setpoints of the pump to increase or decrease the interface material flow rate. For example, if the temperature is too high, then the pump speed is increased. If the temperature is too low, then the pump speed is decreased.

When the new pump speed is set, the printing process continues to follow the feedback loop as described. When the temperature and flow rates are at an optimal or preferred condition, a successful part is printed. When subsequent changes to the temperature are encountered, adjustments are made to the pump speed as described.

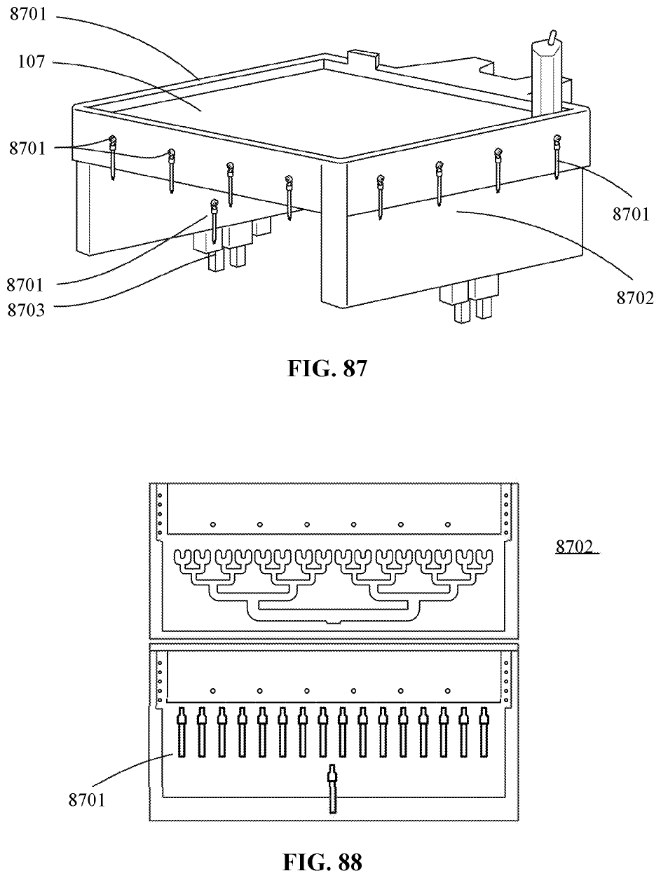

FIG. 90 is a schematic for a custom designed printed circuit board (“PCB”). The PCB may be located onboard the 3D printer to take measurements from the temperature sensors, the interface material/resin level sensors, and other analog sensors in a centralized manner. The PCB connects with small custom computers integrated into the control system of the 3D printer. The board enables collection of an analog voltage signal series of Analog-to-Digital Converter (“ADC”) Integrated Chips (“ICs”) that are coupled with voltage divider circuits for the temperature sensor readings and current sensor circuits for the level sensors. The ICs are selected with multiple ADC channels and I2C addresses. I2C is a low-level digital communication protocol, which allows the number of inputs to be scaled up to 64 on a single I2C bus.

The PCB board is a central source through which the system may channel all sensor data to the computers that control the printer. The PCB board was specifically designed to enable the system to scale the sensing capabilities of the printer and enable and control some or all of the various processes functions.

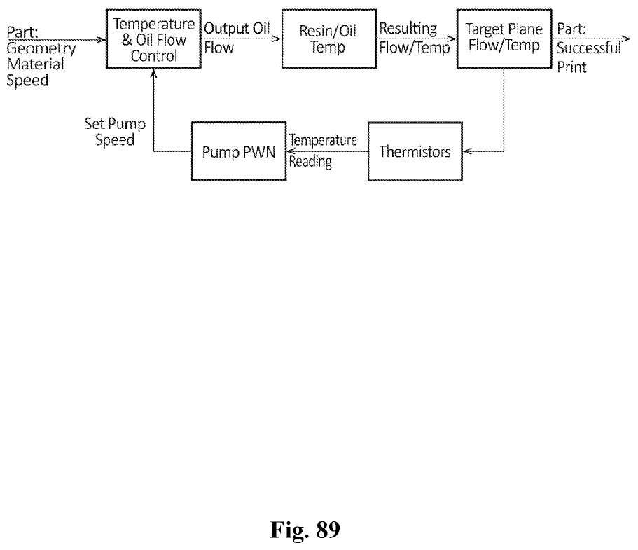

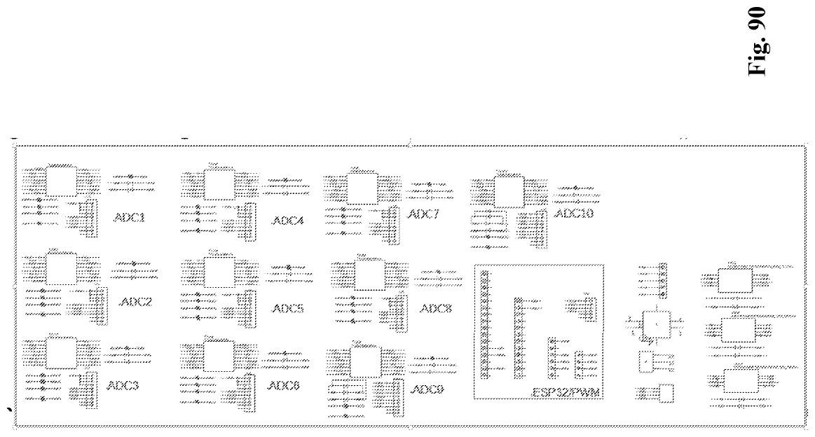

FIG. 91 and FIG. 92 are layouts for the custom designed PCB. FIG. 91 connects to FIG. 92 at locations A and B. When joined at connections A and B, FIG. 91 and FIG. 92 create a single PCB layout.

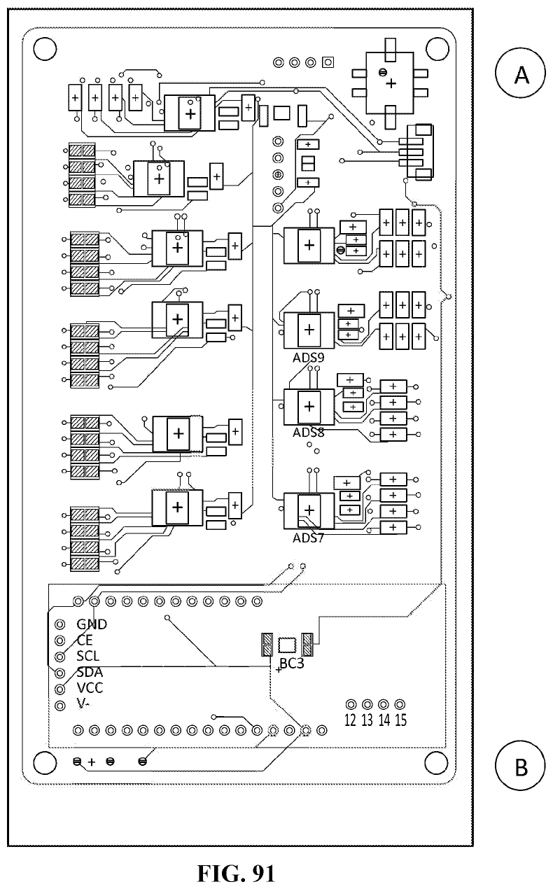

FIG. 93 is a block flow diagram depicting a feedback loop to control cooling fans based on ambient temperature and ventilation fan speeds. A set of temperature sensors is located on the support structure or hood area and follows a similar feedback loop as the thermistors located on the aquarium. Unlike the thermistors 8701 on the liquid vat 107 in FIG. 87 and FIG. 88, the thermistors found near the support structure or hood area and the optical cavity are typically ambient temperature thermistors. The ambient temperature sensors record a resistance based on the temperature of the environment in which the sensors are located. The sensors have a resistance versus temperature relationship such that when the temperature increases, the resistance decreases. When the temperature lowers, the resistance increases. If the temperature recorded is too high, the computing system determines that the ambient temperature should be lowered through ventilation cooling, such as by increasing the speed of a ventilation fan.

As illustrated, the geometry, material being used in the printing process, and the speed of the print are factors or characteristics of the printing process being used to print a particular part. The temperature and ventilation control systems set an output for the ambient temperature based on the known print process characteristics. The resulting ventilation fan speed causes a temperature to be achieved in the environment. The resulting temperatures and ventilation fan speed are compared to a target temperature and ventilation fan speed. During the resulting printing process, the thermistors continuously or periodically report a temperature in the environment. The ventilation fan reports an operating condition based on the PMW speed control. Based on the ventilation fan speed and the temperatures reported, the computing system or other manager of the printing process changes the setpoints of the ventilation fan to increase or decrease the ventilation fan speed. For example, if the temperature is too high, then the ventilation fan speed is increased. If the temperature is too low, then the ventilation fan speed is decreased.

### Humidity Control

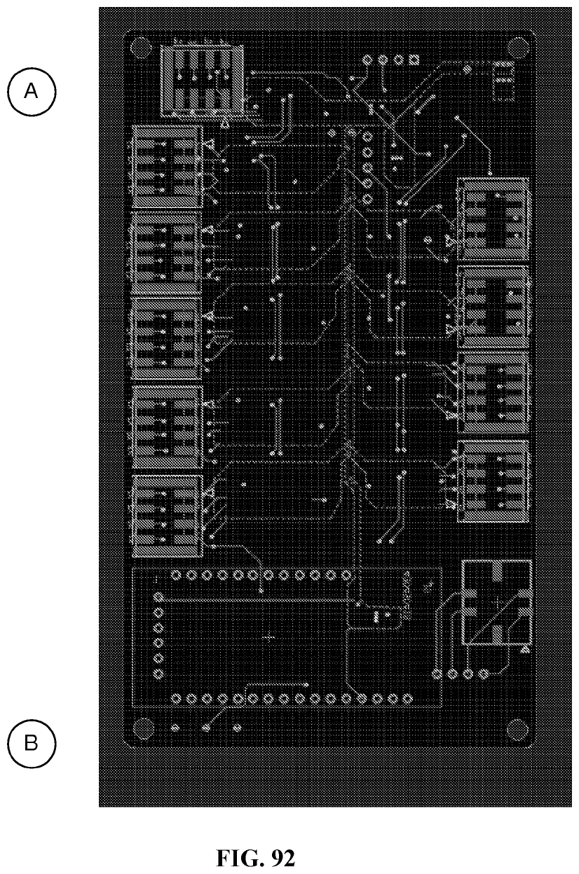

FIG. 94 is a block flow diagram depicting a feedback loop to control temperature based environmental humidity. One effect of excessive environmental humidity may include condensation of the glass on the liquid vat interface. Condensation may drip onto sensitive electronics or other features of the printer. Another potential effect is that high humidity may cause the resin to absorb more water from the air than is preferred. The additional water in the resin may cause the resin to become cloudy. Water can also affect the reaction of the resins by either chemically damping the reaction or cooling the reaction so that the curing of the resin is slowed. The effects that humidity has on the 3D printing process may cause imperfections in the printed part.

To control this variable in the printing process, humidity sensors are fitted within the optical cavity where the light engine is placed in the printer, and in the body of the liquid vat. The humidity sensors record the humidity data and communicate with the computing system managing the operations of the printer. The computing system manages the ventilation system. The ventilation system consists of fans fitted with PWM capabilities, enabling the fans to be set at different speeds increasing and decreasing ventilation as a result. The PWM speed control for the fans then increases with increasing humidity and decreases with lower humidity.

As illustrated in FIG. 94, the geometry, material being used in the printing process, and the speed of the print are factors or characteristics of the printing process being used to print a particular part. The humidity and ventilation control systems set an output for the ambient humidity based on the known print process characteristics. The resulting ventilation fan speed causes a humidity to be achieved in the environment. The resulting humidity and ventilation fan speed are compared to a target humidity and ventilation fan speed. During the resulting printing process, the humidity sensors continuously or periodically report a humidity in the environment. The ventilation fan reports an operating condition based on the PMW speed control. Based on the ventilation fan speed and the humidity reported, the computing system or other manager of the printing process changes the setpoints of the ventilation fan to increase or decrease the ventilation fan speed. For example, if the humidity is too high, then the ventilation fan speed is increased. If the humidity is too low, then the ventilation fan speed is decreased.

The Humidity sensors communicate with the computer controls through I2C communication on a PCB. The ICs were selected with multiple ADC channels and I2C addresses (I2C is a low-level digital communication protocol), so that the number of inputs can be scaled up to 64 on a single I2C bus.

### Tilt-Control

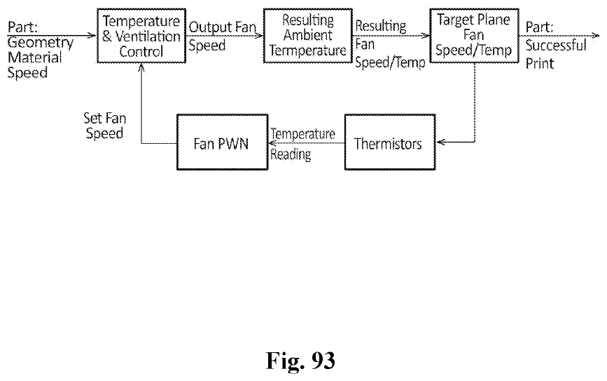

FIG. 95 is an illustration of tilt sensors on a light engine platform. The tilt sensors provide input parameters for leveling and alignment. In an example, a set of tilt sensors is found in the base plate assembly and another set is found in the liquid vat alignment bowl. The two parameter control inputs from the tilt sensors are the x and y coordinates of both the base plate and the liquid vat. The sensors also measure six degrees of freedom found in the Stewart platform light engine modules. The tilt sensors that are employed in the 3D printer provide the x and y coordinates of the base plate, the light engines platforms, and the liquid vat. The light engine Stewart platform modules and the oil interface should be parallel and accurately aligned to provide proper printing of parts. If the light engine Stewart platform modules are not properly aligned, then the print will not have the dimensional accuracy that the part demands, resulting in a failed print. The sensors measure both the absolute tilt of the printer and the relative tilt of the light engines to the liquid vat.

In the FIG. 95, light engine 1503 is mounted on a Stewart platform 9502. The Steward platform 9502 is used to level the light engine 1503 in a proper alignment and tilt with respect to the other light engines 103 and the liquid vat 107. The Stewart platform 9502 is mounted on a platform 9502, shelf, table, or other body portion that is either integral to the printer or mounted adjacent to the printer. The tilt sensor is mounted on the platform 9501, the Stewart platform 9502, or both.

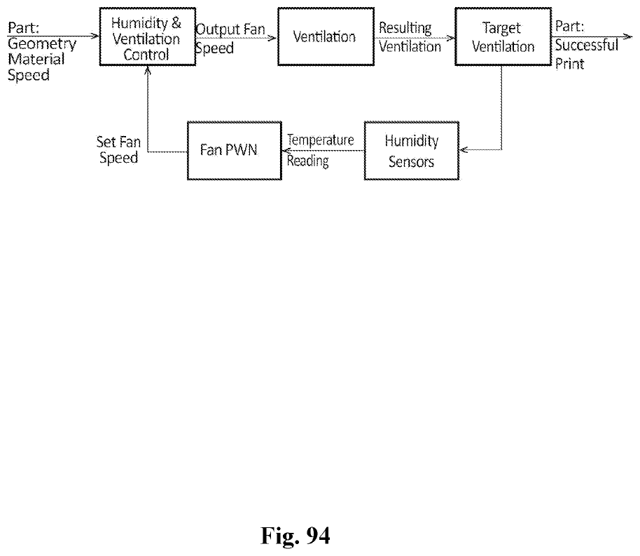

FIG. 96 is an illustration of tilt sensors 9601 on a liquid vat 107. The liquid vat 107 is the body of the printer that holds the liquid resin and the curing part, as described herein. The tilt sensor 9601 provides inputs about the absolute tilt and alignment of the liquid vat 107. The tilt sensor 9601 provides inputs about the relative alignment of the liquid vat 107 with the light engine or other portions of the 3D printer assembly or housing.

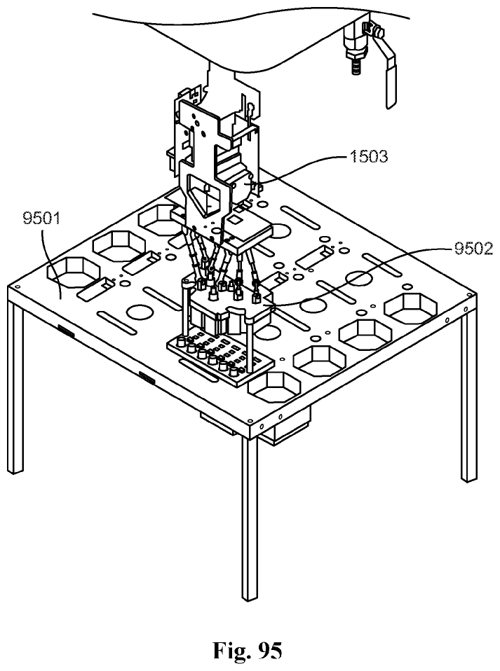

FIG. 97 is an illustration of a mounting location on a platform 9501 for a tilt sensor 9601. The tilt sensor 9601 may be mounted on the platform 9501 securely such that when the platform 9501 is tilted or otherwise comes out of alignment, the tilt sensor 9601 will detect the relative position and provide an output.

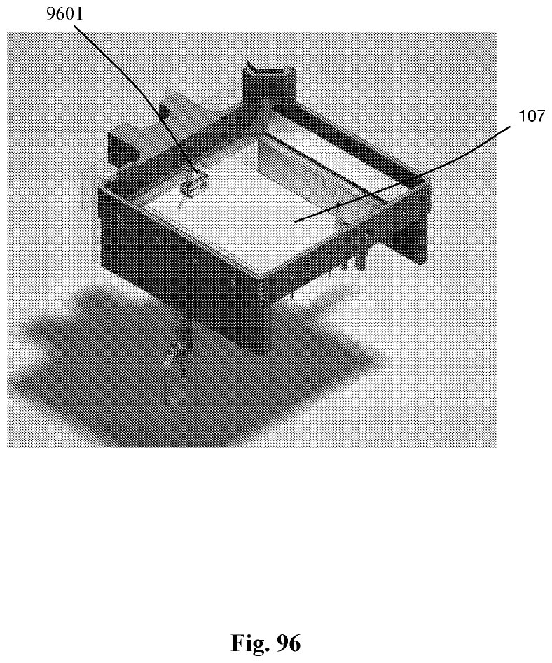

FIG. 98 is an illustration of a tilt sensor 9601 mounted on a mounting location on a platform 9501. The tilt sensor 9601 is mounted on the platform 9501 securely such that when the platform 9501 is tilted or otherwise comes out of alignment, the tilt sensor 9601 will detect the relative position and provide an output.

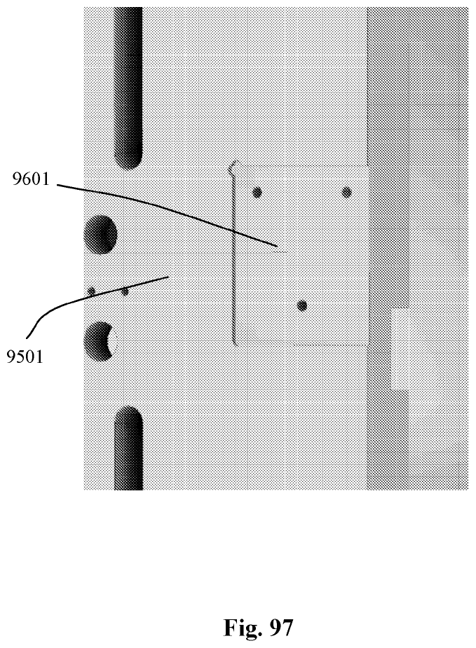

FIG. 99 is an illustration of a mounting location on a liquid vat 107 for a tilt sensor 9601. The tilt sensor 9601 may be mounted on the liquid vat 107 securely such that when the liquid vat 107 is tilted or otherwise comes out of alignment, the tilt sensor 9601 will detect the relative position and provide an output.

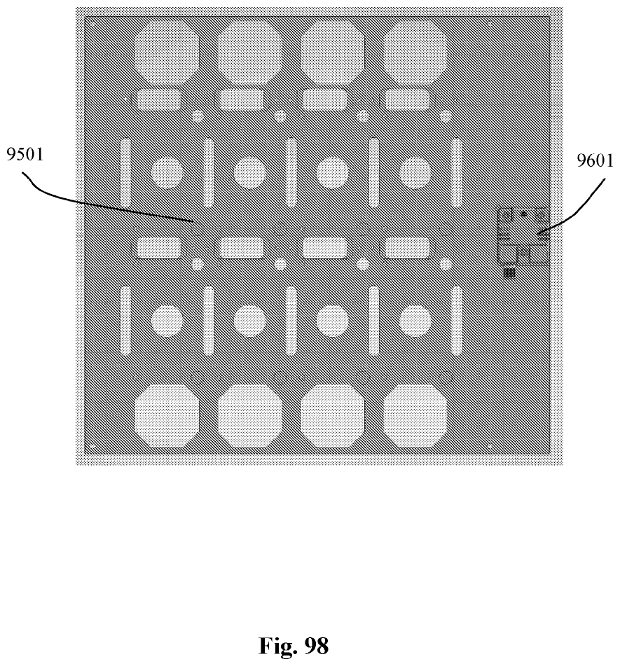

FIG. 100 is an illustration of a tilt sensor 9601 mounted on a mounting location on a liquid vat 107. The tilt sensor 9601 is mounted on the liquid vat 107 securely such that when the liquid vat 107 is tilted or otherwise comes out of alignment, the tilt sensor 9601 will detect the relative position and provide an output.

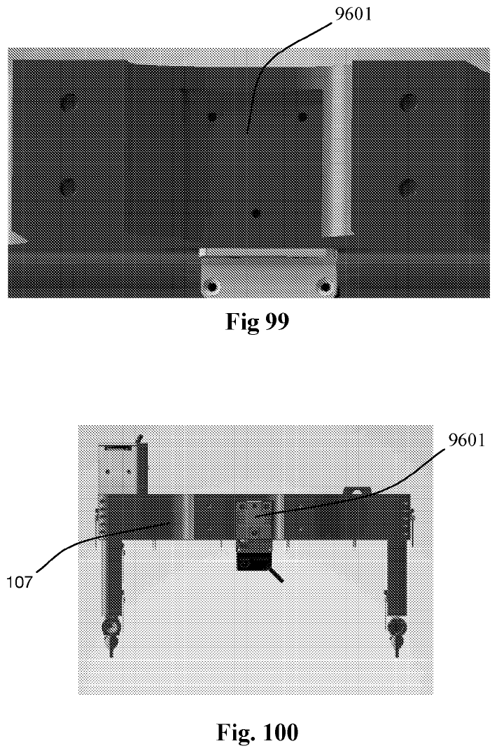

FIG. 101 is a block flow diagram depicting a feedback loop to control platforms based on tilt sensors. When the base platform 9501 is level to gravity, then the individual light engine Stewart platform modules can mimic the platform 9501 in order to ensure parallelism with the oil level interface. The liquid vat 107 must remain level to ensure that the interface material/liquid resin interface is level with gravity.

In the feedback loop, the geometry, material being used in the printing process, and the speed of the print are factors or characteristics of the printing process being used to print a particular part. The tilt and parallelism control systems set an output for the tilt plane based on the known print process characteristics. The resulting tilt plane causes an adjustment of the Stewart platforms, and the resulting parallelism is compared to a target parallelism. During the resulting printing process, the tilt sensors continuously or periodically report a tilt of the platform 2201. The Stewart platforms report an adjustment by each module. Based on the tilt and the adjustments reported, the computing system or other manager of the printing process changes the setpoints of the tilt and parallelism controllers. For example, a leveling device may tilt the platform 9501 or other device as required to achieve an alignment with gravity. In another example, the Steward platforms are provided with instructions to accommodate the current level of tilt. In another example, the feedback loop is used with liquid vat tilt sensors 9601. Similar responses to the tilt feedback may be taken for the liquid vat 107.

The printer has a custom PCB onboard the printer to take measurements from the tilt sensor in a centralized manner and to connect with small custom computers integrated into the control system. The PCB enables collection of an analog voltage signal series of Analog-to-Digital Converter (ADC) Integrated Chips (ICs) that are coupled with voltage divider circuits for the thermistor readings and current sensor circuits for the level sensors. The ICs were selected with multiple ADC channels and I2C addresses (I2C is a low-level digital communication protocol), so that the number of inputs can be scaled up to 64 on a single I2C bus.

### Level Control

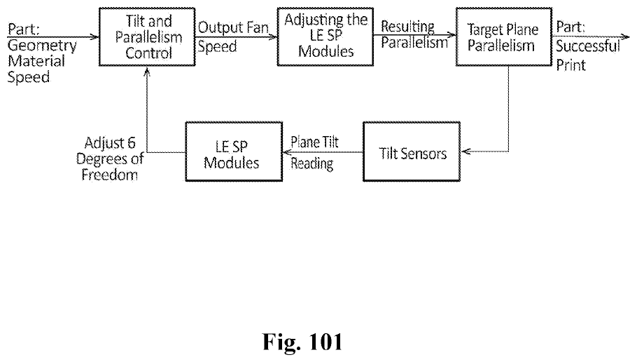

FIG. 102 is an illustration of a liquid vat 107 with an upper-level sensor 10002 and a lower-level sensor 10001. The 3D printer operates more efficiently and consistently when the resin depth is known, the level of the interface material/liquid resin interface is known, and the build plate 4804 is aligned at the proper depth.

The 3D printer utilizes level sensors, such as upper-level sensor 10002 and a lower-level sensor 10001 to measure the depth of the resin in the liquid vat 107 and the depth of the resin/interface material interface. The sensors 10001, 10002 may be based on any suitable level technology, such as laser sensors, optical sensors, proximity switches, float sensors, or any other sensor. In the examples herein, the level sensors 10001, 10002 are laser sensors.

In the example, the system uses one laser sensor 10001 mounted beneath the liquid vat 107 and one laser sensor 10002 mounted above the liquid vat 107. For the lower laser distance sensor 10001, the laser passes through a window in the floor of the liquid vat 107 and the optically clear interface material and is reflected from the resin on top of the interface. The interface level subtracted from a known height of the window at the bottom of the liquid vat 107 gives the interface material height. The upper laser sensor 10002 is reflected from the upper surface of the resin in the liquid vat 107. Subtracting the height of the interface from the upper surface of the resin, the system can easily calculate the amount of resin in the liquid vat 107. By knowing the height of the interface material in real time the height of the Z-arm can be held constant with respect to the interface material height. By holding the build plate 4804 constant with the interface, the resin may build at the interface level and utilize the benefits provided by the interface.

In this configuration, even if small variations in oil height occur the Z-arm can be adjusted in real time. That is, if the level of the interface material is higher than expected, the system will recognize that the interface is higher than expected and raise the Z-arm, which raises the build plate 4804 to the new, higher level of the interface. In an additional example, an upper level sensor 10002 is mounted to the Z-arm or build plate 4804 to more effectively control Z-arm positioning relative to the resin and/or interface material.

A computing or electronic device may measure, monitor, or control the operations of the components of the fluid handling and thermal management system and/or the 3D printer based on the level inputs. For example, the controller may be a computer controller that receives inputs of level or any other input and uses the inputs to control the operations of the components of the 3D printer or fluid handling and thermal management system. For example, the computer controller may be a flow controller. The flow controller may receive an input of the level devices 10001, 10002 and determine that the level of the interface material is lower than a threshold. The flow controller may increase the speed of a volumetric pump to increase the amount of interface material in the liquid vat 107.

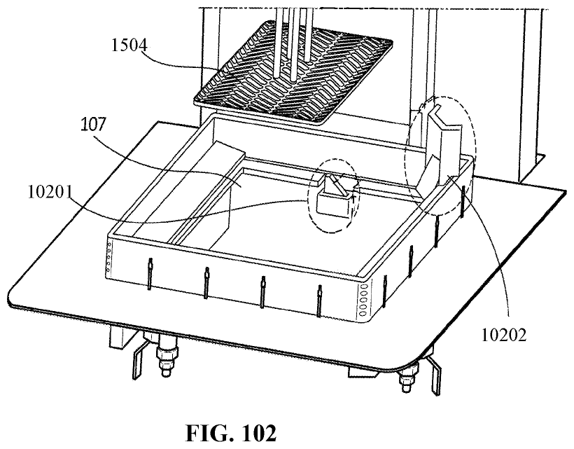

FIG. 103 is a block flow diagram depicting a feedback loop to control resin and interface material level based on fluid level sensors. The parameter inputs may be the interface material level detected by the level device 10001, the Z-Arm build plate upright support device level, and the height of the light engine Stewart platform modules. If the interface material level increases by x microns, the height of the light engine Stewart platform modules and Z-Arm must increase x microns to stay within the optimal operating parameters.

In the feedback loop, the geometry, material being used in the printing process, and the speed of the print are factors or characteristics of the printing process being used to print a particular part. The interface material level and the Stewart platform module control systems set an output for the interface material level based on the known print process characteristics. The resulting interface material level causes an adjustment of the Stewart platforms and the Z-Arm level, and the resulting levels are compared to target levels. During the resulting printing process, the level sensors 2901, 2902 continuously or periodically report a interface material level. The Stewart platforms and the Z-Arm reports an adjustment by each module or device. Based on the interface material level and the adjustments reported, the computing system or other manager of the printing process changes the setpoints of the interface material level and the Stewart platform module controllers. The feedback loop allows for continuing adjustments to operate the printing process at optimal interface material levels.

The printer has a custom PCB onboard the printer to take measurements from the oil level sensor in a centralized manner, connecting with small custom computers we have integrated into our control system. The board enables collection of an analog voltage signal series of Analog-to-Digital Converter (ADC) Integrated Chips (ICs) are coupled with voltage divider circuits for the thermistor readings and current sensor circuits for the level sensors. The ICs were chosen with multiple ADC channels and I2C addresses (I2C is a low-level digital communication protocol), so that the number of inputs can be scaled up to 64 on a single I2C bus.

### Fluid Handling and Thermal Management Control

The 3D printing system may employ sensors in the fluid handling and thermal management system. The fluid handling and thermal management system may represent any system, component, module, or other accessory to the printer that provides process fluid flow devices and electronic support. An example fluid handling and thermal management system includes a volumetric pump, filters, a heat exchanger, a fan, an enclosure case, quick disconnects, electronics, and various control sensors (including a computer, pressure, and temperature sensors). The fluid handling and thermal management system unit may be integral to the 3D printer, affixed to the 3D printer, or located separately from the 3D printer. The fluid handling and thermal management system may be a part of the 3D printer without being located on the same rack with the 3D printer. The fluid handling and thermal management system may be scaled to service more than one 3D printer as described herein. The fluid handling and thermal management system may include a material separator.

The various control sensors in the fluid handling and thermal management system exist to aid the functioning of a volumetric pump, filters, and heat exchanger. The volumetric pump is a pump that creates a constant volumetric flow of fluid that is constant regardless of the pressure in the system. The constant flow rate enables the changing of the amount of oil in the system and the location of the fluid handling and thermal management system relative to the printer without any adjustment to pump operation. Changing oil levels, moving the fluid handling and thermal management system relative to the printer, and other process changes will result changes to the system pressure. If a non-volumetric pump were used to pump the interface material, the changes in system pressure would need tuning for each location of the fluid handling and thermal management system as well as oil levels to deliver precise, repeatable interface material flow. The changes in pressure may be monitored by the pressure and temperature sensors that are installed in the fluid handling and thermal management system. These sensors allow a computer control system to verify the proper functioning of the fluid handling and thermal management system and indicate that the settings are being utilized.

In an example, a pressure and temperature sensor are fitted in the interface material line before the oil reaches the filters and after the pump. Additional pressure and temperature sensors are fitted in the line of glycol delivered from the chiller. These sensors indicate the pressure and allow the system to verify that the flow of interface material and flow of glycol that has been configured is being delivered. The temperatures of the interface material and glycol can also be recorded to verify that the information being given by the temperature sensors on the liquid vat is accurate. These pressure and temperature sensors allow the system to verify that the feedback loop between the temperature thermistors and the pump flow is operating properly. If the system recognizes an increase in temperature, the sensors will verify increase, and the feedback loop increases the flow of interface material. The pressure sensors will recognize record the increased interface material flow. Additionally, the pressure sensor fitted before the filters may be combined with a pressure shut off sensor to avoid over-pressurizing the system. The shut off sensor acts as a safety mechanism if the pressure of the system surpasses a certain configured value and shuts off all the electronics in the fluid handling and thermal management system and the fluid flow in the system.

In an example, the fluid handling and thermal management system may differentially cool resin and/or interface material. This differential cooling allows for distribution of fluids having differing temperatures to specific locations during the printing process, which allows for flexible gradient temperature control. In an example, this is a liquid cooling system having different multiple compartments holding coolant of differing temperatures, cooling the different fluids to different temperatures. Suitable liquid coolants include, but are not limited to, water, ethylene glycol, propylene glycol, and combinations thereof.

In an example, the fluid handling and thermal management system may further comprise a resin replenishment system in combination with a resin recirculation system. In this example, an optimal ratio of fresh resin to recirculated resin is determined for a given printing process and resin formulation. This system would include a collection tube positioned in the resin vat 107 through which the resin to be recirculated flows into the resin replenishment system. In an example, the resin replenishment system further comprises a compartment holding fresh resin. The resin replenishment system would then have a compartment in which fresh resin is combined with resin to be recirculated optionally comprising a mechanical mixer in order to ensure proper distribution of all the components of the resin formulation and replenish the resin to the optimal levels. Replenished resin would then be circulated from this compartment back into the resin vat 107. In an example, a mechanical mixer is present in the resin vat above the interface material as an additional method of component distribution control of the resin formulation. In an example, the resin replenishment system uses a flow manifold system to circulate the replenished resin into the resin vat. In an example, the resin replenishment system further comprises a computer controller capable of receiving signals from a resin level sensor in a resin vat 107. Based on this data, the computer controller is capable of dictating how much new resin from the new resin compartment is mixed with the recirculated resin. In an example, the resin replenishment system is housed within a 3D printer. In an example, the resin replenishment system is an external resin replenishment system. In an example, multiple 3D printers are coordinated with a single resin replenishment system.

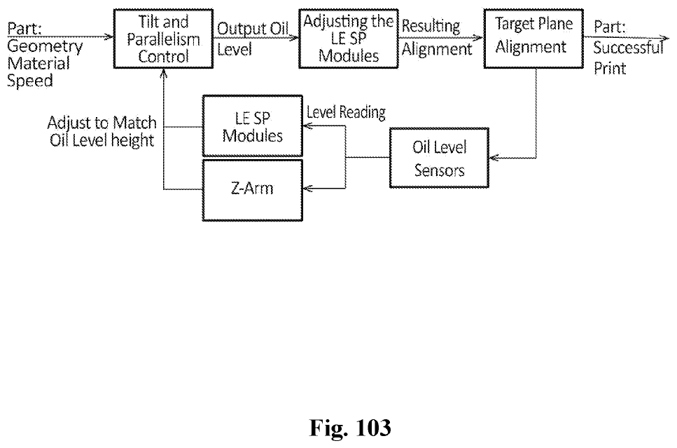

FIG. 104 is an image of a pressure transmitter 10401 in a glycol line 10402. The pressure transmitter 10401 is screwed into a tee connection. The signal from the pressure transmitter 10401 is communicated to a computing system as described herein.

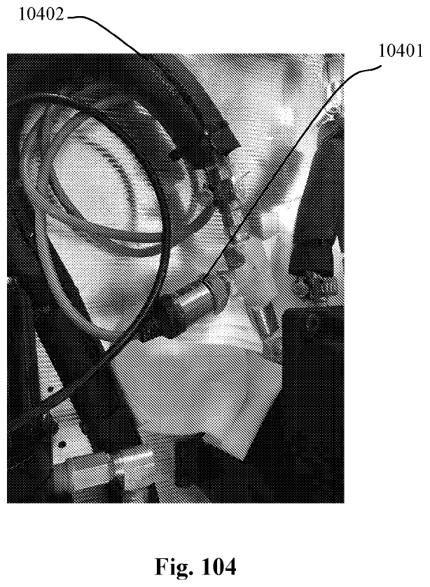

FIG. 105 is an image of a pressure transmitter 10401 and a pressure sensor shut off 10501 in a glycol line 10402. The signal from the pressure transmitter 10401 is communicated to a computing system as described herein. The pressure sensor shut off 10501 may actuate a valve device that stops the flow in the line.

The pressure and temperature sensors communicate with the computer controls through I2C communication on a PCB. The ICs were chosen with multiple ADC channels and I2C addresses (I2C is a low-level digital communication protocol), so that the number of inputs can be scaled up to 64 on a single I2C bus.

### Alternative Designs

Another improvement may be made to the laser detection of interface material and liquid resin height. The current system works with resin that has color but not for resin that is optically clear and without color. The optically clear resin may not reflect a laser signal due to the refractive index of the resin. A laser reflection is required for the current laser sensors to work.

To overcome this issue, alternative sensors may be used to detect interface material and liquid resin in the 3D printer. A first sensor alternative uses ultra-sonic sensors mounted above the liquid vat. The first sensor will detect the combined height of the main liquid vat filled with both interface material and resin. The second ultra-sonic sensor will be mounted above a channel that only has interface material in it. The channel has an opening underneath that allows interface material to flow between the channel and the liquid vat but not resin. With these two measurements, a system would be able to know the height of both the interface material and the resin. The system is described in greater detail in FIG. 33.

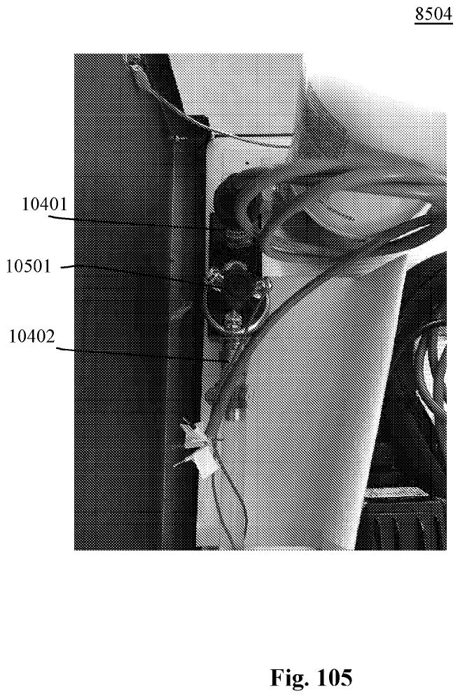

FIG. 106 is an illustration of a system with ultra-sonic sensors with a interface material channel. A first ultrasonic sensor 10601 is mounted over the combined resin and interface material in the liquid vat 107. The ultrasonic sensor 10601 bounces a signal off the resin surface and measures the height of the resin surface. A second ultrasonic sensor 10602 is positioned over a channel 10603 of only interface material. The channel 3303 is not in the liquid vat 107, but is allowed to equalize the height of the interface material because the channel 10603 is open to the interface material in the liquid vat 107.

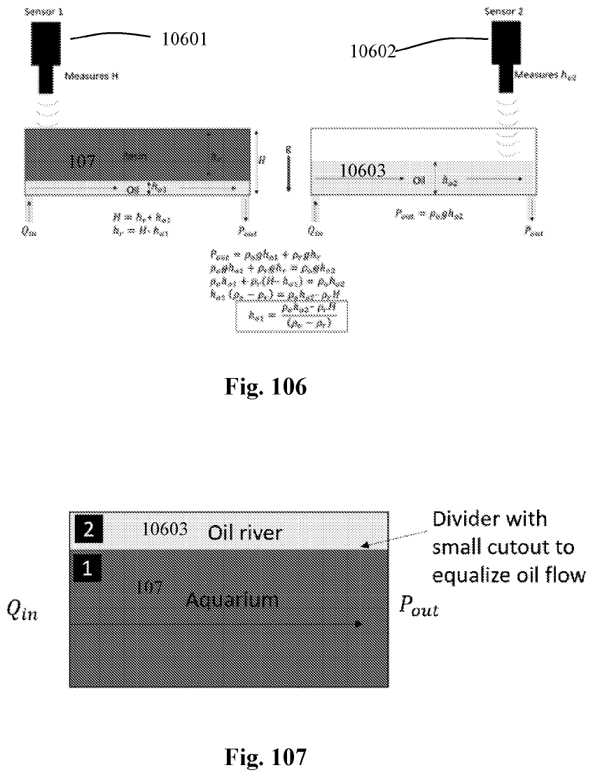

FIG. 107 is a top view of the liquid vat 107 and the channel 10603. A divider between the liquid vat 107 and the channel 10603 has one or more holes or cutouts to allow the interface material level to equalize. The channel 10603 may be located in any suitable position, such as parallel to the liquid vat 107 or in any other configuration. The second ultrasonic sensor 10602 bounces a signal off the surface of the channel 10603 and determines the height of the interface material. By subtracting the surface of the interface material from the surface of the resin, the total height of the resin may be calculated, and the height of the interface may be determined.

In another alternative design, submerged lasers are utilized in the liquid vat.

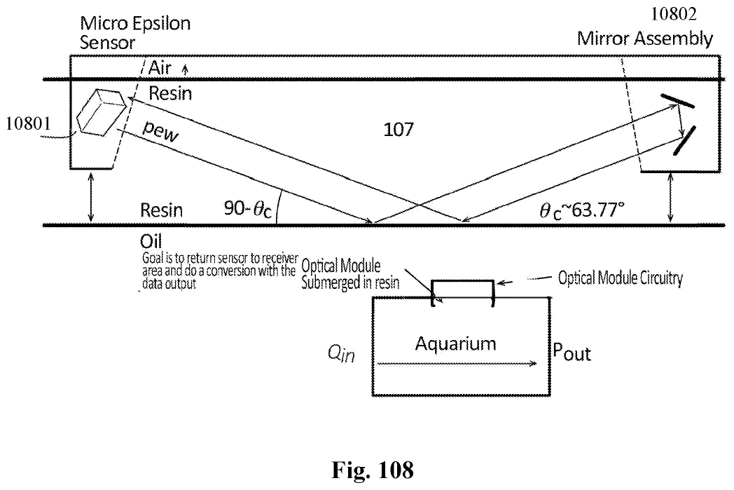

FIG. 108 is an illustration of a submerged laser level 10801 with mirrors 10802. Instead of the laser being placed above or below the liquid vat 107, the laser 10801 is submerged into the resin in the liquid vat 107. While the index of refraction of the resin (and interface material) does not allow for a laser to bounce of its surface and return to the sensor, the index of refraction does allow for the optical property of Total Internal Reflection (“TIR”). TIR is the same phenomenon utilized in fiber optic cables where the laser can bounce inside the resin. When a laser level 3501 is placed inside the resin and angled with the critical angle needed for TIR, the laser can then be made to bounce from the interface of the interface material and the resin. In FIG. 26, the signal bounces off the interface and reflects from a series of mirrors 10802 to bounce back off the interface a second time. The signal is received by the submerged laser level 10802. The laser level 10801 is able to use the received signal to determine the height of the interface. Alternatively, the laser may bounce the signal upwards off the inner surface of the resin to detect the total height of the liquid vat 107.

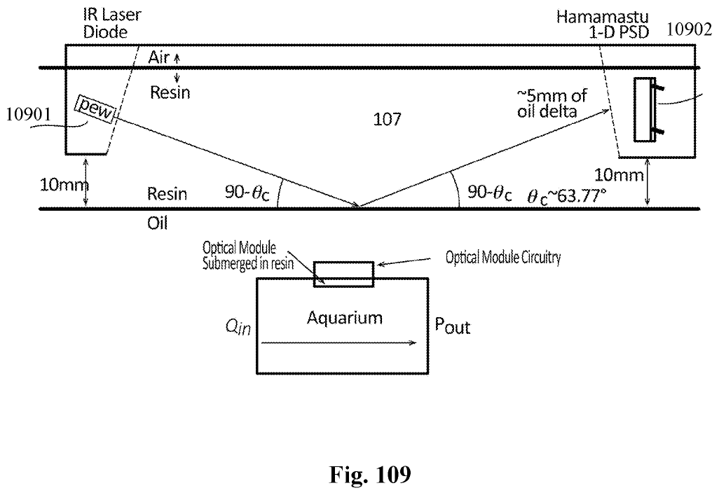

FIG. 109 an illustration of a submerged laser level signal generator 10901 with a separate detector 10902. In this example, the laser level signal generator 10901 produces the laser signal and bounces the signal off the interface of the resin and interface material. The signal is received by the detector 10902. In this manner, the level is determined from a single bounce of the signal off of the interface. Alternatively, the laser may bounce the signal off the surface of the resin to detect the total height of the liquid vat 107.

Another potential improvement that can be employed is the availability of an IR camera that has the field of vision to encapsulate all the liquid vat and build platform apparatus during the printing process. The IR camera may capture the temperatures of the resin/interface material and the printed part in real time as the part is being printed. The real time temperature from an IR camera may indicate temperature data that was not as easily detected by the thermistor temperature probes that use a heat transfer gradient through conduction to model the temperature of interface material and resin. The IR camera would also be beneficial because a temperature profile of the liquid vat and build platform may allow the system to notice any outliers in temperature, such as an overheating part. The IR camera may be useful to identify localized heating issues within the printing vat. Based on this, the computing device may optionally change the temperature of the interface material and/or resin as it is circulated. Optionally, the computing device may differentially position interface material and/or resin based on temperature as it is recirculated. In an example, high concentrations of polymerization occurring in different regions of the liquid vat results in increased temperatures in those locations. The computing device may recirculate cooler interface material and/or resin through specific channels in the flow manifold aligned with those locations as compared to channels aligned with other locations thus maintaining a consistent temperature throughout the geography of the liquid vat.

The IR camera would employ a feedback loop similar to the temperature probe feedback loop described herein. For example, when the temperature rises, the interface material flow rises in order to cool the temperature and reach that optimal oil flow/resin and oil temperature parameters for the part that is printing.

Another potential improvement would include a metrology sensor in the aquarium in order to allow for real time monitoring and quality control of the part as it is being printed based on its mechanical properties. Non-limiting examples of mechanical properties to be monitored and controlled include the density of the part, the geometry of the part, the position of layers of the part, and the texture of the surface of the part.

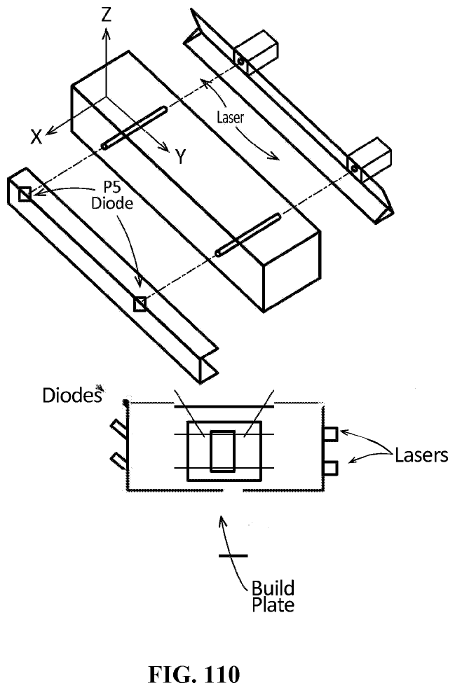

FIG. 110 is an illustration of a photodiode sensor to align a build plate. Another potential improvement in the sensor/feedback loops area is utilizing a photodiode sensor combined with a laser to align the build plate with the oil interface. The photodiode sensor combined with a laser would involve two precisely mounted lasers in parallel with dimension tolerancing, and two photodiode sensors on the receiving end of the lasers. The laser signals would travel through the base plate, through an optical cavity, through another optical hole cavity through the opposing end of the build plate and arrive at the photodiode sensor. If both lasers can pass through both small optical hole cavities, and arrive at the photodiode, then the build plate is level to a high dimensional accuracy and is level to the oil interface for a successful print.

A feedback loop in this scenario would include the laser signal providing the photodiode with the sensing of the beam, and the photodiode indicating to the system that the build platform is level.

In examples of the technology, a method to control operational parameters in a three-dimensional (“3D”) printer is described. The method includes by one or more computing devices, configuring operational setpoints for process equipment to operate a 3D printer process; receiving inputs from one or more sensors of operational parameters of the 3D printer process; comparing the received operational parameters to the setpoints; and modifying at least one of the operational setpoints for the process equipment based on the comparison of the received operational parameters to the setpoints.

In the method, one of the operational parameters comprising a temperature of fluids in the 3D printer process. In the method, a first fluid being a liquid resin that is cured to form a printed part during the printer process. In the method, a second fluid being an interface material that flows under the liquid resin to remove heat from the liquid resin. In the method, modifying at least one of the operational setpoints comprises increasing a flow rate of the interface material based on the comparison determining that the temperature is higher than a threshold value. In the method, one of the operational parameters comprising a level of fluids in the printer process. In the method, modifying at least one of the operational setpoints comprises increasing a level of the fluids based on the comparison determining that the level is lower than a threshold value.

In the method, one of the operational parameters comprising a temperature of an environment around the printer process. In the method, modifying at least one of the operational setpoints comprises increasing a speed of a ventilation fan based on the comparison determining that the temperature is higher than a threshold. In the method, one of the operational parameters comprising forces on a part being printed in the 3D printer process.

In the method, one of the one or more sensors being a load cell on a build plate of the 3D printer process. In the method, one of the one or more sensors being a torque monitor on a servo motor of an upright support of the 3D printer process. In the method, one of the one or more sensors being a strain gauge on a build plate of the 3D printer process. In the method, modifying at least one of the operational setpoints comprises decreasing a flow rate of an interface material based on the comparison determining that the forces on the part are higher than a threshold value.

In the method, one of the operational parameters comprising a flow of an oil that flows under a liquid resin that is cured to form a printed part, the flow of an interface material being used to remove heat from the liquid resin. In the method, wherein modifying at least one of the operational setpoints comprises decreasing a flow rate of the interface material based on the comparison determining that the flow rate is lower than a threshold value. In the method, one of the operational parameters comprising a tilt of one or more pieces of process equipment of the printer process.

In the method, modifying at least one of the operational setpoints comprises adjusting an alignment of a light source for curing the liquid resin based on the comparison determining that the tilt of a particular piece of process equipment has changed. In the method, one of the operational parameters comprising a level of an interface between the fluids in the printer process. In the method, upon detecting a change in the level of the interface, modifying at least one of the operational setpoints comprises adjusting a level of the light source for curing the liquid resin. In the method, adjusting a level of the light source comprises adjusting a level of a Stewart platform supporting the light source.

In examples of the technology, a method to create variable gelation heights in three-dimensional (“3D”) printing is described. The method includes calculating a gray scaling of one or more pixels on a light source that cures liquid resin in a 3D printer to form a printed part, the gray scaling being calculated by turning each pixel of the one or more pixels on and off at a particular rate, the particular rate selected based on a desired intensity of each pixel; and printing a part with varying gelation heights by powering the one or more pixels on the light source based on the gray scaling to control the intensity of the light source at each location of the printed part.

In the method, the gray scaling being based on a straight-line skeleton algorithm. In the method, the gray scaling being based on a polygon offset algorithm. In the method, the gray scaling being based on a gradient polygon offset algorithm.

### Example Computing Devices

FIG. 111 depicts a computing machine 2000 and a module 2050 in accordance with certain examples. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components, for example, a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a vehicular information system, one or more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (DSP), an application specific integrated circuit (ASIC), a graphics processing unit (GPU), a field programmable gate array (FPGA), a programmable logic device (PLD), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain examples, the processor 2010 along with other components of the computing machine 2000 may be a virtualized computing machine executing within one or more other computing machines.

The system memory 2030 may include non-volatile memories, for example, read-only memory (ROM), programmable read-only memory (PROM), erasable programmable read-only memory (EPROM), flash memory, or any other device capable of storing program instructions or data with or without applied power. The system memory 2030 may also include volatile memories, for example, random access memory (RAM), static random access memory (SRAM), dynamic random access memory (DRAM), and synchronous dynamic random access memory (SDRAM).

Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device, for example, the storage media 2040.

The storage media 2040 may include a hard disk, a floppy disk, a compact disc read only memory (CD-ROM), a digital versatile disc (DVD), a Blu-ray disc, a magnetic tape, a flash memory, other non-volatile memory device, a solid state drive (SSD), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules, for example, module 2050, data, or any other information. The storage media 2040 may be part of, or connected to, the computing machine 2000. The storage media 2040 may also be part of one or more other computing machines that are in communication with the computing machine 2000, for example, servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits, for example, microcode or configuration information for an FPGA or other PLD.

The input/output (I/O) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, for example, small computer system interface (SCSI), serial-attached SCSI (SAS), fiber channel, peripheral component interconnect (PCI), PCI express (PCIe), serial bus, parallel bus, advanced technology attached (ATA), serial ATA (SATA), universal serial bus (USB), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or analog communication media, for example, fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to certain examples, any of the processor 2010, the other elements of the computing machine 2000, or the various peripherals discussed herein may be integrated into a single device, for example, a system on chip (SOC), system on package (SOP), or ASIC device.

Examples may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing examples in computer programming, and the examples should not be construed as limited to any one set of computer program instructions. Further, a skilled programmer would be able to write such a computer program to implement an example of the disclosed examples based on the appended flow charts and associated description in the application text. Therefore, disclosure of a particular set of program code instructions is not considered necessary for an adequate understanding of how to make and use examples. Further, those skilled in the art will appreciate that one or more aspects of examples described herein may be performed by hardware, software, or a combination thereof, as may be embodied in one or more computing systems. Additionally, any reference to an act being performed by a computer should not be construed as being performed by a single computer as more than one computer may perform the act.

The examples described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the examples presented previously are illustrative, and, in alternative examples, certain acts can be performed in a different order, in parallel with one another, omitted entirely, and/or combined between different example examples, and/or certain additional acts can be performed, without departing from the scope and spirit of various examples. Accordingly, such alternative examples are included in the scope of the following claims, which are to be accorded the broadest interpretation so as to encompass such alternate examples.

Although specific examples have been described above in detail, the description is merely for purposes of illustration. It should be appreciated, therefore, that many aspects described above are not intended as required or essential elements unless explicitly stated otherwise.

Modifications of, and equivalent components or acts corresponding to, the disclosed aspects of the examples, in addition to those described above, can be made by a person of ordinary skill in the art, having the benefit of the present disclosure, without departing from the spirit and scope of examples defined in the following claims, the scope of which is to be accorded the broadest interpretation so as to encompass such modifications and equivalent structures.

1. A material separator apparatus to remove contaminants from interface material from a 3D printing process, comprising:
an inlet through which interface material flows into the material separator apparatus;
an outlet through which the interface material flows from the material separator apparatus;
internal tubing connecting the inlet to the outlet and comprising a collection zone located before a downwardly declined portion of the internal tubing, the location of the collection zone allowing contaminants in the interface material to collect in the collection zone.

2-18. (canceled)

19. A three-dimensional printer apparatus, comprising:
an array of a plurality of projector systems, each of the projector systems associated with a projection area, each of the projector systems positioned adjacent to at least one other of the projector systems without a space between a projection area of each of the projector systems and a projection area of each adjacent projector system, and each of the projector systems comprising a projector and a projector alignment system;
a visual alignment system configured to individually align each of the projectors;
a cooling system configured to individually cool the projectors; and
a base plate to which each of the projector systems is mounted.

20. The apparatus of claim 19, each respective projector alignment system comprising a parallel manipulator comprising a plurality of linkages arranged in a single plane of symmetry pattern on first and second plates connected by the linkages.

21. The apparatus of claim 20, wherein each parallel manipulator and associated communication system, power system, and circuitry comprises a footprint that is not larger than the projection area of the corresponding projector to which it is attached.

22. The apparatus of claim 20, the first plate being fixed, the second plate being disposed in space relative to the first plate and connected to the first plate by the plurality of linkages, the second plate being movable relative to the first plate by operation of the plurality of linkages, each respective linkage of the plurality of linkages comprising a linear actuator and a motor, the motor driving the linear actuator to move the respective linkage to thereby move the second plate.

23. (canceled)

24. The apparatus of claim 20, wherein repositioning one or more of the linkages of the plurality of linkages repositions the second plate in six degrees of freedom, the respective projector of each projector system being coupled to the second plate of the parallel manipulator of the respective projector alignment system such that movement of the second plate moves the projector in six degrees of freedom.

25. (canceled)

26. The apparatus of claim 20, each respective projector alignment system further comprising a rotational element and a rotational linkage.

27. The apparatus of claim 26, wherein each parallel manipulator, rotational element, and associated communication system, power system, and circuitry comprises a footprint that is not larger than the projection area of the corresponding projector to which it is attached.

28. The apparatus of claim 27, the first plate being fixed, the second plate being disposed in space relative to the first plate and connected to the first plate by the rotational linkage and the plurality of linkages, the second plate being movable and rotatable relative to the first plate by operation of the rotational linkage and/or the plurality of linkages.

29. The apparatus of claim 28, the second plate being rotatable in a plane in which the second plate is positioned by the parallel manipulator, and the rotational linkage comprising a rotational actuator and a motor, the motor driving the rotational actuator to rotate the rotational linkage to thereby rotate the second plate.

30. (canceled)

31. The apparatus of claim 19, the visual alignment system comprising:
a camera; and
a gantry system coupled to the apparatus and to which the camera is coupled, the gantry system movably positionable with respect to the array of projector systems to capture images projected by the projector systems.

32. The apparatus of claim 31, the gantry system positionable to move the camera between the projectors in the array of projectors and above the projectors in the array of projectors.

33-35. (canceled)

36. A method to align projectors in an array of projectors, comprising:
by one or more computing devices:
transmitting, to two or more projectors in the array of projectors, instructions to project a template;
requesting, from a visual alignment system, a set of images of the projected templates;
receiving, from the visual alignment system, the set of images of the projected templates;
comparing images from the set of images to determine an alignment of the two or more projectors;
upon determining that the two or more projectors are not aligned, calculating a position for alignment for each of the two or more projectors; and
transmitting, to two or more second computing devices associated with each of the two or more projectors, instructions to position one or more of the two or more projectors according to the position for alignment of the two or more projectors.

37. The method of claim 36, wherein the one or more computing devices is an image processing computer.

38. The method of claim 36, wherein determining the alignment of the two of more projectors comprises comparing markings in the set of images of the projected templates.

39. The method of claim 36, wherein the position for alignment comprises a translation matrix and a rotation matrix for each of the two or more projectors.

40. The method of claim 36, wherein,
the two or more second computing devices are motor controller boards associated with each of the two or more projectors,
the motor controller boards control one or more motors associated with one or more parallel manipulators to position the two or more projectors, and
each parallel manipulator comprises one or more linkages repositionable by the one or more motors to move a respective projector in six degrees of freedom.

41-42. (canceled)

43. The method of claim 40, comprising:
by the two or more second computing devices:
receiving, from the one or more computing devices, the position for alignment for a particular projector of the two of more projectors; and
repositioning, by the one or more motors of the parallel manipulator, each the one or more linkages of the parallel manipulator in accordance with the position for alignment.

44. (canceled)

45. The method of claim 36, wherein the visual alignment system comprises a camera and a gantry system, the method further comprising:
by the visual alignment system:
receiving a request for the set of images of the projected templates;
positioning, by the gantry system, the camera above a first portion of the projected templates;
capturing an image of the first portion of the projected templates;
repositioning, by the gantry system, the camera above a second portion of the projected templates;
capturing an image of the second portion of the projected templates;
repeating the repositioning and capturing of images until at least one image has been captured of each of the projected templates; and
transmitting, to the one or more computing devices, the captured images as the set of images.

46. A platform positioning apparatus, comprising:
a processor to transmit one or more signals to position a first platform; and
the first platform affixed to a second platform, the first platform being affixed to the second platform with a plurality of linkages, the first platform being disposed in space relative to the second platform, and the first platform being movable relative to the second platform by operation of the plurality of linkages based on the one or more signals transmitted by the processor to position the first platform.

47. The apparatus of claim 46, wherein the platform positioning apparatus is a parallel manipulator.

48. The apparatus of claim 46, wherein the plurality of linkages are arranged in a pattern with a single plane of symmetry, wherein the arrangement of the plurality of linkages allows simultaneous movement of each linkage of the plurality of linkages without interference from remaining linkages of the plurality of linkages.

49. (canceled)

50. The apparatus of claim 46, wherein the first platform and the second platform are of a same size in at least two dimensions, wherein each respective linkage of the plurality of linkages comprises a linear actuator and a motor, the motor driving the linear actuator to move the respective linkage to thereby position the first platform, and wherein the plurality of linkages position the first platform in six degrees of freedom.

51-57. (canceled)

58. A flow manifold to create laminar interface material flows in a 3D printer, comprising:
an inlet through which interface material flows into a liquid vat;
an outlet through which the interface material flows from the liquid vat, the inlet and outlet positioned below an operational level of liquid resin in the liquid vat;
a flow divider that distributes the interface material from the inlet across an entrance to the liquid vat, the flow divider comprising flow splitting channels that provide the interface material from the inlet at a consistent pressure and consistent flow velocity across a width of the entrance; and
a flow straightener comprising fins that straighten the interface material flow and that remove turbulence in the interface material flow.

59-136. (canceled)

137. A method to control operational parameters in a three-dimensional (“3D”) printer, comprising:
by one or more computing devices:
configuring operational setpoints for process equipment to operate a 3D printer process;
receiving inputs from one or more sensors of operational parameters of the 3D printer process;
comparing the received operational parameters to the setpoints; and
modifying at least one of the operational setpoints for the process equipment based on the comparison of the received operational parameters to the setpoints.

138-159. (canceled)

160. (canceled)

161. A method to create variable gelation heights in three-dimensional (“3D”) printing, comprising:
calculating a gray scaling of one or more pixels on a light source that cures liquid resin in a 3D printer to form a printed part, the gray scaling being calculated by turning each pixel of the one or more pixels on and off at a particular rate, the particular rate selected based on a desired intensity of each pixel; and
printing a part with varying gelation heights by powering the one or more pixels on the light source based on the gray scaling to control the intensity of the light source at each location of the printed part.

162-167. (canceled)

168. The apparatus of claim 19, wherein each of the projector systems projects UV light and a light with a wavelength that is higher than UV light such that the wavelength higher than UV light is a light in the visible spectrum to allow visual alignment of the projector systems.

169-170. (canceled)

171. A temperature control system for a liquid vat of a 3D printer, comprising:
a liquid vat comprising resin that is cured to form a 3D printed part, the liquid vat having four side walls;
a flow manifold on a first sidewall that receives a flow of interface material that forms a layer on a bottom of the liquid vat and that creates an interface with a resin that floats above the interface material;
at least one temperature sensors that monitors a temperature profile of the fluid across the liquid vat and a part printed;
a controller that varies a temperature of the interface material and the resin based on the temperature profile.

172. (canceled)

173. A fluid handling system to replenish resin in resin flows in a 3D printer, comprising:
a liquid vat comprising flow of liquid resin that is cured to form a 3D printed part, wherein the liquid resin is recirculated from an outlet of the liquid vat to the inlet of the liquid vat;
a first compartment comprising fresh resin to replenish the liquid resin flowing into the vat;
a second compartment in which the fresh resin from the first compartment is mixed with the recirculating resin in a configured ratio of fresh resin to recirculated resin.

174-175. (canceled)
